(19) United States
(12) Patent Application Publication
(10) Pub. No.: US 2019/0164180 A1
(43) Pub. Date: May 30, 2019

(54) METHODS, SYSTEMS, APPARATUS AND ARTICLES OF MANUFACTURE TO GENERATE PROJECTION WEIGHTS FOR A PANEL

(71) Applicant: The Nielsen Company (US), LLC, New York, NY (US)

(72) Inventors: Christophe Koell, Brussels (BE); Ludo Daemen, Duffel (BE); Ryan Koralik, Elk Grove Village, IL (US); Igor Uzilevskiy, Hoboken, NJ (US)

(21) Appl. No.: 15/827,612

(22) Filed: Nov. 30, 2017

(51) Int. Cl. G06Q 30/02; G06Q 10/06

(52) U.S. Cl. CPC G06Q 30/0202; G06Q 30/0226; G06Q 30/0205; G06Q 10/067

(57) ABSTRACT

Methods, systems, apparatus and articles of manufacture to generate projection factors are disclosed. An apparatus to reduce panel imbalance errors includes a data analyzer to identify a retailer in a geographic region indicative of shopping bias. The data analyzer also is to identify households of interest in the geographic region having combined panel data, the combined panel data representing core panelist data and auxiliary data. The apparatus also includes a modeling engine to calculate potential spending of each household at one or more stores of the retailer. The potential spending is based on observed spending. The apparatus also includes a projection engine to reduce panel imbalance errors by calculating projection weights for the combined panel based on (a) the potential spending at the one or more stores and (b) social or demographic representation data of the combined panel.

### FIELD OF THE DISCLOSURE

This disclosure relates generally to stores and consumers in a geographic region and, more particularly, to methods, systems, apparatus and articles of manufacture to generate projection weights for a panel.

### BACKGROUND

Data measurement companies utilize reporting and/or panelist data (e.g., data obtained from controlled participants) to provide information needed by their clients. Such data provides insight to consumer behavior, such as shopping behavior of consumers having a particular sociodemographic representation (e.g., an age or age group, a gender, etc.). This data also enables clients (e.g., stores) to effectively market to other consumers sharing a similar sociodemographic representation. Conventional projection systems rely on computational resources and, in recent years, have become more complex.

### BRIEF DESCRIPTION OF THE DRAWINGS

FIG. 1 is a block diagram of an example projection system in accordance with the teachings of this disclosure.

FIGS. 2A-C are tables showing example predictions in accordance with disclosed examples.

FIG. 3A is a table showing example calibration parameters associated with generating projection weights for a panel in accordance with disclosed examples.

FIG. 3B is a table showing example projection data and example calculated projection weights.

FIGS. 3C-F are example tables showing an example calibration of example projection weights.

FIG. 4 is a flowchart representative of example machine-readable instructions that may be executed to implement the example projection system of FIG. 1 to generate projection weights for a panel.

FIG. 5 is a flowchart representative of example machine-readable instructions that may be executed to implement the example projection system of FIG. 1 to calculate a distance between an example store and an example region of interest.

FIG. 6 is a flowchart representative of example machine-readable instructions that may be executed to implement the example projection system of FIG. 1 to calculate potential spending for example households.

FIG. 7 is a flowchart representative of example machine-readable instructions that may be executed to implement the example projection system of FIG. 1 to calibrate potential spending.

FIG. 8 is a flowchart representative of example machine-readable instructions that may be executed to implement the example projection system of FIG. 1 to identify an example target retailer or retail channel for calibration.

FIG. 9 is a flowchart representative of example machine-readable instructions that may be executed to implement the example projection system of FIG. 1 to calibrate example projection weights.

FIG. 10 is a flowchart representative of example machine-readable instructions that may be executed to implement the example projection system of FIG. 1 to calibrate example elasticity data.

FIG. 11 is a flowchart representative of example machine-readable instructions that may be executed to implement the example projection system of FIG. 1 to calibrate example purchase potential data.

FIG. 12 is a block diagram of an example processor platform structured to execute the example machine-readable instructions of FIGS. 4-11 to implement the example projection system of FIG. 1.

The figures are not to scale. Wherever possible, the same reference numbers will be used throughout the drawing(s) and accompanying written description to refer to the same or like parts.

### DETAILED DESCRIPTION

Recent technology advances in computer architecture has enabled the development of effective technologies related to the technical field of market research and analytics. In particular, household projection data enables a sample of a population (e.g., members of consumer panel) to substantially represent a population. For example, a household projection weight (e.g., 10, 100, 1000, etc.) represents a multiplier and/or a projected quantity of consumers (e.g., non-panelists) sharing the same or similar attributes (e.g., attributes indicating particular demographic representations) as panelists. As such, behaviors of a particular population of interest (e.g., households having a particular income and/or number of residents) can be predicted and/or otherwise projected based on behaviors of the panelists such as, for example, shopping and/or purchase behavior(s) (e.g., particular items purchased, quantity of purchases, frequency of purchases, etc.), which enables clients (e.g., stores) of a data measurement company to effectively and/or efficiently market to the consumers. Further, such projection data enables a data measurement company to provide estimates (e.g., estimates relating to purchase value, frequency, penetration, etc.) at the population level relevant to their clients, which enables their clients to evaluate and/or determine effectiveness of marketing, such as product advertising marketing efforts.

Known projection systems typically calculate household projection weights for a panel such that projected populations provided via the weights properly and/or accurately represent observed populations (e.g., reliable population data provided by a census bureau) in a particularly large geographic area, such as a county or census division. However, the projection weights are often limited or constrained by available panelist data and, as a result, known projection systems may combine different panelist data such as, for example, shopper data provided via a store loyalty program and data provided by a consumer panel (e.g., HomeScan). Generally speaking, market researchers may perform audience measurement by enlisting any number of consumers as panelists. Panelists are audience members enlisted to be monitored, who divulge and/or otherwise share their behaviors (e.g., media exposure, purchasing behavior, etc.), demographic data and/or locations of residence to facilitate market research activities. For example, an example panel includes HomeScan associated with consumers that are monitored via one or more monitoring devices and/or meters, which may be referred to as a core panel. Because core panelist data is carefully cultivated and accurate, it is also expensive to obtain and manage. Additionally, to satisfy statistical projection accuracy, a requisite quantity of panelist data may be needed depending on projection sizes. As such, another example panel may include a loyalty or shopper program (also sometimes referred to as a frequent shopper program and/or a reward program) associated with consumers that are monitored via stores at which the consumers shop, which may be referred to as an auxiliary panel.

Typically, core panels (e.g., HomeScan) are selected such that they are generally demographically and/or geographically balanced relative to observed population data. However, imbalances are often inherent to any panel and magnified when panels include less accurate data (e.g., auxiliary panelist data) and/or when different panels are combined (e.g., combining data of HomeScan with data of one or more loyalty programs). In particular, certain auxiliary panelist data inherently provides significant imbalances, such as the above disclosed shopper data provided by a loyalty program of a store (e.g., a grocery store). For example, customers participating in a loyalty program typically over represent certain demographic representations, such as women age 65 and older and/or regions (e.g., zip codes, blocks, etc.) in which they live, which may be referred to as a demographic bias. Further, these customers tend to shop at the store(s) having the loyalty program, which may be referred to as a store and/or a shopping bias.

Such panel imbalances reduce the ability of known projection systems in the technical field of market research and analytics to effectively generate accurate and/or useful projection weights for a panel. Thus, known projection systems may fail to provide accurate and/or useful projection weights for an imbalanced panel, for example, caused by a store and/or a shopping bias. For example, auxiliary panelist data provided by a loyalty store and/or panelists exposed to the loyalty store may cause the above noted known projection systems to generate substantially large projection weights that do not accurately represent the population in the geographic region. As a result, clients of a data measurement company that rely on these known projection systems are adversely affected by erroneous projection data. Additionally, such erroneous projection data may require a selection of a new panel and/or cause the known projection systems to endure computationally intensive re-calculation of the projection weights to satisfy a standard or threshold of error, which reduces computational efficiency of the known projection systems. Further, the known projection systems may discard or waste auxiliary data (e.g., waste memory) that could have otherwise been used to effectively supplement core panelist data in generating the projection weights.

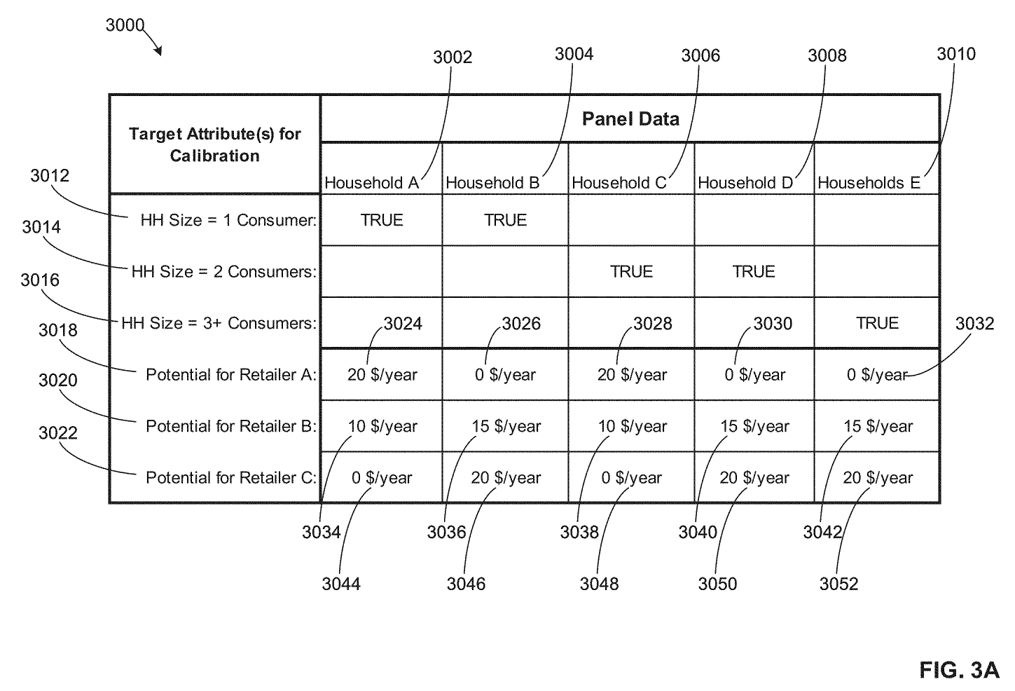

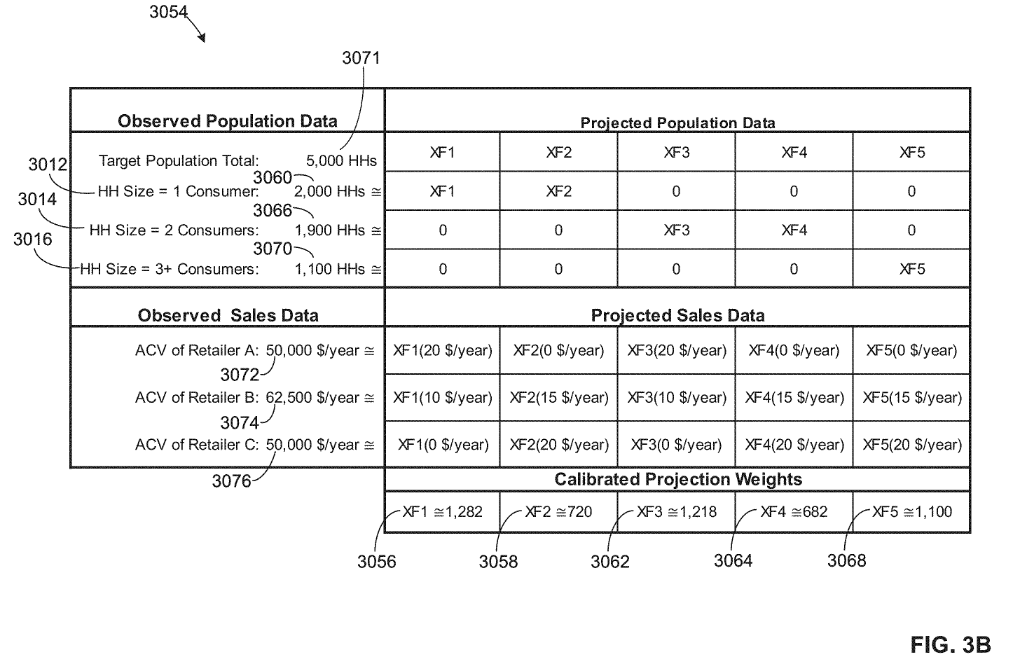

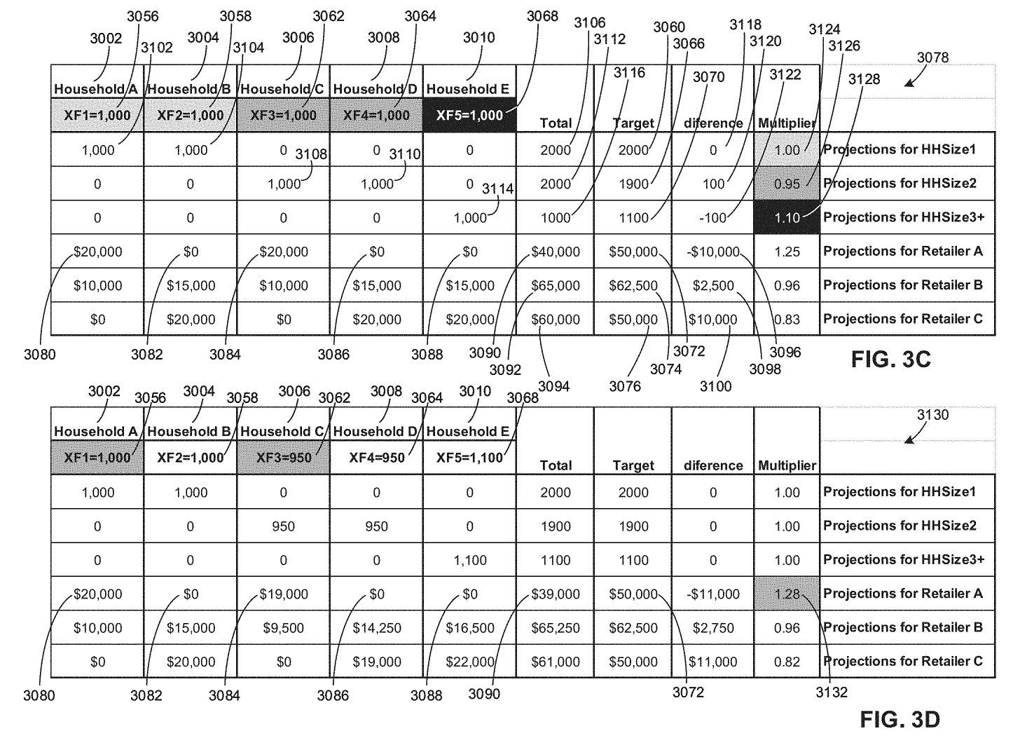

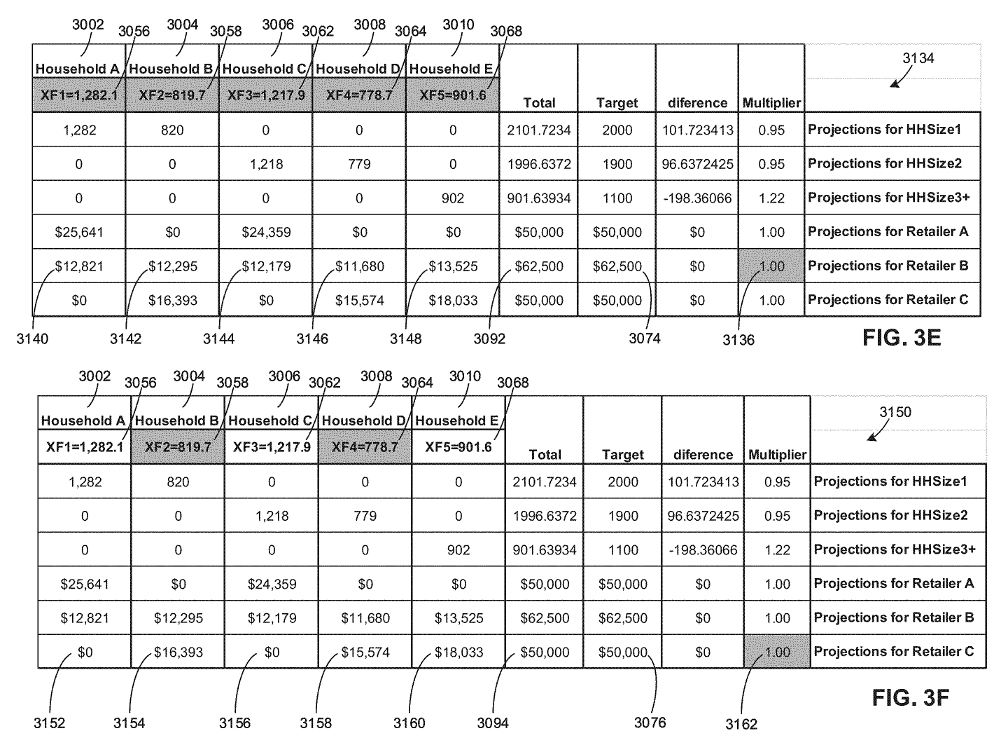

Methods, systems, apparatus, and articles of manufacture to generate projection weights for a panel (e.g., a combined panel) are disclosed herein as improvements to the technical field of market research and analytics. Examples disclosed herein calculate the projection weights based on potential spending (e.g., money spent per year) of households of interest (e.g., a household having one of a core panelist and/or an auxiliary panelist living therein) at stores as well as potential sales (e.g., annual sales) of those stores, for example, facilitated by a Huff gravitational model, as disclosed further below in connection with Equations (1), (2), and/or (3). In addition to providing projections in terms of different populations in the geographic region, the disclosed projection weights provide projections in terms of the potential spending of the households of interest at one or more retailers (e.g., a company associated with one or more of the stores in the geographic region) and/or retail channels (e.g., a supermarket channel, a convenience store channel, a gas station/kiosk channel, etc.). In particular, some disclosed examples calculate the projection weights to balance and/or align (e.g., simultaneously) both: (1) projected potential spending of the households of interest relative to observed sales of a target (e.g., a retailer and/or a retail channel identified as having sufficient data associated therewith to ensure accurate projection weights); and (2) projected population data (e.g. one or more projected populations associated with particular demographic representations) for the geographic region relative to associated observed population data of the geographic region, as disclosed further below in connection with Equation (4) and FIGS. 3A-F.

By generating the projection weights in this manner, examples disclosed herein reduce and/or eliminate panel imbalance and/or errors in the projection weights (e.g., caused by a store bias and/or a shopping bias) that would have otherwise been exhibited by known projection systems. Thus, examples disclosed herein improve computational efficiency in generating the projection weights by reducing and/or eliminating a need for re-calculations caused by such imbalance(s) and/or error(s). Further, some disclosed examples maintain accuracy of the projection weights for a combined panel (e.g., HomeScan Premium) while using less core panelist data (e.g., data provided via HomeScan) (e.g., less memory) that would have otherwise been required by the above-described known projection systems. Additionally, a relatively lower reliance upon core panelist data results in a corresponding reduction in a cost of memory consumption and/or computational resources associated with market research.

To determine and/or otherwise calculate the potential spending of the households of interest as well as the potential sales of the stores (e.g., prior to generating the projection weights for the panel), some disclosed examples utilize the Huff gravitational model to calculate purchase potentials between regions of interest (e.g., zip codes, census blocks, etc.) and stores in a geographic region (e.g., a country, a census region and/or division, etc.), as disclosed in further detail below in connection with Equations (1) and (2). In particular, example purchase potentials (e.g., probability values and/or proportional values) predict a proportion and/or a distribution of expenditures (e.g., money spent per year) from households in the regions of interest to the stores in the geographic region and, as a result, also predict sales (e.g., all-commodity volumes (ACVs)) of those stores as well as total expenditures (e.g., money spent per year) of the regions of interest, as disclosed in further detail below in connection with Equation (3).

In some examples, to further reduce and/or eliminate the panel imbalance(s) and/or error(s) when generating the projection weights, the potential sales for the stores facilitated by the purchase potentials need to substantially align to and/or match observed sales data associated with the stores. That is, the potential sales and/or ACVs (also referred to herein as “rebuilt ACVs”) of the stores may be substantially different relative to observed ACVs of the stores. As used herein, the terms “all-commodity volume (ACV),” and/or “observed all-commodity volume (ACV)” refer to an amount of sales (e.g., sales per year, sales per month, etc.) associated with a store (e.g., a grocery store, a depai linent store, a convenience store, etc.), a retailer, and/or a retail channel, for example, obtained via one or more of the stores in the geographic region and/or reliable third-party data sources. As used herein, the terms “rebuilt ACV” and/or “potential ACV” refer to a potential or predicted amount of sales of a store (e.g., sales per year, sales per month, etc.), a retailer, and/or a retail channel, for example, calculated in a manner consistent with Equations (1), (2), and/or (3).

Accordingly, to generate accurate and/or useful projection weights for the households of interest, the potential ACVs of the stores determined and/or otherwise calculated based on the purchase potentials need to substantially align to and/or match respective observed ACVs. As such, some examples calibrate Equation (1) (e.g., select, adjust and/or otherwise calibrate elasticity values of Equation (1)) to enable resulting potential ACVs of the stores to substantially align to and/or match the respective observed ACVs. In such examples, Equation (1) includes a pair of elasticity values (α, β) (e.g., exponent values), each of which affect sensitivity of Equation (1) and/or resulting purchase potentials and, thus, each affect resulting potential ACVs of the stores. The elasticity values of Equation (1) may be unique or specific to each store and relate to store attributes and/or characteristics. For example, a first elasticity value α relates to a size (e.g., in terms of one or more of a quantity of products, a variety of products, an ACV and/or a store type (e.g., grocery supermarkets, dollar stores, drug stores, etc.)) of a particular store, and a second elasticity value β relates to a distance between the store and a region of interest. In such examples, a consumer may tend to shop more frequently at a large store (e.g., a grocery supermarket) compared to a small store (e.g., a dollar store) and/or a proximate store (e.g., a store located 5 miles away from the consumer) compared to a distant store (e.g., a store located 50 miles from the consumer)). Some disclosed examples calibrate the elasticity values for one or more of the stores such that each store and/or a group of stores is/are associated with unique elasticity values. By calibrating the elasticity values of Equation (1) prior to generating the purchase potentials and/or the projection weights, retail or store bias(es) and/or otherwise adverse panel effects associated with the stores are substantially reduced. On the other hand, if the elasticity values are not calibrated, the resulting potential ACVs of the stores may be substantially different relative to the respective observed ACVs and, as a result, may leave the resulting projection data with inaccuracies and/or errors.

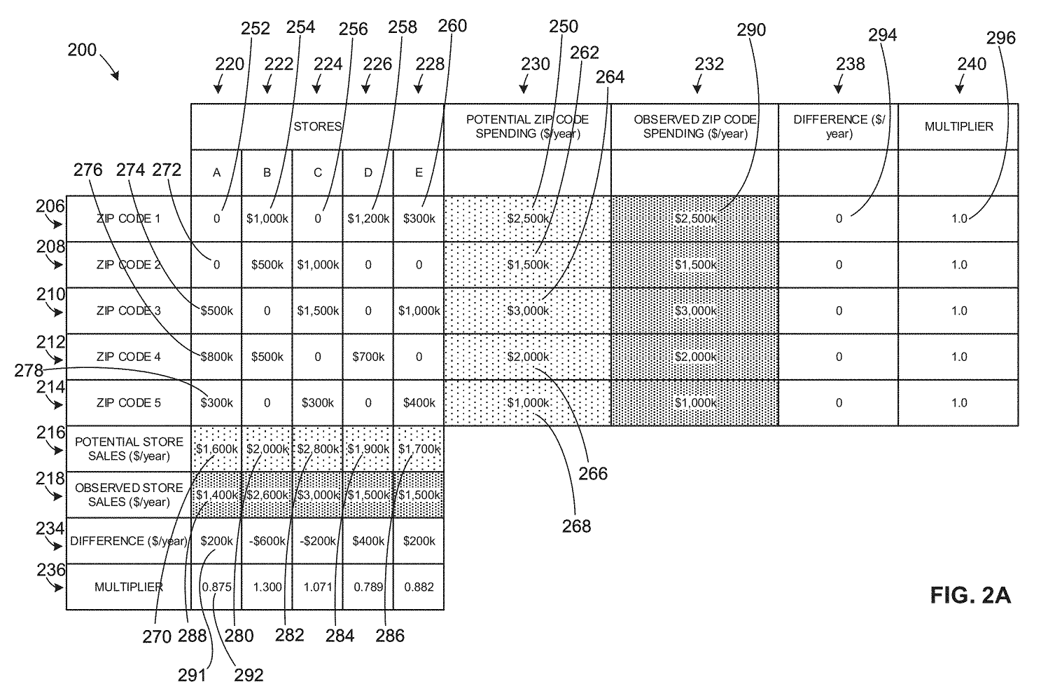

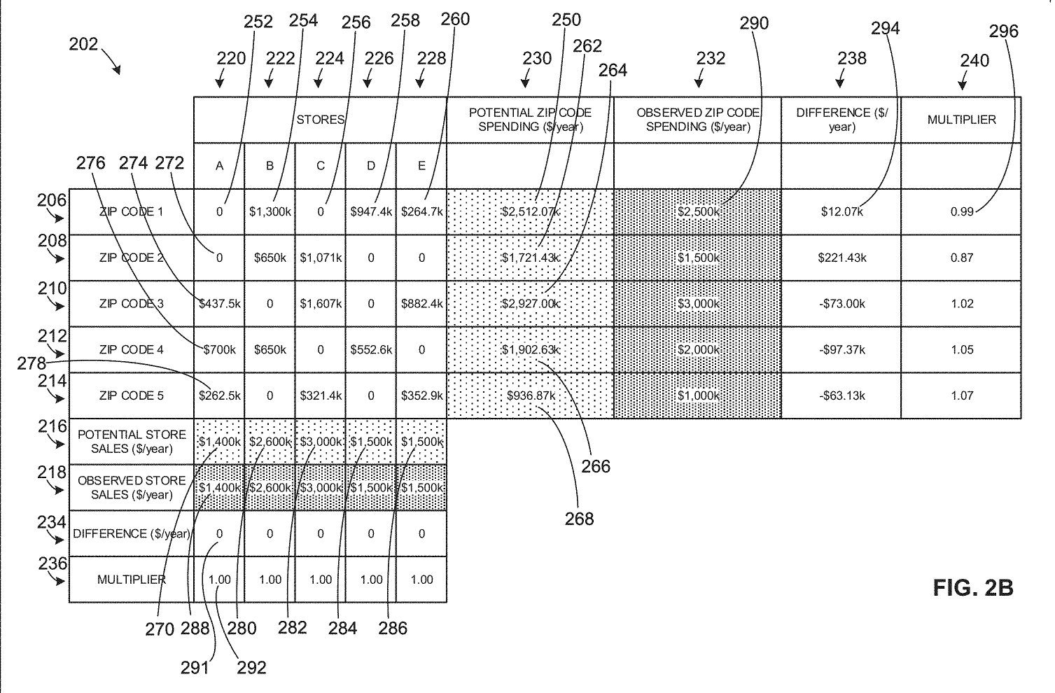

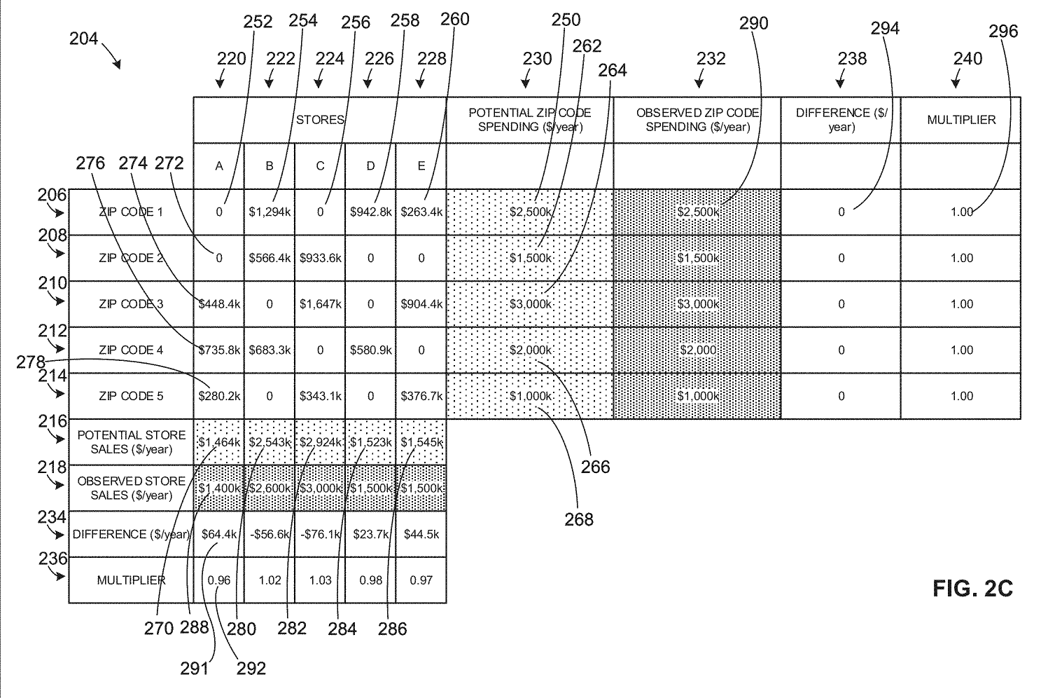

Additionally or alternatively, to further align and/or match the potential ACVs to the respective observed ACVs, some disclosed examples calibrate the underlying purchase potentials facilitating the calculated potentials. However, by calibrating and/or otherwise changing the purchase potentials, potential expenditures of the regions of interest facilitated by the purchase potentials may no longer align to and/or match respective observed expenditures, which may likewise leave the resulting proj ection data with inaccuracies and/or errors. In such examples, the calculated potential data (e.g., potential ACVs of stores and potential expenditures of regions of interest) is considered to be unbalanced relative to associated observed data (e.g., observed ACVs of the stores and observed expenditures of the regions of interest). As used herein the terms “expenditure” and/or “observed expenditure” refer to an amount money or currency spent (e.g., spent per year, per month, etc.) by a region of interest and/or a household in the region of interest, for example, obtained via one or more census bureaus and/or reliable third-party data sources. As used herein, the terms “rebuilt expenditure” and/or “potential expenditure” refer to a potential or predicted amount of money or currency spent (e.g., annually) by a region of interest and/or a household in the region, for example, calculated in a manner consistent with Equations (1), (2), and/or (3). Accordingly, in some such examples, to balance the potential data relative to the observed data, the purchase potentials may endure one or more iterations of calibration to align and/or match (e.g., simultaneously) both: (1) the potential ACVs of the stores to the respective observed ACVs; and (2) the potential expenditures of the regions of interest to the respective observed expenditures. Calibration of the purchase potentials in this manner can be implemented, for example, using an iterative proportional fitting technique or method, which is disclosed in greater detail below in connection with FIGS. 2A-C.

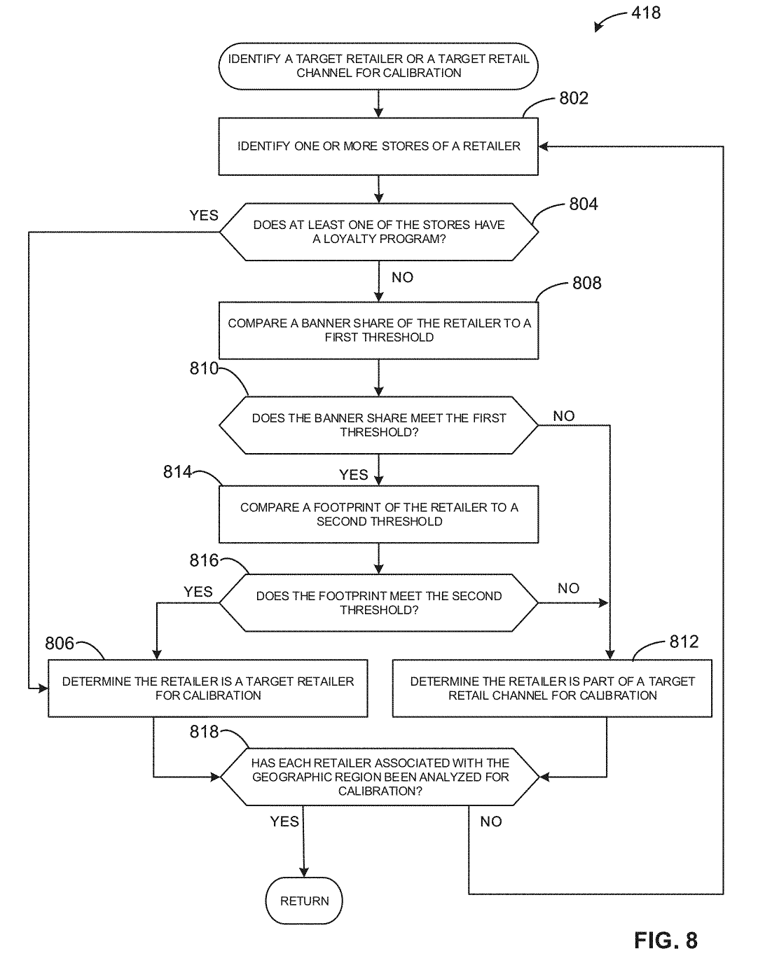

Some disclosed examples identify a target retailer or retail channel (e.g., a supermarket or supercenter channel, a convenience store channel, etc.) for calibration that may be associated with a store bias and/or a shopping bias. In such examples, to ensure an example target (e.g., a single retailer and/or a group of retailers) is reliable (e.g., there is sufficient data associated with the target to provide an accurate calibration), a target retailer is selected based on filters and/or one or more criteria. For example, the target retailer includes one or more stores having a loyalty program that may offer incentives and/or rewards to participating customers (e.g., auxiliary panelists). In some examples, the target retailer has a certain share of banner. That is, observed sales associated with the target retailer (e.g., an ACV of the target retailer) represents a certain share or percentage (e.g., greater than about 5%) of all retailer sales in the geographic region. In some examples, the target retailer has a certain footprint. That is, the target retailer is exposed to a certain share or percentage (e.g., about 10%) of all households in the geographic region, as disclosed in greater detail below in connection with FIG. 8.

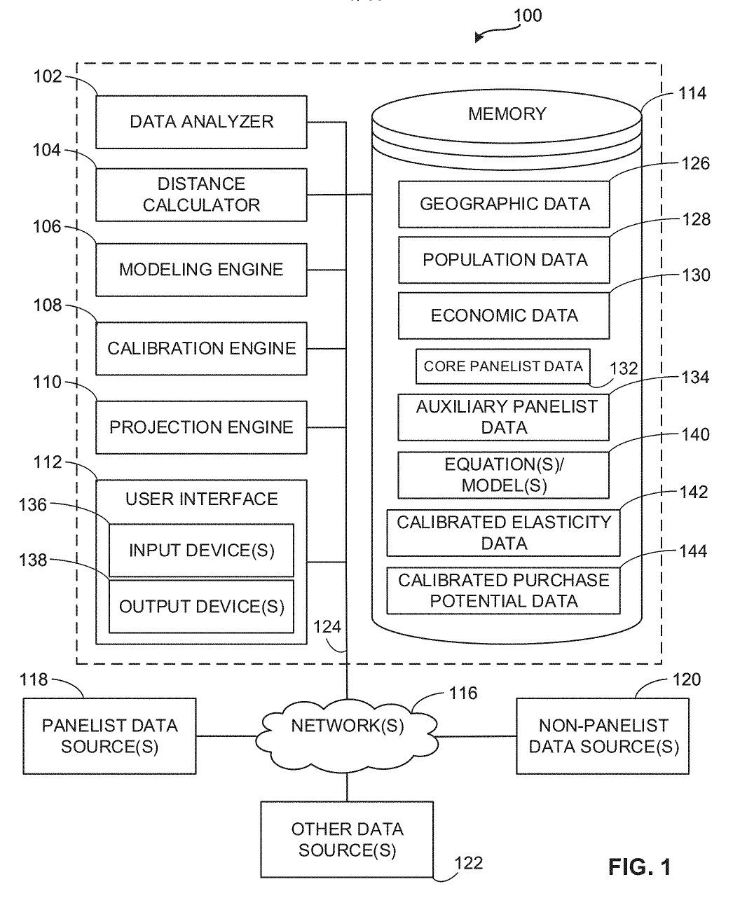

FIG. 1 is a block diagram of an example projection system 100 in accordance with the teachings of this disclosure. In the illustrated example of FIG. 1, the example projection system 100 includes an example data analyzer 102, an example distance calculator 104, an example modeling engine 106, an example calibration engine 108, an example projection engine 110, an example user interface 112, and an example memory 114. In some examples, the example projection system 100 also includes one or more example network(s) 116, one or more example core panelist data sources 118, one or more example auxiliary panelist data sources 120, and/or one or more other data sources 122.

According to the illustrated example of FIG. 1, the user interface 112 is communicatively coupled to the network(s) 116 (e.g., the Internet, one or more virtual private networks (VPNs), one or more local-area networks (LAN), one or more wide-area networks (WANs), etc.) via one or more communication links (e.g., one or more signal wires and/or busses) 124. In particular, the example user interface 112 of the illustrated example receives data (e.g., geographic data, population data, economic data, core panelist data, auxiliary panelist data, other associated data, etc.) associated with a geographic region (e.g., a country, a census region and/or division, a state, etc.) via the network(s) 116 and/or stores the data in the memory 114.

In some examples, geographic data 126 (e.g., stored in the memory 114) includes coordinates of one or more regions of interest (e.g., one or more zip codes, one or more census blocks, etc.) and/or stores in the geographic region, which may represent global positions and/or relative locations. In some examples, the coordinates may represent a geometry or shape (e.g., a regular or irregular polygon) of the regions of interest, which enables the example projection system 100 to identify a center of mass coordinate of a region of interest.

In some examples, population data 128 (e.g., stored in the memory 114) includes observed population estimates associated with the regions of interest, such as a number of people and/or households as well as demographic representation data (e.g., a location of residence, a household size, a household income, etc.). The population data 128 may also indicate an observed population density, an observed population center, and/or an observed population distribution of a region of interest, which can be used to identify a center of mass coordinate for the region of interest.

In some examples, economic data 130 (e.g., stored in the memory 114) includes observed spending associated with people the geographic region such as, for example, an amount of money or currency spent (e.g., per day, per month, per year, etc.) by a household (e.g., a panelist household or a non-panelist household) in a region of interest, which may be referred to as an observed expenditure of the household. In some examples, an example observed expenditure of a region of interest includes an aggregate of the observed spending of one or more (e.g., all) households in the region of interest.

In some examples, the economic data 130 includes observed sales data associated with stores in the geographic region such as, for example, an observed amount of sales received (e.g., annually) by a store (e.g., a grocery store, a department store, a drug store, etc.) in the geographic region, which may be referred to as an observed ACV of the store.

The other data source(s) 122 of FIG. 1 can include one or more census bureaus (e.g., the United States (US) Census Bureau, the Integrated European Census Microdata (IECM), etc.), one or more reliable third-party data services (e.g., Spectra®) that provide observed data associated with the geographic region and/or, more generally, includes one or more databases accessible via the network(s) 116. In such examples, the other data source(s) 122 may be communicatively coupled to the network(s) 116 and/or provide the geographic data 126, the population data 128, and/or the economic data 130 to the example projection system 100.

In some examples, core panelist data 132 (e.g., stored in the memory 114) includes shopping behavior data of core panelists that indicates and/or represents characteristics, patterns, and/or behaviors of the core panelists, such as particular stores at which their currency was spent, particular items purchased, frequency of purchases, quantity of purchases, etc. As used herein, a “core panelist” refers to a person participating in a consumer panel (e.g., a non-combined panel), such as HomeScan. In some examples, the core panelist data 132 includes demographic data (e.g., an age, a gender, a nationality, an occupation, an income, a location of residence, a household size, etc.) of the core panelists.

The core panelist data source(s) 118 of FIG. 1 include one or more consumer panels (e.g., HomeScan). Such panels may provide the core panelist data 132 via monitoring or measurement devices that monitor shopping activity of core panelists and provide corresponding core panelist data to the network(s) 116 and/or the example projection system 100. For example, a core panelist uses the measurement device(s) to scan purchased products or store goods (e.g., scan universal product codes (UPCs)) and/or otherwise divulge associated purchase data. In some examples, the core panelists provide their demographic data to the monitoring device(s) (e.g., when registering as a core panelist with an associated data measurement company).

Similarly, in some examples, auxiliary panelist data 134 (e.g., stored in the memory 114) likewise includes shopping behavior data and/or demographic data of auxiliary panelists (e.g., provided via preferred shopper data, loyalty card data, etc.). As used herein, an “auxiliary panelist” refers to a person participating in an auxiliary panel, such as a frequent shopper program, a loyalty program, and/or a reward program of a store. The auxiliary panelist data source(s) 120 of FIG. 1 include one or more stores in the geographic region and/or third-party data services that may provide the auxiliary panelist data 134 to the network(s) 116 and/or the example projection system 100. For example, one or more stores in the geographic region have a frequent shopper program, loyalty program, and/or a reward program to monitor shopping activity of customers. The customers may provide their demographic data and/or identifying information (e.g., a name, a phone number, an email address, etc.) when registering as an auxiliary panelist with the store(s). However, in some examples, the customers may provide their identifying information without their demographic data. In such examples, one or more third-party data services (e.g., Spectra®) may provide the missing demographic data of the customers to the example projection system 100, for example, by using the identifying information of the customers to identify their missing demographic data.

The example user interface 112 of FIG. 1 facilitates interactions and/or communications between an end user and the example projection system 100. The user interface 112 includes one or more input devices 136 to enable the user to input information and/or data to the example projection system 100. For example, the input device(s) 136 of the user interface 112 may include a button, a switch, a key board, a mouse, a microphone, a touchscreen, etc. that enable(s) the user to convey data and/or commands to the example projection system 100.

In some examples, the user interface 112 also includes one or more output devices 138 to present information and/or data in visual and/or audible form to the user. For example, the one or more output device(s) 138 of the user interface 112 may include a light emitting diode, a touchscreen, a liquid crystal display, etc. to present visual information and/or a speaker or audio transducer to present audible information such as, for example, generated projection weights.

The example data analyzer 102 of FIG. 1 is communicatively coupled to the memory 114 via the communication link(s) 124. In particular, the data analyzer 102 analyzes the data stored in the memory 114, for example, to retrieve observed expenditures and coordinates for regions of interest in a geographic region. In such examples, the data analyzer 102 analyzes the geographic data 126, population data 128, and/or the economic data 130 stored in the memory 114 to retrieve a first observed expenditure (e.g., $2,500,000 per year) and first region coordinates for a first region of interest (e.g., a first zip code) in the geographic region, such as an x-coordinate, a y-coordinate and/or a z-coordinate, which may represent a relative position and/or location of the region of interest. Additionally or alternatively, in some examples, the data analyzer 102 retrieves one more other region coordinates for the first region of interest, which may indicate a geometry or shape of the first region of interest, such as a regular shape or polygon (e.g., a rectangle, a rhombus, a trapezoid, a circle, etc.) and/or an irregular shape or polygon.

Further, in some examples, the data analyzer 102 retrieves one or more other observed expenditures and region coordinates for other regions of interest. For example, the data analyzer 102 retrieves: a second observed expenditure (e.g., $1,500,000 per year) and second region coordinates (e.g., a global or relative position and/or a geometry) for a second region of interest (e.g., a second zip code) in the geographic region; a third observed expenditure (e.g., $3,000,000 per year) and third coordinates (e.g., a global or relative position and/or a geometry) for a third region of interest (e.g., a third zip code) in the geographic region; etc. Thus, in some examples, the data analyzer 102 can retrieve an observed expenditure and region coordinates for each region of interest in the geographic region. While certain example values are used to illustrate disclosed examples above, such examples are not limited thereto.

In some examples, the data analyzer 102 of the illustrated example of FIG. 1 retrieves observed ACVs and store coordinates for one or more stores in the geographic region. For example, the data analyzer 102 analyzes the geographic data 126 and/or the economic data 130 stored in the memory 114 to retrieve a first observed ACV (e.g., $1,400,000 per year) and first store coordinates (e.g., a global or relative position) for a first store (e.g., a grocery store) in the geographic region. Further, in some examples, the data analyzer 102 retrieves one or more other observed ACVs and/or other store coordinates for other stores. For example, the data analyzer 102 retrieves: a second observed ACV (e.g., $2,300,000 per year) and a second store coordinate (e.g., a global or relative position) for a second store in the geographic region; a third observed ACV (e.g., $3,000,000 per year) and a third store coordinate (e.g., a global or relative position) for a third store in the geographic region; etc. Thus, in some examples, the data analyzer 102 can retrieve an observed ACV and a store coordinate for each store in the geographic region.

In some examples, the data analyzer 102 identifies one or more target retailers and/or retail channels for calibration that may be associated with a store bias and/or a shopping bias, which is disclosed in greater detail below in connection with FIG. 8. In particular, the data analyzer 102 identifies an example target (e.g., a single retailer and/or a group of retailers) based on one or more filters and/or criteria, which provides for a robust and/or improved accuracy of calibration of the example target by ensuring the target is associated with sufficient data. For example, an example target retailer includes one or more stores having a loyalty program that may offer incentives and/or rewards to participating customers (e.g., auxiliary panelists and/or core panelists). In some examples, the target retailer has a certain share of banner. That is, observed sales associated with the target retailer (e.g., an ACV of the target retailer) represents a certain share or percentage (e.g., greater than about 5%) of all retailer sales in the geographic region. In some examples, the target retailer has a certain footprint. That is, the store(s) of target retailer are exposed to a certain share or percentage (e.g., about 10%) of all households in the geographic region. For example, an example store is considered to be exposed to a region of interest and/or household when a value of potential spending (e.g., calculated by the modeling engine 106, as discussed below) associated therewith is greater than about $0 per year.

For example, the data analyzer 102 analyzes the data stored in the memory 114 to identify the first example store, the second example store, and the third example store as part of a first example retailer (e.g., a first company) Further, in some examples, the data analyzer 102 identifies one or more other stores in the geographic region as part of other retailers. Thus, in some examples, the data analyzer 102 may identify each store in the geographic region as part of a retailer.

The example distance calculator 104 of FIG. 1 is communicatively coupled to the memory 114 via the example communication link(s) 124. In particular, the example distance calculator 104 accesses coordinates stored in the memory 114 to calculate distances between the regions of interest and the stores in the geographic region based on the coordinates of the regions of interest and the store coordinates of the stores. For example, the distance calculator 104 calculates a first distance (e.g., a linear and/or Euclidian distance) between the first region coordinates (e.g., x_{region}_{₁} and y_{region}_{₁}) of the first region of interest and the first store coordinates (e.g., xₛₜₒᵣₑ_{₁} and yₛₜₒᵣₑ_{₁})) of the first store, for example, where) the first distance≅{square root over ((xₛₜₒᵣₑ_{₁}−x_{region}_{₁})²+(yₛₜₒᵣₑ_{₁}−y_{region}_{₁₎}²)}. In this manner, the distance calculator 104 may calculate a distance between each store and each region of interest in the geographic region.

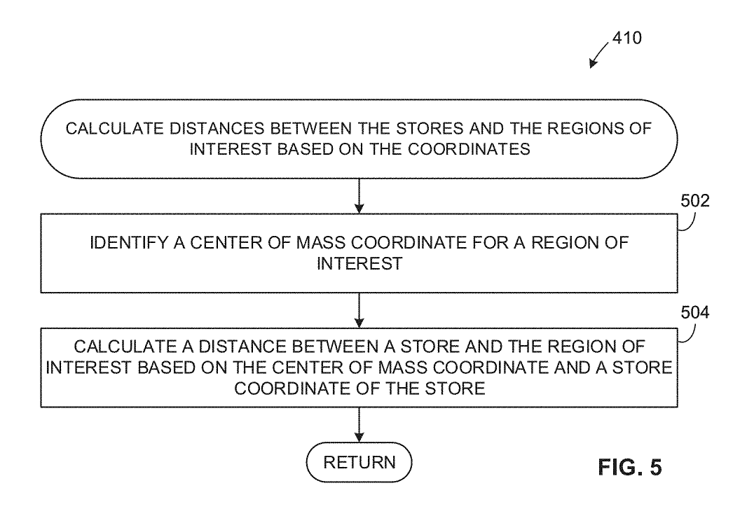

Additionally or alternatively, in some examples, the distance calculator 104 calculates the distances based on geographic and/or population characteristics of the regions of interest such as, for example, shapes or geometries, population distributions, population centers and/or population densities of the regions of interest. For example, the distance calculator 104 identifies a first center of mass coordinate for the first region of interest and calculates the first distance based on the first center of mass coordinate and the first store coordinate, which is disclosed in greater detail below in connection with FIG. 5.

The example modeling engine 106 of FIG. 1 is communicatively coupled to the memory 114 via the communication link(s) 124 to access and/or store data. In particular, the modeling engine 106 calculates potential or predicted spending of households (e.g., households of interest) at stores in the geographic region. As used herein, the terms “household of interest” and/or “panelist household” refer to a household having at least one panelist (e.g., a core panelist or an auxiliary panelist) living and/or located therein. As used herein, the term “non-panelist household” refers to a household having none of a core panelist or an auxiliary panelist living therein. As such, in some examples, the modeling engine 106 also calculates potential or predicted sales (e.g., calculates one or more ACVs) of stores as well as potential and/or predicted spending (e.g., calculates one or more expenditures) of regions of interest in the geographic region, as discussed further below in connection with Equations (1), (2) and/or (3). For example, the modeling engine 106 may calculate how much money or currency a household is likely to spend (e.g., annually) at each store in the geographic region. In such examples, the modeling engine 106 retrieves one or more equations, algorithms and/or models 140 stored in the memory 114 to calculate probability values and/or proportional values (e.g., purchase potentials) between the regions of interests and the stores in the geographic region, as disclosed further below.

In some examples, prior to calculating the probability values and/or proportional values, the modeling engine 106 calculates one or more utilities in a manner consistent with example Equation (1):

$${U}_{zs} = \frac{{Size}_{s}^{α}}{{Travel}_{z \to s}^{β}} \qquad Equation ( 1 )$$

In the illustrated example of Equation (1) (e.g., stored in the example memory 114), U_{zs} represents a numerical value corresponding to a utility of a person (e.g., a customer of a store) and/or a household located in a region of interest z that is extracted from a store s. As used herein, the term “utility” refers to a relative preference and/or usefulness of a person and/or a household to shop at a particular store. In some examples, the utility U_{zs} is a numerical value corresponding to a utility of the region of interest z (e.g., to reduce granularity and/or calculations of predictions for the geographic region). In the illustrated example of Equation (1) above, Size is a numerical value (e.g., obtained by the example projection system 100) that corresponds to an assortment and/or an inventory of the store s. For example, a hypermarket may have a relatively large value for its Size and a convenience store may have a relatively small value for its Size. The example Size variable is directly related to the resulting utility U_{zs}. Accordingly, the person living in the household is less likely to shop at small stores having a relatively limited assortment of products compared to large stores having a relatively larger assortment of products.

In the illustrated example of Equation (1), Travel_{z→s} is a numerical value that corresponds to a distance (e.g., a linear distance) (e.g., 1 mile, 5 miles, 10 miles, etc.) between the store s and the region of interest z, which may be calculated by the example projection system 100 (e.g., via the distance calculator 104). This example distance variable is inversely related to the resulting utility U_{zs}. Accordingly, the person living in the household is less likely to shop at stores distant from the household (e.g., stores located 15 miles, 30 miles, 50 miles, etc. from the household) compared to other stores proximate to the household (e.g., stores located 1 mile, 5 miles, 10 miles, etc.). In the illustrated example of Equation (1) above, α is a first elasticity value (e.g., an exponent) associated with the store s, and β is a second elasticity value (e.g., an exponent) associated with the store s, each of which affect sensitivity of the utility U_{zs}.

Utilities provided by Equation (1) enable the projection system 100 to calculate (e.g., via purchase potentials) predicted spending of a region of interest and/or a household (and/or one or more other households) in that region, as discussed further below in connection with Equations (2) and (3). Further, the utilities also enable the projection system 100 to calculate (e.g., via purchase potentials) potential sales and/or a potential ACV of a store (and/or other ACVs of other stores) as well as potential expenditures of the regions of interest.

In some examples, the modeling engine 106 calculates one or more probability values and/or proportional values (also referred to as “purchase potentials”) in a manner consistent with example Equation (2):

$$Pr [ s \vert z ] = \frac{{U}_{zs}}{{\sum }_{k} {U}_{zk}} \qquad Equation ( 2 )$$

In the illustrated example of Equation (2) (e.g., stored in the example memory 114), Pr[s|z] represents a numerical value corresponding to a probability or likeliness of the consumer living in the region of interest z to shop at and/or provide currency to the particular store s. As used herein, Pr[s|z] is referred to as a “potential share of purchase” and/or a “purchase potential.” In some examples, Pr[s|z] facilitates calculated potentials or predictions (e.g., potential spending of households, potential ACVs of stores, and/or potential expenditures of regions of interest) associated with the households and stores in the geographic region. For example, the example projection system 100 calculates an amount of money or currency the household and/or person located in region of interest z is likely to spend (e.g., per year) at the stores based on the value of Pr[s|z], as discussed further below in connection with Equation (4). Example Equations (1) and (2) are sometimes referred to as a “Huff model” and/or a “Huff gravitational model.”

In the illustrated example of Equation (2), U_{zs} is a numerical value corresponding to the above disclosed utility of the household and/or person located in the region of interest z calculated in a manner consistent with Equation (1). U_{zk} represents a numerical value corresponding to another utility of the person and/or household in region of interest z extracted from another store k calculated in a manner consistent with Equation (1). Accordingly, Σₖ U_{zk} represents an aggregate of utilities of the person and/or the household in the region of interest z. That is, Σₖ U_{zk} represents a utility (e.g., a preference) of the person for one or more other stores (e.g., each store and/or all stores) in the geographic region.

The example calibration engine 108 of FIG. 1 is communicatively coupled to the memory 114 via the communication link(s) 124 to access and/or store data. In particular, the calibration engine 108 (and/or the modeling engine 106) uses one or more of the equation(s)/model(s) 140 stored in the memory 114 to calculate a rebuilt or potential ACV for one or more stores in the geographic region, for example, based on the above disclosed purchase potentials in connection with Equation (2). In particular, to enable the projection system 100 of FIG. 1 to generate accurate and/or useful projection weights (e.g., in a manner consistent with Equation (4)) based on the potential spending of households of interest, resulting potential ACVs (e.g., calculated via the modeling engine 106) of the stores in the geographic region substantially align to and/or match respective observed ACVs, as discussed further below in connection with Equation (3).

Similarly, the calibration engine 108 (and/or the modeling engine 106) also calculates a potential expenditure for one or more regions of interest in the geographic region, for example, based on the above disclosed purchase potentials in connection with Equation (2). In particular, to enable the projection system 100 of FIG. 1 to generate (e.g., in a manner consistent with Equation (4)) accurate and/or useful projection weights based on the potential spending of households of interest, resulting predicted expenditures of the regions of interest in the geographic region also substantially align to and/or match respective observed expenditures, which may be provided by Equations (1), (2) and/or (3), as discussed further below.

In some examples, the calibration engine 108 and/or the modeling engine 106 calculates one or more rebuilt or potential ACVs in a manner consistent with example Equation (3):

$${\sum }_{z ∈ Regions of Interest} {N}_{z} \cdot {\overline{S}}_{z} \cdot {P}_{r \vert z} = {ACV}_{Rebuilt \vert r} \qquad Equation ( 3 )$$

In the illustrated example of Equation (3) (e.g., stored in the example memory 114), N_{z} represents a numerical value corresponding to an observed number of households in the region of interest z, and S̅_{z} represents a numerical value corresponding to an observed amount of money or currency (e.g., an average or mean) spent by each household (e.g., per year, per month, per day, etc.), for example, obtained by the projection system 100 via the network(s) 116. As used herein, the quantity N_{z}·S̅_{z} may be referred to as an “expenditure” and/or an “observed expenditure” of the region of interest z. P_{r|z} is a numerical value corresponding to a purchase potential directed between a retailer r (e.g., a target retailer) and the region of interest z, for example, calculated in a manner consistent with Equation (1) and/or (2) above. Accordingly, the quantity N_{z}·S̅_{z}·P_{r|z} represents an aggregated potential or predicted spending of the households in the region of interest z at the retailer r, as facilitated by the purchase potential P_{r|z}. As previously disclosed, an example retailer (e.g., a company) includes one or more stores in the geographic region.

In the illustrated example of Equation (3), ACV_{Rebuilt|r} is a numerical value corresponding to a rebuilt or potential ACV of the retailer r. According to the illustrated example of Equation (3), the potential ACV of the retailer r is defined by the one or more purchase potentials (e.g., all purchase potentials) and corresponding observed expenditures of the regions of interest associated with one or more stores of the retailer r (e.g., regions of interest proximate to and/or exposed to the one or more stores of the retailer r). Stated differently, the rebuilt or potential ACV of the retailer r may be an aggregate of the purchase potentials and corresponding observed expenditures associated with the store(s) of the retailer r (e.g., an aggregate of calculated potential spending at the store(s) of the retailer r).

Similarly, in some examples, a potential or rebuilt expenditure (e.g., calculated via the projection system 100) of the region of interest z (and/or other regions of interest) is defined by one or more purchase potentials (e.g., all purchase potential(s)) associated with the region of interest z and the observed expenditure of the region of interest z. Stated differently, the potential or rebuilt expenditure of the region of interest z may be an aggregate of the purchase potentials associated with the region of interest z and the observed expenditure of the region of interest z (e.g., an aggregate of calculated potential spending at the stores in the geographic region by the region of interest z).

Equations (1), (2) and/or (3) may provide a potential or rebuilt expenditure of the region of interest z (and/or other regions of interest) that aligns to and/or matches a respective observed expenditure of the region of interest z. On the other hand, Equations (1), (2) and/or (3) may not provide a potential or rebuilt ACV of the retailer r that aligns to and/or matches a respective observed ACV of the retailer r, for example, when data associated with each household in the geographic region is not available. As previously disclosed, to generate accurate and/or useful projection weights based on calculated potential spending of households of interest as well as observed sales (e.g., an observed ACV) of the retailer r, calculated potential data associated with the store(s) of the retailer needs to be balanced relative to observed data associated with the store(s). In some examples, the modeling engine 106 and/or the calibration engine 108 calculate (e.g., simultaneously) both: (1) the potential ACV of the retailer r to substantially align to and/or match the observed ACV of the retailer r; and (2) the potential expenditures of the regions of interest to substantially align to and/or match respective observed expenditures.

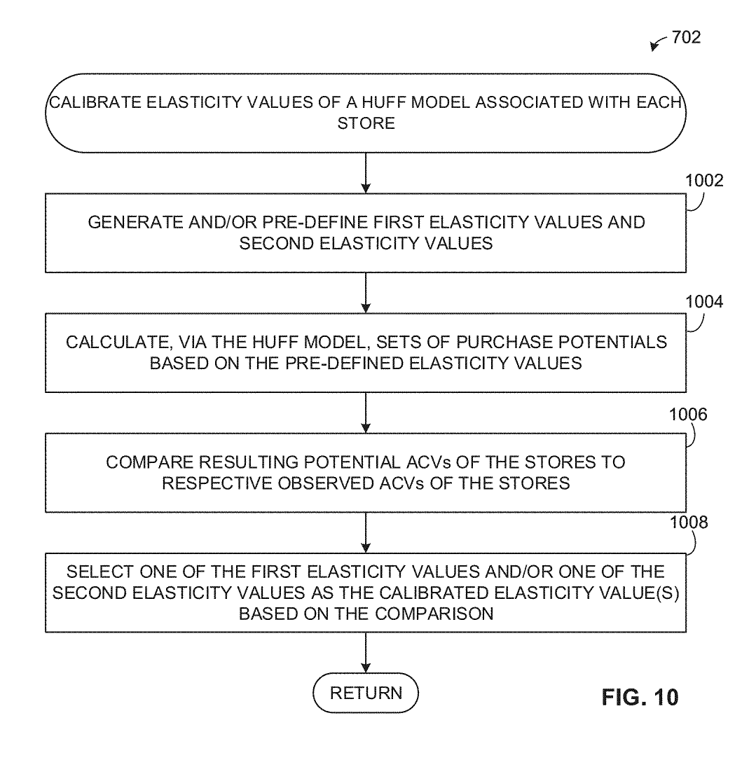

In some examples, to substantially align and/or match a potential ACV of the store s to the observed ACV (e.g., prior to identifying a target retailer), the elasticity values (α, β) of Equation (1) may be pre-defined, selected, adjusted, changed and/or otherwise calibrated. Typically, the first elasticity value α of Equation (1) may be pre-defined to have a value of 1 (e.g., a seed value), and the second elasticity value β may be pre-defined to have a value of 2 (e.g., a seed value) for each store in the geographic region. However, in some examples, the first elasticity value α and the second elasticity value β may be specific or unique to the store s (and/or other stores) and are each adjusted, changed and/or otherwise calibrated (e.g., via the calibration engine 108). For example, the calibration engine 108 may identify the first elasticity value α and/or the second elasticity value β to enable a resulting calculated potential ACV of the store s to substantially align to and/or match the respective observed ACV, for example, where the potential ACV is within about 95% of the observed ACV, which is disclosed in greater detailer below in connection with FIG. 10. After calibrating the first elasticity value α and/or the second elasticity value for one or more stores in the geographic region, the calibration engine 108 may store associated calibrated elasticity data 142 in the memory 114 for use by the projection system 100.

In some examples, to further align and/or match the potential ACV of the store s to the respective observed ACV of the store s, the calibration engine 108 calibrates the potential spending of the households in the region of interest z (e.g., the underlying purchase potential Pr[s|z] (and other purchase potentials)) as well as potential spending of households in other regions of interest associated with the store s. However, by calibrating and/or otherwise changing the potential spending and/or the underlying purchase potentials, the potential expenditures of the regions of interest may no longer align to and/or match their respective observed expenditures (e.g., the potential data associated with the store s is unbalanced relative to the observed data associated with the store), which may adversely affect resulting projection data generated by the projection engine 110. Thus, in such examples, the potential spending and/or the purchase potentials may endure one or more iterations of calibration to align and/or match (e.g., simultaneously) both: (1) the potential ACV of the store s to the respective observed ACV; and (2) the potential expenditures of the regions of interest to their respective observed expenditures. Calibration in this manner can be implemented, for example, using an iterative proportional fitting (IPF) technique or method, which is disclosed in greater detail below in connection with FIGS. 2A-C. After calibrating the potential spending and/or the purchase potentials associated with one or more stores in the geographic region, the example calibration engine 108 stores associated calibrated purchase potential data 144 in the memory 114.

The example projection engine 110 of FIG. 1 is communicatively coupled to the memory 114 via the communication link(s) 124 to access and/or store data. In particular, the projection engine 110 uses one or more of the equation(s)/models 140 stored in the memory 114 to calculate one or more projection factors or weights for a panel (e.g., a combined panel) associated with the geographic region, which facilitates marketing to consumers in the geographic region.

In some examples, the projection engine 110 calculates the projection weights in a manner consistent with example Equation (4):

$${\sum }_{HH} XF ( HH ) \cdot {\overline{S}}_{z ( HH )} \cdot {P}_{r \vert z ( HH )} = {ACV}_{Rebuilt \vert r} \qquad Equation ( 4 )$$

In the illustrated example of Equation (4) (e.g., stored in the example memory 114), XF(HH) represents a numerical value (sometimes referred to as a “projection weight” and/or a “projection factor”) corresponding to a household of interest HH (e.g., a household having at least a core panelist and/or an auxiliary panelist living and/or located therein) in the region of interest z. In some examples, the example household of interest HH (and/or one or more other households of interest) is associated with a particular demographic representation and/or a location of residence (e.g., obtained by the projection system 100 via the core panelist data source(s) 118 and/or the auxiliary panelist data source(s) 120). P^{r|z(HH)} represents a numerical value corresponding to a purchase potential (e.g., a calibrated purchase potential obtained via the calibrated purchase potential data 144) associated with at least a store (e.g., the example store s) of the retailer r and the region of interest z in which the household of interest HH is located, for example, calculated by the projection system 100 in a manner consistent with Equations (1) and (2) above. S̅_{z(HH)} represents a numerical value corresponding to an amount of money or currency (e.g., an average amount of money or currency) spent by each household in the region of interest z (e.g., spent per year, per month, per day, etc.), for example, obtained by the projection system 100 via the network(s) 116. ACV_{Rebuilt|r} represents a numerical value corresponding to an observed ACV of the retailer r, for example, obtained by the projection system 100 via the network(s) 116.

The projection engine 110 of FIG. 1 calculates projection data (e.g., one or more projected populations in the geographic region, projected potential spending for households of interest at one or more retailers, etc.) based on the projection weights of the panel. In some examples, to ensure accurate projections, the calibration engine 108 calibrates the projection weights to balance and/or align (e.g., simultaneously) both: (1) projected potential spending of the households of interest relative to observed sales of target retailers and/or target retail channels; and (2) projected population data of the geographic region relative to associated observed population data of the geographic region, which is disclosed in greater detail below in connection with FIGS. 3A-F. In this manner, the projection system 100 effectively reduces and/or eliminates errors in the projection weights that would have otherwise adversely affected the projection data.

The example memory 114 is communicatively coupled to the example data analyzer 102, the example distance calculator 104, the example modeling engine 106, the example calibration engine 108, the example projection engine 110, the example user interface 112, the example network(s) 116, the example core panelist data source(s) 118, the example auxiliary panelist data source(s) 120, the other data source(s) 122 and/or, more generally, the example projection system 100 of FIG. 1. In particular, the memory 114 stores and/or provides access to data associated with the example projection system 100. The example memory 114 of FIG. 1 may be implemented by one or more storage devices and/or one or more types of storage devices such as, for example, a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The data and/or information stored in the memory 114 may be stored in any file and/or data structure format, organization scheme, and/or arrangement. In some examples, the memory 114 stores and/or provides access to the above disclosed geographic data 126, population data 128, economic data 130, core panelist data 132, auxiliary panelist data 134, and/or other data associated with the geographic region and/or regions of interest in the geographic region. Further, the memory 114 stores and/or provides access to the equation(s)/model(s) 140 (e.g., Equation(s) (1), (2), (3), and/or (4) above), the calibrated elasticity data 142 and/or the calibrated purchase potential data 144.

FIGS. 2A-C show an example first table 200, an example second table 202, and an example third table 204 (e.g., generated by the example projection system 100), each of which illustrates potential spending associated with example households in an example geographic region. In particular, each of the tables 200, 202, and 204 illustrates a distribution of rebuilt or potential expenditures from example regions of interest in which the households are located to stores (e.g., all stores) in a geographic region facilitated by example purchase potentials, for example, calculated in a manner consistent with Equations (1) and/or (2).

As previously disclosed, Equations (1) and/or (2) may provide potential expenditures of regions of interest that align to and/or match respective observed expenditures, as shown in the first example table 200 of FIG. 2A (e.g., see columns 230 and 232). As will be disclosed further below in connection with the second table 202 and the third table 204, the underlying purchase potential data facilitating the predictions of the first table 200 may be calculated, changed, adjusted and/or calibrated to provide potential ACVs of the stores in the geographic region that substantially align to and/or match respective ACVs of the stores. However, as previously disclosed, by altering the underlying purchase potential data, potential expenditures of the regions of interest facilitated by the purchase potential data may no longer align to and/or match respective observed expenditures (e.g., shown in FIG. 2B; see columns 230 and 232), which may cause the projection engine 110 to generate erred projection data. Accordingly, in such examples, to generate accurate and/or useful projection weights for households of interest based on potential spending of the households (e.g., calculated in a manner consistent with Equation (4)), both: (1) the calculated potential ACVs substantially align to and/or match the respective observed ACVs (e.g., see row 234); and (2) the calculated potential expenditures substantially align to and/or match the respective observed expenditures (e.g., see column 238). As such, in some examples, the underlying purchase potential data of the first table 200 endures one or more iterations of calibration (e.g., via an iterative proportional fitting (IPF) technique or method) in connection with satisfaction of a number of iterations (e.g., 1 iteration, 10 iterations, 100 iterations, etc.) and/or one or more threshold values, for example, until convergence is achieved, thereby substantially aligning and/or matching the potential data to respective observed data. For example, the second table 202 of FIG. 2B illustrates a first iteration of calibration performed by the projection system 100, and the third table 204 of FIG. 2C illustrates a second iteration of calibration performed by the projection system 100.

In the illustrated example of FIGS. 2A-C, each of the tables 200, 202, 204 includes a first row 206 representing a distribution of a first potential expenditure 250 (e.g., $2,500 k or $2,500,000) from a first region of interest (e.g., a first zip code (“ZIP CODE 1”)) to a first store (store “A”), a second store (store “B”), a third store (store “C”), a fourth store (store “D”), and a fifth store (store “E”). This distribution of the first potential expenditure 250 of the first region of interest is calculated by the modeling engine 106 based on example purchase potentials (e.g., calculated by the modeling engine 106) associated with the first region of interest and each store in the geographic region (e.g., a country, a census region and/or division, etc.) in a manner consistent with Equations (1) and/or (2). For example, the first region of interest includes a first purchase potential Pr[s_{A}|z₁] associated with the first store (store “A”), a second purchase potential Pr[s_{B}|z₁] associated with the second store (store “B”), etc. Accordingly, a first portion 252 (e.g., $0) of the first potential expenditure 250 is calculated (e.g., via the modeling engine 106) for the first store (store “A”) based on the first purchase potential Pr[s_{A}|z₁], for example, where Pr[s_{A}|z₁]≅0% (e.g., due to a relatively large distance (e.g., 500 miles, 1,000 miles, 2,000 miles, etc.) between the first region of interest and the first store). Similarly, in the example of FIG. 2A, a second portion 254 (e.g., $1,000 k or $1,000,000) of the first potential expenditure 250 is calculated (e.g., via the modeling engine 106) for the second store (store “B”) based on the second purchase potential Pr[s_{B}|z₁], for example, where Pr[s_{B}|z₁]≅40%. In a similar manner, a third portion 256 (e.g., $0) of the first potential expenditure 250 is calculated (e.g., via the modeling engine 106) for the third store (store “C”), a fourth portion 258 (e.g., $1,200 k or $1,200,000) of the first potential expenditure 250 is calculated (e.g., via the modeling engine 106) for the fourth store (store “D”), and a fifth portion 260 (e.g., $300 k or $300,000) of the first potential expenditure 250 is calculated (e.g., via the modeling engine 106) for the fifth store (store “E”).

Similar to the first row 206, each of the tables 200, 202, 204 of FIGS. 2A-C also includes a second row 208 representing a distribution of a second potential expenditure 262 (e.g., $1,500 k or $1,500,000) from a second region of interest (e.g., a second zip code (“ZIP CODE 2”)) to the first store (store “A”), the second store (store “B”), the third store (store “C”), the fourth store (store “D”), and the fifth store (store “E”). This distribution of the second potential expenditure 262 of the second region of interest is likewise calculated by the modeling engine 106 based on example purchase potentials associated with the second region of interest and each store in the geographic region in a manner consistent with Equations (1) and/or (2). Further, each of the tables 200, 202, 204 of FIGS. 2A-C also includes a third row 210 representing a distribution of a third potential expenditure 264 (e.g., $3,000 k or $3,000,000) from a third region of interest (e.g., a third zip code (“ZIP CODE 3”)) to the first store (store “A”), the second store (store “B”), the third store (store “C”), the fourth store (store “D”), and the fifth store (store “E”); a fourth row 212 representing a distribution of a fourth potential expenditure 266 (e.g., $2,000 k or $2,000,000) from a fourth region of interest (e.g., a fourth zip code (“ZIP CODE 4”)) to the first store (store “A”), the second store (store “B”), the third store (store “C”), the fourth store, and the fifth store (store “D”); and a fifth row 214 representing a distribution of a fifth potential expenditure 268 (e.g., $1,000 k or $1,000,000) from a fifth region of interest (e.g., a fifth zip code (“ZIP CODE 5”)) to the first store (store “A”), the second store (store “B”), the third store (store “C”), the fourth store (store “D”), and the fifth store (store “E”).

While the example tables 200, 202, 204 of FIGS. 2A-C depict five example regions of interest (e.g., zip codes, census blocks, etc.) and five example stores (e.g., grocery stores, department stores, convenience stores, etc.) in a geographic region (e.g., a country, a census region and/or division, etc.), other disclosed examples include greater (e.g., each and/or all store(s)) or fewer (e.g., one store) stores in the geographic region. Further, other disclosed examples include additional (e.g., each and/or all region(s) of interest) or fewer (e.g., one region of interest) regions of interest in the geographic region.

In the illustrated example of FIGS. 2A-C, each of the tables 200, 202, 204 also includes a sixth row 216 representing a potential ACV of each store in the geographic region calculated by the modeling engine 106 based on the underlying purchase potential data in a manner consistent with Equations (1) and/or (2). As previously disclosed, a potential ACV of a store is an aggregate of associated portions of potential expenditures provided by the regions of interest. As shown in FIG. 2A, a first potential ACV 270 (e.g., $1,600 k or $1,600,000) of the first store is approximately equal to a sum of associated portions of potential expenditures, for example, the first portion 252 from the first region of interest (e.g., $0), a second portion 272 from the second region of interest (e.g., $0), a third portion 274 from the third region of interest (e.g., $500 k or $500,000), a fourth portion 276 from the fourth region of interest (e.g., $800 k or $8,000,000), and a fifth portion 278 from the fifth region of interest (e.g., $300 k or $300,000). Similarly, as shown in FIG. 2A, the modeling engine 106 likewise calculates a second potential ACV 280 (e.g., $2,000 k or $2,000,000) for the second store, a third potential ACV 282 (e.g., $2,800 k or $2,800,000) for the third store, a fourth potential ACV 284 (e.g., $1,900 k or $1,900,000) for the fourth store, and a fifth potential ACV 286 (e.g., $1,700 k or $1,700,000) for the fifth store.

In the illustrated example of FIGS. 2A-C, each of the tables 200, 202, 204 also includes a seventh row 218 representing an observed ACV of each store, for example, obtained by the projection system 100 via the network(s) 116. As shown in FIG. 2A, the first potential ACV 270 of the first store is not aligned to and/or does not match a respective first observed ACV 288 (e.g., $1,400 k or $1,400,000) of the first store (e.g., see row 234). As such, the underlying purchase potential data associated with the first store is considered to be uncalibrated.

In the example of FIG. 2A, each of the tables 200, 202, 204 also includes a first column 220 representing potential spending directed to the first store (store “A”) provided by the portions of rebuilt or potential expenditures 252 (e.g., $0), 272 (e.g., $0), 274 (e.g., $500 k), 276 (e.g., $800 k), and 278 (e.g., $300 k) from the first region of interest, the second region of interest, the third region of interest, the fourth region of interest, and the fifth region of interest, respectively; a second column 222 representing potential spending directed to the second store (store “B”) provided by portions of rebuilt or potential expenditures (e.g., $1,000 k, $500 k, $0, $500 k, and $0) from the first region of interest, the second region of interest, the third region of interest, the fourth region of interest, and the fifth region of interest; a third column 224 representing potential spending directed to the third store (store “C”) provided by portions of rebuilt or potential expenditures (e.g., $0, $1,000 k, $1,500 k, $0, and $300 k) from the first region of interest, the second region of interest, the third region of interest, the fourth region of interest, and the fifth region of interest; a fourth column 226 representing potential spending directed to the fourth store (store “D”) provided by portions of rebuilt or potential expenditures (e.g., $1,200 k, $0, $0, $700 k, and $0) from the first region of interest, the second region of interest, the third region of interest, the fourth region of interest, and the fifth region of interest; and a fifth column 228 representing potential spending directed to the fifth store (store “E”) provided by portions of rebuilt or potential expenditures (e.g., $300 k, $0, $1,000 k, $0, and $400) from the first region of interest, the second region of interest, the third region of interest, the fourth region of interest, and the fifth region of interest.

In the illustrated example of FIGS. 2A-C, each of the tables 200, 202, 204 also includes a sixth column 230 representing a rebuilt or potential expenditure of each region of interest calculated by the modeling engine 106 based on the underlying purchase potential data in a manner consistent with Equations (1), (2), and/or (3); and a seventh column 232 representing an expenditure (i.e., an observed expenditure) of each region of interest, for example, retrieved by the data analyzer 102 from the memory 114. As shown in FIG. 2A, the first potential expenditure 250 of the first region of interest is aligned to and/or matches a respective first observed expenditure 290 (e.g., $2,500 k or $2,500,000) of the first region of interest (e.g., see column 238).

In some examples, each of the tables 200, 202, 204 may also include an eighth row 234 representing a numerical difference (e.g., calculated via the data analyzer 102) between each potential ACV of the sixth row 216 and its corresponding observed ACV of the seventh row 218, which enables the example projection system 100 to determine whether the underlying purchase potential data is calibrated with respect to the potential ACVs and the observed ACVs. For example, as shown in FIG. 2A, the data analyzer 102 calculates a first difference 291 (e.g., $200 k or $2,000) between the first potential ACV 270 and the first observed ACV 288 of the first store. In such examples, the projection system 100 determines the purchase potentials are uncalibrated when one or more of the differences of the eighth row 234 exceed a first threshold value (e.g., +/−$100, $500, $1,000, etc.) and/or when one or more of the potential ACVs in the sixth row 216 do not converge relative to a respective one of the observed ACVs in the seventh row 218 (e.g., the first potential ACV 270 differs from the first observed ACV 288 by a percentage or proportion greater than about 0.1%). This uncalibrated purchase potential data may be caused by an insufficient number of iterations (e.g., 1 iteration, 5 iterations, 10 iterations, etc.) performed by the calibration engine 108.

To facilitate calibration of the underlying purchase potential data with respect to the potential ACVs and the observed ACVs, each of the tables 200, 202, 204 may also include a ninth row 236 representing a ratio or multiplier between each of the potential ACVs of the sixth row 216 and its respective observed ACV of the seventh row 218. This ratio or multiplier may be derived (e.g., calculated via the data analyzer 102) from the sixth row 216 and the seventh row 218. For example, as shown in FIG. 2A, a first multiplier 292 (e.g., 0.875) in the first column 220 associated with the first store is based on a proportion of the first observed ACV 288 of the first store and the first potential ACV 270 of the first store, for example, where

$$0.875 ≅ \frac{\$1 , 400 k}{\$1 , 600 k} .$$

In such examples, in response to the one or more differences of the first table 200 of FIG. 2A exceeding the first threshold value, the calibration engine 108 calculates, changes, adjusts, and/or calibrates the portions of the potential expenditures and/or the underlying purchase potential data associated with each store based on each corresponding factor to align and/or match each potential ACV to a respective one of the observed ACVs, for example, to generate the second table 202 of FIG. 2B. For example, with respect to the first column 220 of the first table 200 of FIG. 2A, the calibration engine 108 multiplies the first portion 252 from the first region of interest (e.g., $0) by 0.875, the second portion 272 from the second region of interest (e.g., $0) by 0.875, the third portion 274 from the third region of interest (e.g., $500 k) by 0.875, etc. Similarly, with respect to the second column 222, the calibration engine 108 multiplies the portion 254 from the first region of interest (e.g., $1,000 k) by 1.300, the portion from the second region of interest (e.g., $500 k) by 1.3, etc. Further, the calibration engine 108 likewise multiplies the other portions from the regions of interest for each column 224, 226, 228 in this manner, thereby calculating the second table 202 of FIG. 2B.

Similar to the eighth row 234 of the first table 200 of FIG. 2A, in some examples, each of the tables 200, 202, 204 also includes an eighth column 238 representing a numerical difference (e.g., calculated via the data analyzer 102) between each potential expenditure of the sixth column 230 and its corresponding observed expenditure of the seventh column 232, which may likewise enable the example projection system 100 to determine whether the underlying purchase potential data is calibrated with respect to the potential expenditures and the observed expenditures. For example, as shown in the second table 202 of FIG. 2B, the data analyzer 102 calculates a second difference 294 (e.g., $12.07 k or $12,070) between the first potential expenditure 250 and the first observed expenditure 290 of the first region of interest. In such examples, the projection system 100 determines the purchase potentials are uncalibrated when one or more of the differences in the eighth column 238 exceed a second threshold value (e.g., +/−$100, $500, $1,000, etc.) and/or when one or more of the potential expenditures in the sixth column 230 do not converge relative to a respective one of the observed expenditures in the seventh column 232 (e.g., the first potential expenditure 250 differs from the first observed expenditure 290 by a percentage or proportion greater than about 0.1%). As previously disclosed, this uncalibrated purchase potential data may be caused by an insufficient number of iterations (e.g., 1 iteration, 5 iterations, 10 iterations, etc.) performed by the calibration engine 108.

Similar to the ninth row 236 of the first table 200 of FIG. 2A, each of the tables 200, 202, 204 may also include a ninth column 240 representing a ratio or multiplier between each of the potential expenditures of the sixth column 230 and its corresponding observed expenditure of the seventh column 232, which may likewise facilitate calibration (e.g., via the calibration engine 108) of the underlying purchase potential data for the example projection system 100 with respect to the potential expenditures and the observed expenditures. This ratio or multiplier may be similarly derived (e.g., calculated via the data analyzer 102) from the sixth column 230 and the seventh column 232. For example, as shown in FIG. 2B, a second multiplier 296 (e.g., 0.99) in the first row 206 of the second table 202 associated with the first region of interest is based on a proportion of the first observed expenditure 290 and the first potential expenditure 250 of the first region of interest, for example, where

$$0.99 ≅ \frac{\$2 , 500 k}{\$2 , 512.07 k} .$$

In such examples, in response to the one or more differences of the eighth column 238 exceeding the second threshold value, the calibration engine 108 multiplies the portions of the potential expenditures associated with each region of interest by the corresponding factor to align and/or match each potential expenditure to a respective one of the observed expenditures, for example, to provide the third table 204 of FIG. 2C. For example, with respect to the first row 206 of the second table 202 of FIG. 2B, the calibration engine 108 multiplies the first portion 252 of the first region of interest (e.g., $0) by 0.99, the second portion 254 of the second region of interest (e.g., $1,300 k or $1,300,000) by 0.99, the third portion 256 of the third region of interest (e.g., $947.4 k or $947,400) by 0.99, etc. Similarly, with respect to the second row 208, the calibration engine 108 multiplies each of the portions of the second region of interest by 0.87. Further, the calibration engine 108 likewise multiplies the other portions of the regions of interest for each row 210, 212, 214 of the example second table 202 of FIG. 2B in this manner, thereby calculating the third table 204 of FIG. 2C.

In the illustrated example of FIG. 2A, the underlying purchase potential data facilitating the predictions of the first table 200 is uncalibrated. That is, while each potential expenditure 250, 262, 264, 266, 268 in the sixth column 230 equals its corresponding observed expenditure in the seventh column 232, each potential ACV 270, 280, 282, 284, 286 in the sixth row 216 does not align to and/or match its corresponding observed ACV in the seventh row 218. As previously disclosed, in some examples, the projection system 100 calibrates the purchase potentials facilitating the potentials or predictions to further reduce and/or eliminate adverse panel effects caused by the stores when generating projection weights. In such examples, the potential ACVs 270, 280, 282, 284, 286 of the stores in the geographic region need to substantially align to and/or match (e.g., in connection with satisfaction of the first threshold value) respective observed ACVs of the stores, and the potential expenditures 250, 262, 264, 266, 268 of the regions of interest in the geographic region need to likewise substantially align to and/or match (e.g., in connection with satisfaction of the second threshold value) respective observed expenditures of the regions of interest, for example, to balance the potential data associated with the stores relative to associated observed data.

Such calibration can be implemented by performing one or more iterations of an IPF method or technique. For example, the calibration engine 108 performs a first iteration for the first table 200 of FIG. 2A to calculate improved values of: (1) potential spending (e.g., 252, 254, 256, 258, 260, etc.) associated with households in the regions of interest (e.g., ZIPCODE 1, ZIPCODE 2, ZIPCODE 3, ZIPCODE 4, ZIPCODE 5, etc.) at the stores (e.g., store “A”, store “B”, store “C”, store “D”, store “E”, etc.) in the geographic region in the second table 202 of FIG. 2B; (2) potential expenditures (e.g., 250, 262, 264, 266, 268) of the regions of interest in the second table 202 of FIG. 2B; and (3) potential ACVs (e.g., 270, 280, 282, 284, 286, etc.) of the stores in the second table 202 of FIG. 2B Further, in some examples, the calibration engine 108 performs a second iteration for the second table 202 of FIG. 2B to further calculate improved values of: (1) potential spending (e.g., 252, 254, 256, 258, 260, etc.) associated with households in the regions of interest (e.g., ZIPCODE 1, ZIPCODE 2, ZIPCODE 3, ZIPCODE 4, ZIPCODE 5, etc.) at the stores (e.g., store “A”, store “B”, store “C”, store “D”, store “E”, etc.) in the geographic region in the third table 204 of FIG. 2C; (2) potential expenditures (e.g., 250, 262, 264, 266, 268) of the regions of interest in the third table 204 of FIG. 2C; and (3) potential ACVs (e.g., 270, 280, 282, 284, 286, etc.) of the stores in the third table 204 of FIG. 2C. The calibration engine 108 may perform iterations of calibration in this manner until convergence is achieved, for example, when the first threshold and/or the second threshold are satisfied, thereby substantially aligning and/or matching both: (1) each of the potential ACVs 270, 280, 282, 284, 286 of the stores in the sixth row 216 to a respective one of the observed ACVs in the seventh row 218; and (2) each of the potential expenditures 250, 262, 264, 266, 268 of the regions of interest in the sixth column 230 to a respective one of the observed expenditures in the seventh column 232. In some examples, the calibration engine 108 performs a pre-determined number of iterations associated with convergence (e.g., about 50 or more iterations).

In the illustrated example of FIG. 2B, unlike the illustrated example of FIG. 2A, each potential ACV value 270, 280, 282, 284, 286 in the sixth row 216 aligns to and/or matches its corresponding observed ACV value in the seventh row 218. However, unlike the illustrated example of FIG. 2A, each potential expenditure value 250, 262, 264, 266, 268 in the sixth column 230 of FIG. 2B does not substantially align to and/or match its corresponding observed expenditure value in the seventh column 232 of FIG. 2B. Accordingly, the purchase potential data associated with the second table 202 of FIG. 2B is still considered to be uncalibrated and may cause erred projection data. As a result, the calibration engine 108 performs the second iteration of calibration based on the multipliers in the ninth column 240 to align and/or match each potential expenditure 250, 262, 264, 266, 268 in the sixth column 230 to its respective observed expenditure in the seventh column 232, thereby calculating the third table 204 of FIG. 2C.

In the illustrated example of FIG. 2C, the underlying purchase potential data facilitating the predictions of the third table 204 is still uncalibrated. However, each of the numerical differences in the eighth row 234 of the third table 204 are significantly smaller relative to the corresponding numerical differences in the eighth row 234 of the first table 202.

After the purchase potential data facilitating the predictions associated with the examples tables 200, 202, 204 is considered to be calibrated (e.g., after the calibration engine 108 performs about 50 or more iterations), the projection system 100 stores the purchase potential data in the memory 114 as part of the calibrated purchase potential data 144, and the projection engine 110 generates projection weights for households of interest in each region of interest based on the calibrated purchase potential data 144, for example, calculated in a manner consistent with Equation (4), as disclosed in greater detail below in connection with FIGS. 3A-F. By calibrating the underlying purchase potential data of the example tables 200, 202, 204 in the manner disclosed above in connection with FIGS. 2A-C, the example projection engine is better enabled to generate projection weights with improved accuracy by reducing and/or eliminating panel imbalance errors caused by the auxiliary panelist data 134 and/or the stores in the geographic region that may be associated with a store bias and/or a shopping bias.

FIG. 3A illustrates an example fourth table 3000 (e.g., generated by the example projection system 100) showing example calibration parameters associated with an example panel in accordance with examples disclosed herein. In the illustrated example of FIG. 3A, the fourth table 3000 includes households of interest (e.g., households having panelists) associated with the example panel, such as first example household of interest 3002 (household “A”), a second example household of interest 3004 (household “B”), a third example household of interest 3006 (household “C”), a fourth example household of interest 3008 (household “D”), and a fifth example household of interest 3010 (household “E”). While the example of FIG. 3A depicts the example panel including the five example households of interest 3002, 3004, 3006, 3008, 3010, in other examples, the panel includes a different number (e.g., 1,000, 25,000, 100,000, etc.) of households of interest.

In some examples, the projection system 100 identifies one or more attributes of interest (e.g., demographic attributes and/or spending attributes) of the households that may be indicative of panel imbalance (e.g., caused by one or more of a demographic bias, a store bias, and/or a shopping bias). For example, a first example attribute of interest 3012 is associated with a first household size (e.g., a household having only one resident), a second example attribute of interest 3014 is associated with a second household size (e.g., a household having only two residents), and a third example attribute of interest 3016 is associated with a third household size (e.g., a household having three or more residents). The example attributes of interest 3012, 3014, 3016 are associated with a demographic representation (e.g., identified by the data analyzer 102 via the panelist data 132, 134) and may be pre-defined or pre-determined by the example projection system 100. While the example of FIG. 3A depicts the three example demographic related attributes of interest 3012, 3014, 3016, in other examples, the example projection system 100 may implement additional, fewer, and/or different attributes of interest.

As shown in FIG. 3A, the data analyzer 102 analyzes the panelist data 132, 134 in the memory 114 to flag and/or identify the first household of interest 3002 and the second household of interest 3004 as corresponding to and/or sharing the first attribute of interest 3012 (as represented by the text “TRUE” in the fourth table 3000), the third household of interest 3006 and the fourth household of interest 3008 as corresponding to and/or sharing the second attribute of interest 3014 (as represented by the text “TRUE” in the fourth table 3000), and the fifth household of interest 3010 as corresponding to and/or sharing the third attribute of interest 3016 (as represented by the text “TRUE” in the fourth table 3000).

As disclosed further below in connection with FIGS. 3B-F, each of the example households of interest 3002, 3004, 3006, 3008, 3010 represent one or more projected populations (e.g., a calculated number of households) in the geographic region. For example, the first household of interest 3002 and the second household of interest, as well as projection weights associated therewith, represent a first example projected population (e.g., see the example values 3102, 3104, 3106 in the sixth table 3078 of FIG. 3C below) in the geographic region corresponding to the first attribute of interest 3012. Further, in the example of FIG. 3A, the third household of interest 3006 and the fourth household of interest 3008, as well as projection weights associated therewith, represent a second example projected population (e.g., see the example values 3108, 3110, 3112 in the sixth table 3078 of FIG. 3C below) in the geographic region corresponding to the second attribute of interest 3014, and the fifth household of interest 3010 represents a third example projected population (e.g., see the example values 3114, 3116 in the sixth table 3078 of FIG. 3C) in the geographic region corresponding to the third attribute of interest 3016. As such, the example households of interest 3002, 3004, 3006, 3008, 3010 of FIG. 3A, as well as their associated projection weights, together represent a projected total population (e.g., see the example value 3071 in the fifth table 3054 of FIG. 3B below) in the geographic region.

In particular, the example projection system 100 calculates the projection weights for the households of interest 3002, 3004, 3006, 3008, 3010 to align and/or match the example projected populations relative to observed populations of the geographic region, thereby reducing and/or eliminating one or more biases (e.g., a demographic bias) associated with imbalance of the example panel, which is disclosed in greater detail below. By extension, reducing bias also reduces errors in the household projection weights as well as improves projection accuracy. Further, in such examples, the example projection system 100 also calculates the projection weights for the households of interest 3002, 3004, 3006, 3008, 3010 to similarly align and/or match projected potential spending of the households of interest 3002, 3004, 3006, 3008, 3010 at one or more target retailer (e.g., retailer “A,” retailer “B,” retailer “C,” etc. determined by the projection system 100) relative to observed sales of the target retailer(s), thereby reducing and/or eliminating one or more other biases (e.g., a store and/or a shopping bias) associated with imbalance of the example panel, as disclosed further below. Accordingly, as shown in FIG. 3A, the example fourth table 3000 includes a fourth example attribute of interest 3018 associated with spending at a first target retailer (retailer “A”) (e.g., potential money spent at stores of the first target retailer (retailer “A”)), a fifth example attribute of interest 3020 associated with spending at a second target retailer (retailer “B”) (e.g., potential money spent at stores of the second target retailer (retailer “B”)), and a sixth example attribute of interest 3022 associated with spending at a third target retailer (retailer “C”) (e.g., potential money spent at stores of the third target retailer (retailer “C”)).

While the example of FIG. 3A depicts the three example spending related attributes of interest 3018, 3020, 3022 for calibration by the example projection system 100, in other examples, the example projection system 100 may use additional, fewer and/or different attributes of interest.

In the example of FIG. 3A, the fourth example table 3000 includes potential spending (e.g., calculated via the modeling engine 106) of the example households of interest 3002, 3004, 3006, 3008, 3010 at the example target retailers (retailers “A”, “B”, and “C”). For example, the modeling engine 106 calculates potential money spent at the first target retailer (retailer “A”) by each of the households of interest 3002, 3004, 3006, 3008, 3010 (e.g., in a manner consistent with Equation(s) (1), (2), and/or (3)). As such, the example fourth table 3000 of FIG. 3A includes: (1) a first example value 3024 (e.g., $20 per year) of potential money spent at one or more stores of the first target retailer (retailer “A”) by the first household of interest 3002 (household “A”); (2) a second example value 3026 (e.g., $0 per year) of potential money spent at the store(s) of the first target retailer (retailer “A”) by the second household of interest 3004 (household “B”); (3) a third example value 3028 (e.g., $20 per year) of potential money spent at the store(s) of the first target retailer (retailer “A”) by the third household of interest 3006 (household “C”); (4) a fourth value 3030 (e.g., $0 per year) of potential money spent at the store(s) of the first target retailer (retailer “A”) by the fourth household of interest 3008 (household “D”); and (5) a fifth example value 3032 (e.g., $0 per year) of potential money spent at the store(s) of the first target retailer (retailer “A”) by the fifth household of interest 3010 (household “E”).

Further still, with respect to the second example retailer 3020 (retailer “B”), the fourth example table 3000 of FIG. 3A similarly includes: (1) a first example value 3034 (e.g., $10 per year) of potential money spent at one or more stores of the second target retailer (retailer “B”) by the first household of interest 3002 (household “A”); (2) a second example value 3036 (e.g., $15 per year) of potential money spent at the store(s) of the second target retailer (retailer “B”) by the second household of interest 3004 (household “B”); (3) a third example value 3038 (e.g., $10 per year) of potential money spent at the store(s) of the second target retailer (retailer “B”) by the third household of interest 3006 (household “C”); (4) a fourth example value 3040 (e.g., $15 per year) of potential money spent at the store(s) of the second target retailer (retailer “B”) by the fourth household of interest 3008 (household “D”); and (5) a fifth example value 3042 (e.g., $15 per year) of potential money spent at the store(s) of the second target retailer (retailer “B”) by the fifth household of interest 3010 (household “E”).

Further still, with respect to the third example retailer (retailer “C”), the fourth example table 3000 of FIG. 3A similarly includes: (1) a first example value 3044 (e.g., $0 per year) of potential money spent at one or more stores of the third target retailer (retailer “C”) by the first household of interest 3002 (household “A”); (2) a second example value 3046 (e.g., $20 per year) of potential money spent at the store(s) of the third target retailer (retailer “C”) by the second household of interest 3004 (household “B”); (3) a third example value 3048 (e.g., $0 per year) of potential money spent at the store(s) of the third target retailer (retailer “C”) by the third household of interest 3006 (household “C”); (4) a fourth example value 3050 (e.g., $20 per year) of potential money spent at the store(s) of the third target retailer (retailer “B”) by the fourth household of interest 3008 (household “D”); and (5) a fifth example value 3052 (e.g., $20 per year) of potential money spent at the store(s) of the third target retailer (retailer “C”) by the fifth household of interest 3010 (household “E”).

In some examples, the example values 3024, 3026, 3028, 3030, 3032, 3034, 3036, 3038, 3040, 3042, 3044, 3046, 3048, 3050, 3052 of money spent at the example target retailers (retailer “A,” “B,” and “C”) of FIG. 3A are calculated at least partially based on purchase potential data associated with a region of interest in which the example households of interest 3002, 3004, 3006, 3008, 3010 are located. As previously disclosed above in connection with FIGS. 2A-C, the projection system 100 calculates the calibrated purchase potential data 144 and/or stores the calibrated purchase potential data 144 in the memory 114 (e.g., see the tables 200, 202, 204 of FIGS. 2A-C) that balances and/or aligns (e.g., simultaneously) both: (1) potential sales of the stores in the geographic region relative to observed sales of the stores; and (2) potential expenditures of the regions of interest in the geographic region relative to observed expenditures of the regions of interest. In the example of FIG. 3A, the first household of interest 3002 (household “A”) is located in the first example region of interest (e.g., a first zip code) and, as a result, an underlying purchase potential (e.g., Pr[r_{A}|z₁]≅40%) associated with the first region of interest and the first target retailer enables the projection system 100 to calculate the first value 3024 of potential money spent at the first retailer (retailer “A”) by the first household of interest (household “A”), for example, where

$$20 \frac{\$}{year} ≅ \overline{{S}_{{z}_{1}}} \cdot Pr [ {r}_{A} \vert {z}_{1} ] .$$

In this example, as previously disclosed in connection with Equation (4), S̅_̅{̅z̅}̅_̅{̅₁̅}̅ is a numerical value (e.g., 50 $ per year) that represents an observed average spending (e.g., annually) of households (e.g., panelist households and/or non-panelist households) located within the first region of interest.

Similarly, in the example of FIG. 3A, the second household of interest (household “B”) is located in the second example region of interest (e.g., a second zip code) and, as a result, an underlying purchase potential (e.g., Pr[r_{A}|z₂]≅0%) associated with the second region of interest and the first target retailer enables the projection system 100 to calculate the second value 3026 of potential money spent at the first target retailer (retailer “A”) by the second household of interest (household “A”), for example, where

$$0 \frac{\$}{year} ≅ \overline{{S}_{{z}_{2}}} \cdot Pr [ {r}_{A} \vert {z}_{2} ] .$$

Further, in some examples, the example projection system 100 likewise calculates one or more of the other values 3028, 3030, 3032, 3034, 3036, 3038, 3040, 3042, 3044, 3046, 3048, 3050, 3052 of potential money spent at the example target retailers based on underlying purchase potentials associated with other regions of interest in which the other households of interest 3006, 3008, 3010 are located.

Accordingly, in some such examples, households of interest located in the same region of interest have the same calculated potential spending at the stores of the target retailers. For example, as shown in FIG. 3A, the first household of interest 3002 (household “A”) and the third household of interest 3006 are both located in the first example region of interest and, thus, share: (1) equivalent values 3024, 3028 of potential money spent at the store(s) of the first target retailer (retailer “A”); (2) equivalent values 3034, 3038 of potential money spent at the second target retailer (retailer “B”); and (3) equivalent values 3044, 3048 of potential money spent at the store(s) of the third target retailer (retailer “C”).

FIG. 3B illustrates an example fifth table 3054 (e.g., generated by the example projection system 100) showing example calculated projection weights associated with the example panel of FIG. 3A. In particular, the projection system 100 calculates example projected population data and/or projected sales data based on the household projection weights, which facilitates calibration of the projection weights, as disclosed further below in connection with FIGS. 3C-F. As previously disclosed, the projection engine 110 calculates projection weights for the panel that balance and/or align (e.g., simultaneously) both: (1) the projected potential spending of the example households of interest 3002, 3004, 3006, 3008, 3010 at the example target retailers (retailers “A”, “B”, and “C”) relative to the observed sales (e.g., observed ACVs) of the target retailers; and (2) the projected populations associated with the example households of interest 3002, 3004, 3006, 3008, 3010 relative to observed populations of the geographic region.

As shown in FIG. 3B, the projection engine 110 calculates a first example projection weight XF₁ 3056 corresponding to the first household of interest 3002 and a second example projection weight XF₂ 3058 corresponding to the second household of interest 3004, for example, where XF₁≅1,282 and XF₂≅720. In particular, the first projection weight XF₁ 3056 and the second projection weight XF₂ 3058 together represent the above disclosed first projected population in the geographic region having the first attribute of interest 3012, for example, where the first projected population≅1,282 households+720 households. As shown in FIG. 3B, the first projected population substantially aligns to and/or matches a first example observed population 3060 (e.g., 2,000 households) (e.g., obtained and/or identified via the projection system 100) in the geographic region associated with the first attribute of interest 3012, for example, where the first observed population XF₁+XF₂. Similarly, in the example fifth table 3054 of FIG. 3B, the projection engine 110 calculates a third example projection weight XF₃ 3062 corresponding to the third household of interest 3006 and a fourth example projection weight XF₄ 3064 corresponding to the fourth household of interest 3008, for example, where XF₃≅1,218 and XF₄≅682. In particular, the third projection weight XF₃ 3062 and the fourth projection weight XF₄ 3064 together represent the above disclosed second projected population (e.g., where the second projected population≅1,218 households+682 households) in the geographic region associated with the second attribute of interest 3014. As shown in FIG. 3B, the second projected population substantially aligns to and/or matches a second example observed population 3066 (e.g., 1,900 households) (e.g., obtained and/or identified via the projection system 100) in the geographic region, for example, where the second observed population≅XF₃+XF₄. Similarly, in the example fifth table 3054 of FIG. 3B, the projection engine 110 calculates a fifth example projection weight XF₅ 3068 corresponding to the fifth household of interest 3010, for example, where XF₅≅1,100. In particular, the fifth projection weight XF₅ 3068 represents the above disclosed third projected population (e.g., where the third projected population≅1,100 households) in the geographic region associated with the third attribute of interest 3016. As shown in FIG. 3B, the third projected population substantially aligns to and/or matches a third example observed population 3070 (e.g., 1,100 households) (e.g., obtained and/or identified via the projection system 100) in the geographic region, for example, where the third observed population≅XF₅. As shown in FIG. 3B, the example fifth table 3054 includes an example total observed population 3071 (e.g., 5,000 households) based on the three example observed populations 3060, 3066, 3070, for example, where the total observed population 3071 is equivalent to an aggregate of the example observed populations 3060, 3066, 3070.

The example projection weights 3056, 3058, 3062, 3064, 3068 in the fifth table 3054 of FIG. 3B are final values (e.g., calculated by the projection engine 110 in a manner consisted with Equation (4)) and are considered to be balanced and/or calibrated. In particular, the example projection weights 3056, 3058, 3062, 3064, 3068 of FIG. 3B provide a first projected potential ACV of the first target retailer (retailer “A”) that substantially aligns to and/or matches a first example observed ACV (e.g., 50,000 $ per year) 3072 (e.g., obtained and/or identified via the projection system 100) of the first target retailer. Further, the projection weights 3056, 3058, 3062, 3064, 3068 in the example fifth table 3054 similarly provide a second projected potential ACV of the second target retailer (retailer “B”) that substantially aligns to and/or matches a second example observed ACV (e.g., 62,500 $ per year) 3074 (e.g., obtained and/or identified via the projection system 100) of the second target retailer. Further still, in the illustrated example of FIG. 3B, the projection weights 3056, 3058, 3062, 3064, 3068 similarly provide a third projected potential ACV of the third target retailer (retailer “C”) that substantially aligns to and/or matches a third example observed ACV (e.g., 50,000 $ per year) 3076 (e.g., obtained and/or identified via the projection system 100) of the third target retailer.

In the illustrated example of FIG. 3B, the above disclosed example values 3024, 3026, 3028, 3030, 3032, 3034, 3036, 3038, 3040, 3042, 3044, 3046, 3048, 3050, 3052 (see FIG. 3A) representing potential spending at the target retailers (retailers “A”, “B”, “C”) are multiplied and/or changed based on a respective one of the projection weights 3056, 3058, 3062, 3064, 3068, thereby providing values of projected potential spending of the households of interest 3002, 3004, 3006, 3008, 3010. In particular, as shown in FIG. 3B, the first projected potential ACV of the first target retailer (retailer “A”) substantially aligns to and/or matches the first observed ACV 3072 of the first target retailer, where the first projected potential

Similarly, in the example of FIG. 3B, the second projected potential ACV of the second target retailer (retailer “B”) substantially aligns to and/or matches the second observed ACV 3074 of the first target retailer, where the second projected potential

$$ACV ≅ ( {XF}_{1} \cdot 20 \frac{\$}{year} ) + ( {XF}_{2} \cdot 0 \frac{\$}{year} ) + ( {XF}_{3} \cdot 20 \frac{\$}{year} ) + ( {XF}_{4} \cdot 0 \frac{\$}{year} ) + ( {XF}_{5} \cdot 0 \frac{\$}{year} ) .$$

Similarly, in the example of FIG. 3B, the third projected potential ACV of the third target retailer (retailer “C”) substantially aligns to and/or matches matches the second observed ACV 3074 of the first target retailer, where the second projected potential

$$ACV ≅ ( {XF}_{1} \cdot 10 \frac{\$}{year} ) + ( {XF}_{2} \cdot 15 \frac{\$}{year} ) + ( {XF}_{3} \cdot 10 \frac{\$}{year} ) + ( {XF}_{4} \cdot 15 \frac{\$}{year} ) + ( {XF}_{5} \cdot 15 \frac{\$}{year} ) .$$

Similarly, in the example of FIG. 3B. the third projected potential ACV of the third target retailer (retailer “C”) substantially aligns to and/or matches the, third observed ACV 3026 of the first inreel retailer, where, the third nrniefleri potential the third observed ACV 3076 of the first target retailer where the third projected potential

$$ACV ≅ ( {XF}_{1} \cdot 10 \frac{\$}{year} ) + ( {XF}_{2} \cdot 20 \frac{\$}{year} ) + ( {XF}_{3} \cdot 0 \frac{\$}{year} ) + ( {XF}_{4} \cdot 20 \frac{\$}{year} ) + ( {XF}_{5} \cdot 20 \frac{\$}{year} ) .$$

As shown in FIG. 3B, the example projection weights 3056, 3058, 3062, 3064, 3068 of the fifth example table 3054 balance and/or align both: (1) the values of projected potential spending of the example households of interest 3002, 3004, 3006, 3008, 3010 at the example target retailers (retailers “A”, “B”, and “C”) relative to the observed ACVs 3072, 3074, 3076 of the target retailers; and (2) the projected populations (e.g., the first projected population, the second projected population, the third projected population, etc.) associated with the panel relative to the observed populations 3060, 3066, 3070 in the geographic region. In some examples, the projection engine 110 calculates the projection weights 3056, 3058, 3062, 3064, 3068 of the fifth table 3054 in this manner by implementing one or more calibration methods and/or techniques, such as an IPF method, as disclosed further below in connection with FIGS. 3C-F.

FIG. 3C illustrates an example sixth table 3078 (e.g., generated by the example projection system 100) associated with generating the example projection weights 3056, 3058, 3062, 3064, 3068 in the fifth table 3054 of FIG. 3B. Unlike FIG. 3B, which depicts the projection weights 3056, 3058, 3062, 3064, 3068 to be balanced and/or calibrated having final calculated values (e.g., where XF₁≅1,282, XF₂≅32 720, XF₃≅1,218, XF₄≅682, and XF₅≅1,100), the illustrated example of FIG. 3C depicts the projection weights 3056, 3058, 3062, 3064, 3068 having initial and/or seed values (e.g., where XF₁≅XF₂≅XF₃≅XF₄≅XF₅≅1,000), as disclosed further below. In particular, FIG. 3C illustrates a first iteration of an example calibration method and/or technique that may be performed by the example projection system 100 to reduce and/or eliminate panel imbalance that may be associated with the example households of interest 3002, 3004, 3006, 3008, 3010 of the example panel.

In the example sixth table 3078 of FIG. 3C, the projection weights 3056, 3058, 3062, 3064, 3068 (e.g., calculated by the projection engine 110) include an initial and/or seed value. In some examples, the projection engine 110 calculates an average projection weight based on the total observed population 3071 as well as a size of the example panel (e.g., a total number of the households of interest 3002, 3004, 3006, 3008, 3010). For example, as shown in FIG. 3C,

$${XF}_{1} = {XF}_{2} = {XF}_{3} = {XF}_{4} = {XF}_{5} = \frac{5 , 000 households}{5 households of interest} .$$

The projection weights 3056, 3058, 3062, 3064, 3068 of FIG. 3C provide projected potential spending of the households of interest 3002, 3004, 3006, 3008, 3010 at each target retailer (retailer “A,” “B,” and/or “C”). For example, as shown in FIG. 3C, the sixth table 3078 includes a first example value 3080 (e.g., $20,000 per year) (e.g., calculated by the projection engine 110), an example second value 3082 (e.g., $0 per year) (e.g., calculated by the projection engine 110), a third example value 3084 (e.g., $20,000 per year) (e.g., calculated by the projection engine 110), a fourth example value 3086 (e.g., $0 per year) (e.g., calculated by the projection engine 110), and a fifth example value 3088 (e.g., $0 per year) (e.g., calculated by the projection engine 110), where each value 3080, 3082, 3084, 3086, 3088 represents projected potential money spent at the first target retailer (retailer “A”) by the households of interest 3002, 3004, 3006, 3008, 3010. In particular, the example values 3080, 3082, 3084, 3086, 3088 of FIG. 3C together represent a first projected potential ACV 3090 (e.g., $40,000 per year) (e.g., calculated by the projection engine 110) of the first target retailer, for example, where the first projected potential ACV≅$20,000+$0+$20,000+$0+$0. Similarly, the projection engine 110 may likewise calculate a second projected potential ACV 3092 (e.g., $65,000) for the second target retailer (retailer “B”) as well as a third projected potential ACV 3094 for the third target retailer (retailer “C”) based on associated values of projected potential spending of the households of interest 3002, 3004, 3006, 3008, 3010.

As shown in FIG. 3C, at least one of the projected potential ACVs 3090, 3092, 3094 of the target retailers (retailer “A,” “B,” and “C”) do not substantially align to and/or match a respective one of the observed ACVs 3072, 3074, 3076 of the target retailers. For example, the first projected potential ACV 3090 differs from the first observed ACV 3072 by a first value 3096 (e.g., about $10,000 per year) (e.g., calculated by the projection engine 110). Further, the second projected ACV 3092 similarly differs from the second observed ACV 3074 by a second value 3098 (e.g., about $2,500 per year) (e.g., calculated by the projection engine 110). Further still, the third projected ACV 3094 similarly differs from the third observed ACV 3076 by a third value 3100 (e.g., about $10,000 per year) (e.g., calculated by the projection engine 110). As such, the example projection weights 3056, 3058, 3062, 3064, 3068 of FIG. 3C are considered to be uncalibrated and/or unbalanced with respect to observed sales data, for example, when at least one of the example difference values 3096, 3098, 3100 exceed a third example threshold (e.g., $1, per year, $10 per year, $100 per year, etc.) and/or the projection system 100 has not performed a sufficient number (e.g., about 50) of iterations of calibration associated with difference values 3096, 3098, 3100 converging.

Similar to projecting the potential spending of the households of interest 3002, 3004, 3006, 3008, 3010 and/or the potential sales of the retailers (retailer “A,” “B,” and “C”), the projection factors 3056, 3058, 3062, 3064, 3068 of FIG. 3C also represent one or more projected populations in the geographic region. For example, as shown in FIG. 3C, the sixth table 3078 includes a first example value 3102 (e.g., 1,000 households) (e.g., calculated by the projection engine 110) based on the first projection weight 3056 and a second example value 3104 (e.g., 1,000 households) (e.g., calculated by the projection engine 110) based on the second projection weight 3058 that together represent the first example projected population 3106 in the geographic region, for example, where the first projected population≅1,000 households+1,000 households. Further, in the example of FIG. 3C, the sixth table 3078 likewise includes a third example value 3108 (e.g., 1,000 households) (e.g., calculated by the projection engine 110) based on the third projection weight 3062 and a fourth example value 3110 (e.g., 1,000 households per year) (e.g., calculated by the projection engine 110) based on the fourth projection weight 3064 that together represent the second example projected population 3112 in the geographic region, for example, where the second projected population≅1,000 households+1,000 households. Further still, in the example of FIG. 3C, the sixth table 3078 likewise includes a fifth example value 3114 (e.g., 1,000 households) (e.g., calculated by the projection engine 110) based on the fifth projection weight 3068 that represents the third example projected population 3116 in the geographic region, for example, where the third projected population≅1,000 households.

As shown in FIG. 3C, at least one of the projected populations 3106, 3112, 3116 provided by the example panel do not substantially align to and/or match a respective one of the observed populations 3060, 3066, 3070 in the geographic region. In the example of FIG. 3C, the first projected population 3106 does not differ from the first observed population 3060 based on a first value 3118 (e.g., about 0 households) (e.g., calculated by the projection engine 110). However, the second projected population 3112 differs from the second observed population 3066 by a second value 3120 (e.g., about 100 households) (e.g., calculated by the projection engine 110). Further still, the third projected population 3116 similarly differs from the third observed population 3070 by a third value 3122 (e.g., about 100 households) (e.g., calculated by the projection engine 110). As such, the example projection weights 3056, 3058, 3062, 3064, 3068 of FIG. 3C are considered to be uncalibrated and/or unbalanced with respect to population data, for example, when at least one of the example difference values 3118, 3120, 3122 exceed a fourth example threshold (e.g., 1 household, 5 households, 50 households, etc.) and/or the projection system 100 has not performed a sufficient number (e.g., about 50) of iterations of calibration associated with the difference values 3118, 3120, 3122 converging.

In some examples, the projection system 100 determines at least one of the example projection weights 3056, 3058, 3062, 3064, 3068 is uncalibrated and/or unbalanced with respect to projected populations and observed populations. In such example, in response to the determination, the example calibration engine 108 re-calculates and/or changes the projection weights 3056, 3058, 3062, 3064, 3068 based on the attribute(s) of interest at least partially responsible for the panel imbalance (e.g., the demographic related attributes of interest 3012, 3014, 3016) and/or a ratio or multiplier between the projected population data 3106, 3112, 3116 and the observed population data 3060, 3066, 3070. For example, as shown in FIG. 3C, the calibration engine 108 changes the first projection weight 3056 and the second projection weight 3058 based on a first multiplier 3124 (e.g., 1.00) (e.g., calculated by the calibration engine 108) between the first projected population 3106 and the first observed population 3060, for example, where the

$$first multiplier ≅ \frac{2 , 000 households}{2 , 000 households} .$$

In this example, the projection engine 110 determines only the first household of interest 3002 and the second household of interest 3004 are representing the first observed population 3060 and, in response, changes only the first projection weight 3056 and the second projection weight 3058 based on the first multiplier 3124.

Further, in the example of FIG. 3C, the calibration engine 108 changes the third projection weight 3062 and the fourth projection weight 3064 based on a second multiplier 3126 (e.g., 0.95) (e.g., calculated by the calibration engine 108) between the second projected population 3112 and the second observed population 3066, for example, where the

$$second multiplier ≅ \frac{1 , 900 households}{2 , 000 households} .$$

In this example, the calibration engine 108 similarly determines only the third household of interest 3006 and the fourth household of interest 3008 are representing the second observed population 3066 and, in response, changes only the third projection weight 3062 and the fourth projection weight 3064 based on the second multiplier 3126.

Further still, in the example of FIG. 3C, the calibration engine 108 changes the fifth projection weight 3068 based on a third multiplier 3128 (e.g., 1.10) (e.g., calculated by the calibration engine 108) between the third projected population 3116 and the third observed population 3070, for example, where the

$$third multiplier ≅ \frac{1 , 100 households}{1 , 000 households} .$$

In this example, the calibration engine 108 similarly determines only the fifth household of interest 3010 is representing the third observed population 3070 and, in response, changes only the fifth projection weight 3068 based on the third multiplier 3128

In this manner, the projection system 100 performs the first iteration of calibration by calculating improved projection weights 3056, 3058, 3062, 3064, 3068 for the example panel, for example, where XF₁≅1,000, XF₂≅1,000, XF₃≅950, XF₄≅950, and XF₅≅1,100, as shown below in connection with FIG. 3D. In particular, the improved projection weights 3056, 3058, 3062, 3064, 3068 align and/or match the example projected population data 3106, 3112, 3116 of the geographic region to the respective observed population data 3060, 3066, 3070 of the geographic region.

FIG. 3D illustrates an example seventh table 3130 (e.g., generated by the example projection system 100) associated with generating the example projection weights 3056, 3058, 3062, 3064, 3068 in the fifth example table 3054 of FIG. 3B. In particular, the seventh table 3130 of FIG. 3D illustrates a second iteration of the disclosed example calibration method and/or technique with respect to projected potential spending at the first target retailer (retailer “A”) (and/or projected potential sales of the first target retailer) and observed sales of the first target retailer.

In some examples, the projection system 100 determines at least one of the example projection weights 3056, 3058, 3062, 3064, 3068 is uncalibrated and/or unbalanced with respect to the example values 3080, 3082, 3084, 3086, 3088 of projected potential spending at the first target retailers retailer “A”) (and/or projected potential sales of the first target retailer) and observed sales of the first target retailer In such examples, in response to the determination, the example calibration engine 108 re-calculates and/or changes one or more of the projection weights 3056, 3058, 3062, 3064, 3068 based on the attribute(s) of interest at least partially responsible for the panel imbalance (e.g., the fourth attribute of interest 3018) and/or a ratio or multiplier between the first projected ACV 3090 and the first observed ACV 3072 of the first target retailer. For example, as shown in FIG. 3D, the calibration engine 108 changes the first projection weight 3056 and the third projection weight 3062 based on a fourth multiplier 3132 (e.g., 1.28) (e.g., calculated by the calibration engine 108) between the first projected ACV 3090 and the first observed ACV 3072, for example, where the

$$fourth multiplier ≅ \frac{\$50 , 000 per year}{\$39 , 000 per year} .$$

In the example of FIG. 3D, the calibration engine 110 determines only the first household of interest 3002 and the third household of interest 3006 are exposed to the first retailer (retailer “A”) and, in response, changes only the first projection weight 3056 and the third projection weight 3062 based on the fourth multiplier 3132. As previously disclosed, the projection system 100 determines an example household of interest is exposed to an example retailer when a value of potential spending (e.g., calculated by the projection system 100) associated therewith is greater than about 0 $ per year. In this manner, instead of adjusting all the projection weights 3056, 3058, 3062, 3064, 3068 in connection with the fourth attribute of interest 3018, the projection system 100 only adjusts household projection weights that show panel imbalance, which improves computational efficiency of the projection system 100 that would have otherwise been reduced by additional calculations for households of interest not exposed to the first target retailer (retailer “A”).

Further, in the example of FIG. 3D, the calibration engine 108 also changes the second projection weight 3058, the fourth projection weight 3064 and the fifth projection weight 3068 such that all of the projection weights 3056, 3058, 3062, 3064, 3068 together substantially align to and/or match the example total observed population 3071 (e.g., 5,000 households), which ensures the projections are accurate. In some examples, after changing the first projection weight 3056 and the third projection weight 3062 based on the fourth multiplier 3132, the calibration engine 108 changes the second projection weight 3058, the fourth projection weight 3064, and the fifth projection weight 3068 based on a fifth multiplier (e.g., 0.82) (e.g., calculated by the calibration engine 108) provided by the total observed population 3071 as well as the example projection weights 3056, 3058, 3062, 3064, 3068, for example, where the

$$fifth multiplier ≅ \frac{5 , 000 households - {XF}_{1} - {XF}_{3}}{{XF}_{2} + {XF}_{4} + {XF}_{5}} .$$

In this manner, the projection system 100 performs the second iteration of calibration by calculating improved projection weights 3056, 3058, 3062, 3064, 3068 for the example panel, for example, where XF₁≅1,282.1, XF₂≅819.7, XF₃≅1,217.9, XF₄≅778.7, and XF₅≅901.6, as shown below in connection with FIG. 3E. In particular, the improved projection weights 3056, 3058, 3062, 3064, 3068 substantially align and/or match the example projected potential spending 3080, 3082, 3084, 3086, 3088 of the households of interest 3002, 3004, 3006, 3008, 3010 at the first target retailer (retailer “A”) (and/or the projected sales 3090 of the first target retailer) to the respective first observed ACV 3072 of the first target retailer.

FIG. 3E illustrates an example eighth table 3134 (e.g., generated by the example projection system 100) associated with generating the example projection weights 3056, 3058, 3062, 3064, 3068 in the fifth example table 3054 of FIG. 3B. In particular, the eighth table 3134 of FIG. 3E illustrates a third iteration of the disclosed example calibration method and/or technique with respect to projected potential spending at the second target retailer (retailer “B”) (and/or projected potential sales of the second target retailer) and observed sales of the second target retailer.

In some examples, the projection system 100 determines the example projection weights 3056, 3058, 3062, 3064, 3068 are uncalibrated and/or unbalanced with respect to example values of projected potential spending 3140, 3142, 3144, 3146, 3148 of the households of interest 3002, 3004, 3006, 3008, 3010 at the second target retailer (retailer “B”) (and/or projected potential sales of the second target retailer) and observed sales of the second target retailer. In such examples, in response to the determination, the example calibration engine 108 re-calculates and/or changes one or more of the projection weights 3056, 3058, 3062, 3064, 3068 based on the attribute(s) of interest at least partially responsible for the panel imbalance (e.g., the fifth attribute of interest 3020) and/or a ratio or multiplier between the second projected potential ACV 3092 and the second observed ACV 3074 of the second target retailer. For example, as shown in FIG. 3E, the calibration engine 108 changes all of the projection weights 3056, 3058, 3062, 3064, 3068 based on a sixth multiplier 3136 (e.g., 1.00) (e.g., calculated by the calibration engine 108) between the second projected ACV 3092 and the second observed ACV 3074, for example, where the

$$sixth multiplier ≅ \frac{\$62 , 500 per year}{\$62 , 500 per year} .$$

In this example, the calibration engine 110 determines all of the households of interest 3002, 3004, 3006, 3008, 3010 are exposed to the second retailer (retailer “B”) and, in response, changes each of the projection weights 3056, 3058, 3062, 3064, 3068 based on the sixth multiplier 3136.

In this manner, the projection system 100 performs the third iteration of calibration by calculating improved projection weights 3056, 3058, 3062, 3064, 3068 for the example panel, for example, where XF₁≅1,282.1, XF₂≅819.7, XF₃≅1,217.9, XF₄≅778.7, and XF₅≅901.6, as shown below in connection with FIG. 3F. In particular, the improved projection weights 3056, 3058, 3062, 3064, 3068 substantially align and/or match the values of projected potential spending 3140, 3142, 3144, 3146, 3148 of the households of interest 3002, 3004, 3006, 3008, 3010 at the second target retailer (retailer “B”) (and/or the projected sales 3092 of the second target retailer) to the respective second observed ACV 3074 of the second target retailer.

FIG. 3F illustrates an example ninth table 3150 (e.g., generated by the example projection system 100) associated with generating the example projection weights 3056, 3058, 3062, 3064, 3068 in the fifth example table 3054 of FIG. 3B. In particular, the ninth table 3150 of FIG. 3F illustrates a fourth iteration of the disclosed example calibration method and/or technique with respect to projected potential spending at the third target retailer (retailer “C”) (and/or projected potential sales of the third target retailer) and observed sales of the third target retailer.

In some examples, the projection system 100 determines the example projection weights 3056, 3058, 3062, 3064, 3068 are uncalibrated and/or unbalanced with respect to example values of projected potential spending 3152, 3154, 3156, 3158, 3160 of the households of interest 3002, 3004, 3006, 3008, 3010 at the third target retailer (retailer “C”) (and/or projected potential sales of the third target retailer) and observed sales of the third target retailer In such examples, in response to the determination, the example calibration engine 108 re-calculates and/or changes one or more of the projection weights 3056, 3058, 3062, 3064, 3068 based on the attribute(s) of interest at least partially responsible for the panel imbalance (e.g., the sixth attribute of interest 3022) and/or a ratio or multiplier between the third projected potential ACV 3094 and the third observed ACV 3076 of the third target retailer. For example, as shown in FIG. 3F, the calibration engine 108 changes only the second projection weight 3058 and the fourth projection weight 3064 based on a seventh multiplier 3162 (e.g., 1.00) (e.g., calculated by the calibration engine 108) between the third projected potential ACV 3094 and the third observed ACV 3076, for example, where the

$$seventh multiplier ≅ \frac{\$50 , 000 per year}{\$50 , 000 per year} .$$

In this example, instead of changing all the projection weights 3056, 3058, 3062, 3064, 3068, the calibration engine 110 determines only the second household of interest 3004 and the fourth household of interest 3008 are exposed to the third retailer (retailer “C”) and, in response, changes only the second projection weight 3058 and the fourth projection weight 3064 based on the seventh multiplier 3162, which improves computational efficiency of the projection system 100 during the fourth example iteration of calibration.

Further, in the example of FIG. 3F, similar to the example of FIG. 3D, the calibration engine 108 also changes the first projection weight 3056, the third projection weight 3062, and the fifth projection weight 3068 such that all of the projection weights 3056, 3058, 3062, 3064, 3068 together substantially align to and/or match the example total observed population 3071 (e.g., 5,000 households), which ensures the projections are accurate. In the example of FIG. 3F, after changing the second projection weight 3058 and the fourth projection weight 3064 based on the seventh multiplier 3162, the calibration engine 108 also changes the first projection weight 3056, the third projection weight 3062, and the fifth projection weight 3068 based on an eighth multiplier (e.g., 1.00) (e.g., calculated by the calibration engine 108) provided by the total observed population 3071 as well as the example projection weights 3056, 3058, 3062, 3064, 3068, for example, where the

$$eighth multiplier ≅ \frac{5 , 000 households - {XF}_{2} - {XF}_{4}}{{XF}_{1} + {XF}_{3} + {XF}_{5}} .$$

In this manner, the projection system 100 performs the fourth iteration of calibration by calculating improved projection weights 3056, 3058, 3062, 3064, 3068 for the example panel, for example, where XF₁≅1,282.1, XF₂≅819.7, XF₃≅1,217.9, XF₄≅778.7, and XF₅≅901.6. In particular, the improved projection weights 3056, 3058, 3062, 3064, 3068 substantially align and/or match the values of projected potential spending 3152, 3154, 3156, 3158, 3160 of the households of interest 3002, 3004, 3006, 3008, 3010 at the third target retailer (retailer “C”) (and/or the projected sales 3094 of the third target retailer) to the respective third observed ACV 3076 of the third target retailer.

In some examples, the projection system 100 repeatedly performs the first iteration of calibration in connection with FIG. 3C, the second iteration of calibration in connection with FIG. 3D, the third iteration of calibration in connection with FIG. 3E, and/or the fourth iteration of calibration in connection with FIG. 3F until, for example, a particular number (e.g., about 50) of iterations have been performed, the third example threshold is satisfied, the fourth example threshold is satisfied, and/or convergence of the projection weights 3056, 3058, 3062, 3064, 3068 is achieved. As a result, the projection system 100 calculates the projection weights 3056, 3058, 3062, 3064, 3068 for the panel to balance and/or align both: (1) projected potential spending 3080, 3082, 3084, 3086, 3088, 3092, 3140, 3142, 3144, 3146, 3148, 3092, 3152, 3154, 3156, 3158, 3160, 3094 of the households of interest 3002, 3004, 3006, 3008, 3010 relative to the observed sales 3072, 3074, 3076 of the target retailers (retailers “A,” “B,” and “C”); and (2) projected population data 3102, 3104, 3106 3108, 3110, 3112, 3114, 3116 relative to the associated observed population data 3060, 3066, 3070, 3071 of the geographic region. As a result, the example panel is balanced and/or errors in the projection weights 3056, 3058, 3062, 3064, 3068 (e.g., caused by a shopping bias and/or a store bias) are reduced and/or eliminated that would have otherwise adversely affected the panel.

While an example manner of implementing the example projection system 100 is illustrated in FIG. 1, one or more of the elements, processes and/or devices illustrated in FIG. 1 may be combined, divided, re-arranged, omitted, eliminated and/or implemented in any other way. Further, the example data analyzer 102, the example distance calculator 104, the example modeling engine 106, the example calibration engine 108, the example projection engine 110, the example user interface 112, the example memory 114, the example network(s) 116, the example core panelist data source(s) 118, the example auxiliary panelist data source(s) 120, the other data source(s) 122 and/or, more generally, the example projection system 100 of FIG. 1 may be implemented by hardware, software, firmware and/or any combination of hardware, software and/or firmware. Thus, for example, any of the example data analyzer 102, the example distance calculator 104, the example modeling engine 106, the example calibration engine 108, the example projection engine 110, the example user interface 112, the example memory 114, the example network(s) 116, the example core panelist data source(s) 118, the example auxiliary panelist data source(s) 120, the other data source(s) 122 and/or, more generally, the example projection system 100 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data analyzer 102, the example distance calculator 104, the example modeling engine 106, the example calibration engine 108, the example projection engine 110, the example user interface 112, the example memory 114, the example network(s) 116, the example core panelist data source(s) 118, the example auxiliary panelist data source(s) 120, the other data source(s) 122 and/or, more generally, the example projection system 100 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware. Further still, the example data analyzer 102, the example distance calculator 104, the example modeling engine 106, the example calibration engine 108, the example projection engine 110, the example user interface 112, the example memory 114, the example network(s) 116, the example core panelist data source(s) 118, the example auxiliary panelist data source(s) 120, the other data source(s) 122 and/or, more generally, the example projection system 100 of FIG. 1 may include one or more elements, processes and/or devices in addition to, or instead of, those illustrated in FIG. 1, and/or may include more than one of any or all of the illustrated elements, processes and devices.

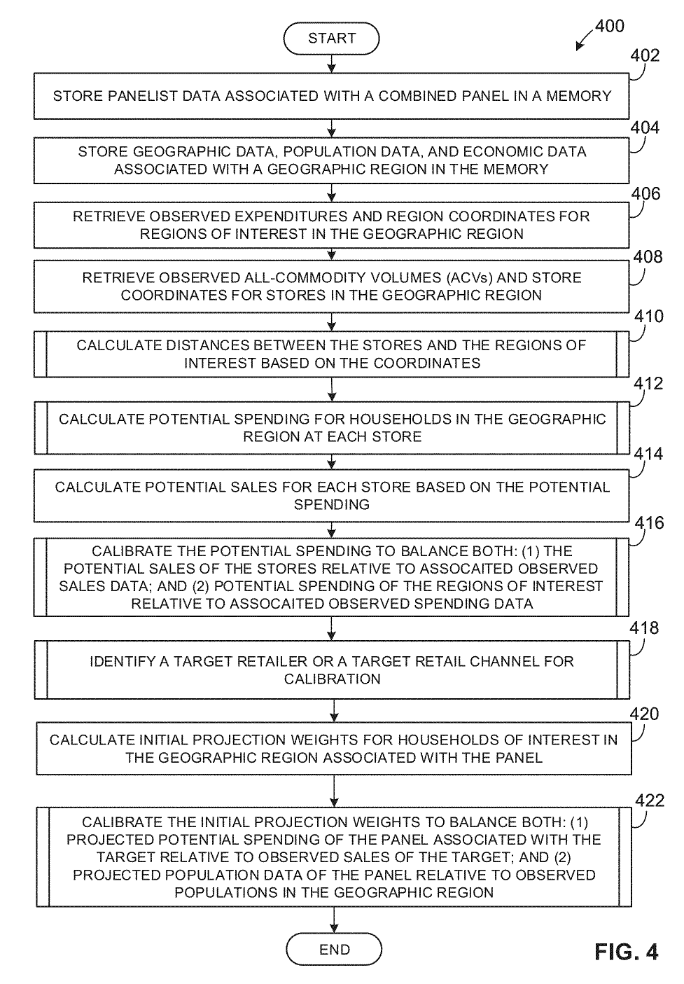

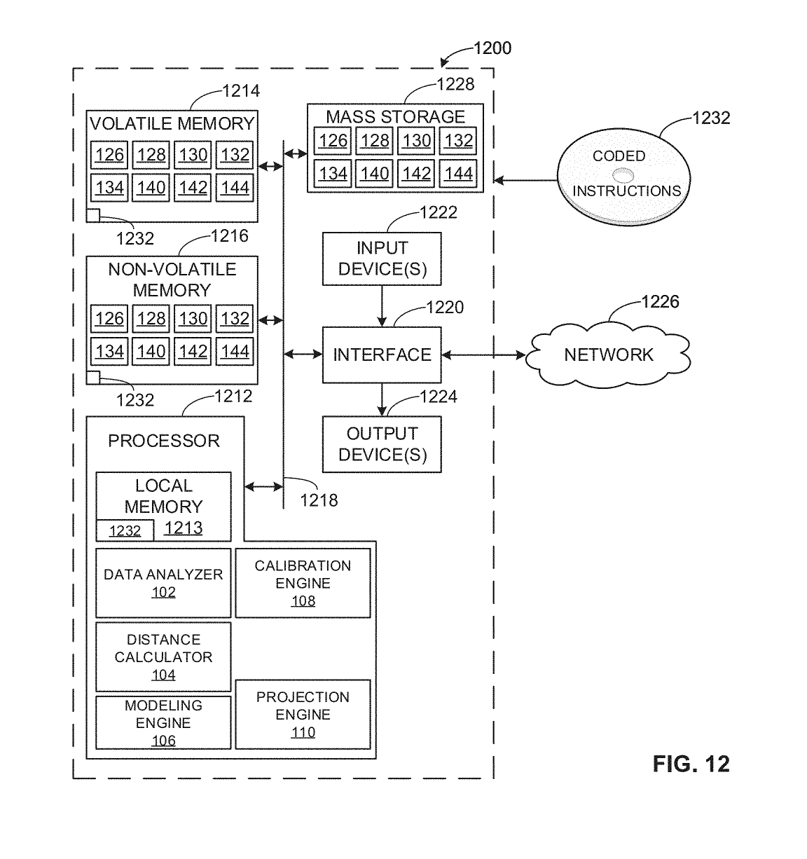

Flowcharts representative of example machine readable instructions for implementing the example projection system 100 of FIG. 1 are shown in FIGS. 4-11. In these examples, the machine readable instructions comprise a program for execution by a processor such as the processor 1212 shown in the example processor platform 1200 discussed below in connection with FIG. 12. The programs may be embodied in software stored on a non-transitory computer readable storage medium such as a CD-ROM, a floppy disk, a hard drive, a digital versatile disk (DVD), a Blu-ray disk, or a memory associated with the processor 1212, but the entire programs and/or parts thereof could alternatively be executed by one or more devices other than the processor 1212 and/or embodied in firmware or dedicated hardware. Further, although the example programs are described with reference to the flowcharts illustrated in FIGS. 4-11, many other methods of implementing the example projection system 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS. 4-11 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

FIG. 4 is a flow diagram representative of an example method 400 that may be performed by the example projection system 100 of FIG. 1 to implement the examples disclosed herein. The example method 400 may be implemented to generate projection factors or weights associated with an example panel (e.g., a combined panel), in which the projection weights facilitate reduced projection errors caused by data bias (e.g., when core panelist data is combined with auxiliary data such as store loyalty and/or shopper data), thereby resulting in improved marketing to consumers in a geographic region.

The example method 400 begins by storing panelist data associated with a combined panel (e.g., HomeScan Premium) in a memory (block 402). In some examples, the projection system 100 of FIG. 1 stores the example core panelist data 132 and/or the example auxiliary panelist data 134 in the example memory 114. For example, as disclosed above, the example projection system 100 stores shopping and/or purchase behavior data in the memory 114, which may indicate characteristics of core panelists and/or auxiliary panelists, such as a rate or frequency of currency spent (e.g., per year, per month, etc.), particular stores at which the currency was spent, particular items purchased, etc. In some examples, the projection system 100 stores demographic data in the memory 114, which indicates one or more demographic representations (e.g., an age, a gender, an occupational type, a household size, a household income, a location of residence, etc.) of the core panelists and/or the auxiliary panelists and/or regions of interest in which they live.

In some examples, the projection system 100 obtains the core panelist data 132 from the core panelist data source(s) 118 (e.g., one or more of the above disclosed monitoring devices) via the network(s) 116. For example, the monitoring devices monitor shopping activity of the panelists and provide associated data to the example projection system 100 for storage in the memory 114. Additionally, the panelists can input corresponding demographic data to the monitoring devices (e.g., when registering with the monitoring devices and/or an associated data measurement company).

In some examples, the projection system 100 obtains the auxiliary panelist data 134 from the auxiliary panelist data source(s) 120 via the network(s) 116. For example, one or more stores in the geographic region having a loyalty program (also sometimes referred to as a frequent shopper program and/or a reward program) can monitor shopping activity of customers (e.g., one or more of the auxiliary panelists) participating in the loyalty program and provide corresponding auxiliary panelist data 134 to the example projection system 100. In such examples, the customers may provide demographic data and/or identifying information (e.g., a name, an address, a phone number, etc.) to the loyalty program (e.g., when registering with the loyalty program). In other examples, as disclosed above, the example projection system 100 can obtain the demographic data of the auxiliary panelists via one or more third-party data services (e.g., Spectra®), for example, if the customers do not provide at least some of their demographic data when registering with the store loyalty program.

After storing at least the core panelist data 132 and/or the auxiliary panelist 134 data in the memory 114 (block 402), control of the example method 400 proceeds to storing geographic data, population data, and economic data associated with a geographic region in the memory (block 404). In some examples, the projection system 100 of FIG. 1 stores the example geographic data 126, the example population data 128, and the example economic data 130 in the example memory 114. For example, the other data source(s) 122 provide the geographic data 126, the population data 128, and/or the economic data 130 to the example projection system 100 (e.g., via the network(s) 116).

In some examples, the projection system 100 stores coordinates (e.g., Euclidian and/or spatial coordinates such as one or more x-coordinates, y-coordinates, and/or z-coordinates) associated with one or more regions of interest (e.g., one or more zip codes) and/or stores in the geographic region, which may represent global or relative positions and/or geometries.

In some examples, the projection system 100 stores observed population data (e.g., observed population estimates) associated with the regions of interest in the memory 114, such as a number of consumers and/or households (e.g., a total number of consumers and/or households) located in a particular region of interest, a number of consumers in each household, a number of consumers and/or households sharing the same demographic representation, etc. The population data 128 may also indicate a population density, a population center, and/or a population distribution of a region of interest, which can be used by the example projection system 100 to identify a center of mass coordinate for the region of interest.

In some examples, the projection system 100 stores expenditures (i.e., observed expenditures) of the regions of interest such as, for example, average and/or total money spent (e.g., annually) by households located in a region of interest. In some examples, the projection system 100 stores data associated with sales of stores and/or retailers in the geographic region. For example, the projection system 100 stores ACVs (i.e., observed ACVs) of the stores and/or the retailers in the memory 114.

After storing at least the geographic data 126, the population data 128, and/or the economic data 130 in the memory 114 (block 404), control of the example method 400 proceeds to retrieving an observed expenditure and one or more coordinates for regions of interest in the geographic region (block 406). In some examples, the data analyzer 102 of FIG. 1 analyzes the geographic data 126, population data 128, and/or the economic data 130 stored in the memory 114 to retrieve a first observed expenditure (e.g., $2,500,000 per year) and first region coordinates (e.g., one or more of an x-coordinate, a y-coordinate, and/or a z-coordinate) for a first region of interest (e.g., a first zip code) in the geographic region. Additionally or alternatively, in some examples, the data analyzer 102 retrieves one or more other coordinates for the first region of interest, which may indicate a geometry or shape (e.g., a regular or irregular polygon) of the first region of interest.

Further, in some examples, the data analyzer 102 analyzes the geographic data 126, the population data 128, and/or the economic data 130 to retrieve one or more other observed expenditures and region coordinates for other regions of interest. For example, the data analyzer 102 retrieves: a second observed expenditure (e.g., $1,500,000 per year) and second region coordinates (e.g., a global or relative position and/or a geometry) for a second region of interest (e.g., a second zip code) in the geographic region; a third observed expenditure (e.g., $3,000,000 per year) and third region coordinates (e.g., a global or relative position and/or a geometry) for a third region of interest (e.g., a third zip code) in the geographic region; etc. Thus, in some examples, the data analyzer 102 can retrieve an observed expenditure and region coordinates for all regions of interest in the geographic region.

After retrieving at least the first observed expenditure and the first coordinate(s) of the first region of interest (block 406), the example projection system 100 stores the observed expenditure(s), the coordinate(s), and/or other data associated with the region(s) of interest in the memory 114, and control of the example method 400 proceeds to retrieving an observed ACV and a store coordinate for stores in the geographic region (block 408). In some examples, the data analyzer 102 of FIG. 1 analyzes the geographic data 126 and/or the economic data 130 stored in the memory 114 to retrieve a first observed ACV (e.g., $1,400,000 per year) and first store coordinates (e.g., one or more of an x-coordinate, a y-coordinate, and/or a z-coordinate) for a first example store (e.g., a grocery store) in the geographic region, which indicates a global or relative position of the first store.

Further, in some examples, the data analyzer 102 analyzes the geographic data 126 and/or the economic data 130 to retrieve one or more other observed ACVs and/or store coordinates for other stores. For example, the data analyzer 102 retrieves: a second observed ACV (e.g., $2,300,000 per year) and second store coordinates (e.g., a global or relative position) for a second example store in the geographic region; a third observed ACV (e.g., $3,000,000 per year) and third store coordinates (e.g., a global or relative position) for a third example store in the geographic region; etc. Thus, in some examples, the data analyzer 102 can retrieve an observed ACV and store coordinates for all stores in the geographic region.

After retrieving at least the first observed ACV and the first store coordinates of the first example store (block 408), the example projection system 100 stores the observed ACV(s), the store coordinate(s), and/or other data associated with the store(s) in the memory 114 and control of the example method 400 proceeds to calculating distances between the store(s) and the region(s) of interest (block 410). In some examples, the distance calculator 104 of FIG. 1 calculates the distance(s) based on the global or relative positions of the region(s) of interest and the store(s), for example, in accordance with one or more of the retrieved region coordinates of the regions of interest and the store coordinates of the stores. For example, the distance calculator 104 calculates a first distance (e.g., a linear distance) between the first region coordinates and the first store coordinates.

In some examples, the distance calculator 104 calculates one or more other distances between the first store and other regions of interest (e.g., all regions of interest) in the geographic region. For example, the distance calculator 104 calculates a second distance between the first store and the second region of interest, a third distance between the first store and a third region of interest, etc. Further, in some examples, the distance calculator 104 may calculate other distances between other stores and other regions of interest. For example, the distance calculator 104 calculates a fourth distance between the second store and the first region of interest, a fifth distance between the second store and the second region of interest, etc. Thus, in some examples, the distance calculator 104 calculates a distance between each store and each region of interest (e.g., every combination and/or permutation of stores and regions of interest) in the geographic region.

In some examples, the distance calculator 104 calculates the distance(s) based on geographic and/or population characteristics such as, for example, a geometry or shape (e.g., a regular or irregular polygon), a population distribution, a population center, and/or a population density of the first region of interest. For example, the distance calculator 104 identifies a first center of mass coordinate based on a population center of the first region of interest and calculates the first distance based on this first center of mass coordinate and the first store coordinate, which is disclosed in greater detail below in connection with FIG. 5.

After calculating at least the first distance between the first store and the first region of interest (block 410), the example projection system 100 stores the calculated distance(s) in the memory 114 and control of the example method 400 proceeds to calculating potential spending for households (e.g., households of interest) in the geographic region associated with each store (block 412). In some examples, the modeling engine 106 of FIG. 1 calculates a value of money or currency that one or more (e.g., all) households in the geographic region is/are to spend (e.g., per year) at the example stores (e.g., the first store, the second store, etc.). Each value may depend on observed data such as, for example, an observed expenditure (e.g., retrieved via the data analyzer 102) of a region of interest and/or a household therein, a size (e.g., retrieved and/or calculated via the data analyzer 102) of an example store, a distance (e.g., calculated via the distance calculator 104) required to travel to an example store, etc. For example, households further away from an example store tend to spend substantially less money thereat.

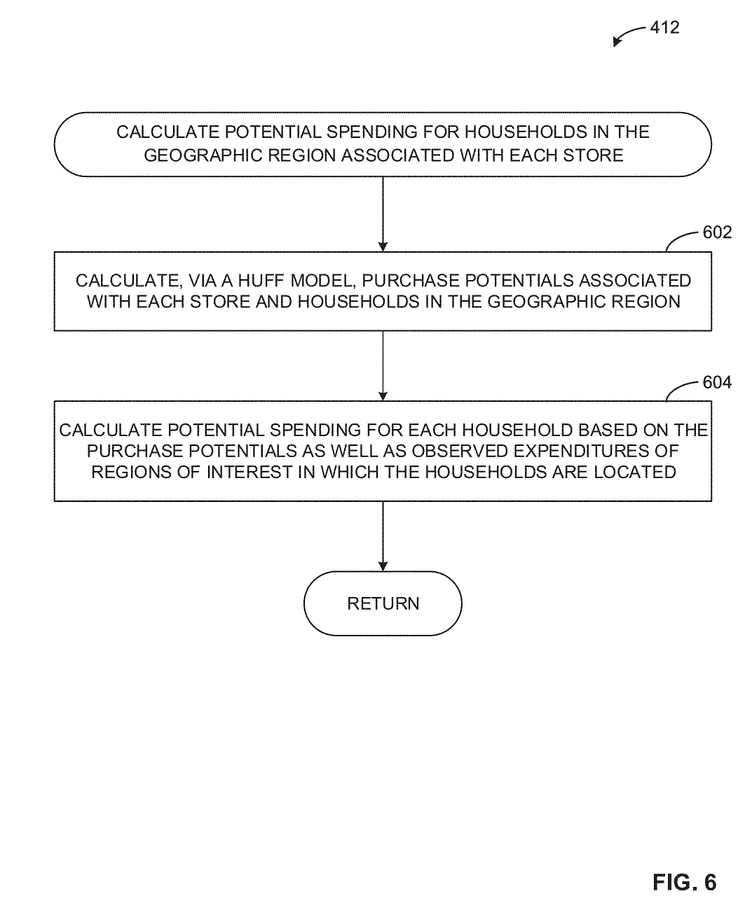

Accordingly, the example projection system 100 uses one or more equations, models and/or algorithms related to calculate spending at each store in the geographic region based on the observed data. In some examples, the modeling engine 106 calculates, via a Huff model, money spent at the example stores by the households in the geographic region in a manner consistent with Equations (1) and/or (2), which is disclosed in greater detail below in connection with FIG. 6. In such examples, the modeling engine 106 calculates, via the Huff model, purchase potentials (e.g., probability and/or proportional values) associated with the example stores, where each purchase potential indicates a likeliness of a corresponding household to spend money at each of the example stores and/or how much the household is likely to spend (e.g., in terms of a percentage or a share of an observed expenditure) at each store.

After calculating the potential money spent at the example stores by the households in the geographic region (block 412), control of the example method 400 proceeds to calculating potential sales for each store based on the potential spending (block 414). In some examples, the modeling engine 106 of FIG. 1 calculates values of sales (e.g., per year) for the example stores based on the calculated spending (e.g., an aggregate of the potential spending) of the households associated with each store. For example, the modeling engine 106 calculates a first potential ACV (i.e., a first rebuilt ACV) (e.g., 270 in the first example table 200 of FIG. 2A) for the first example store in a manner consistent with Equations (1) and/or (2). Similarly, in some examples, the projection system 100 likewise calculates one or more other potential ACVs (e.g., 280, 282, 284, 286 in the first example table 200 of FIG. 2A) for one or more of the other example stores (e.g., the second example store, the third example store, etc.) in the geographic region in a manner consistent with Equations (1) and/or (2). For example, the projection system 100 generates the first example table 202 of FIG. 2A.

After calculating potential sales for the example stores (block 414), control of the example method 400 proceeds to calibrating the potential spending to balance and/or align both: (1) the potential sales of the stores relative to associated observed sales data; and (2) potential spending of the regions of interest relative to associated observed spending data (block 416). As previously disclosed, to better enable the projection system 100 to generate accurate and/or useful projection weights (e.g., calculated in a manner consistent with Equation (4)) for households of interest based on their potential spending at an example target retailer, a potential ACV (i.e., a rebuilt ACV) (e.g., calculated via the modeling engine 106) of each store needs to substantially align to and/or match a respective one of the observed ACVs (e.g., retrieved via the data analyzer 102). Additionally, a potential expenditure (e.g., calculated via the modeling engine 106) of each region of interest needs to substantially align to and/or match a respective one of the observed expenditures (e.g., retrieved via the data analyzer 102), which may be provided by Equations (1), (2) and/or (3).

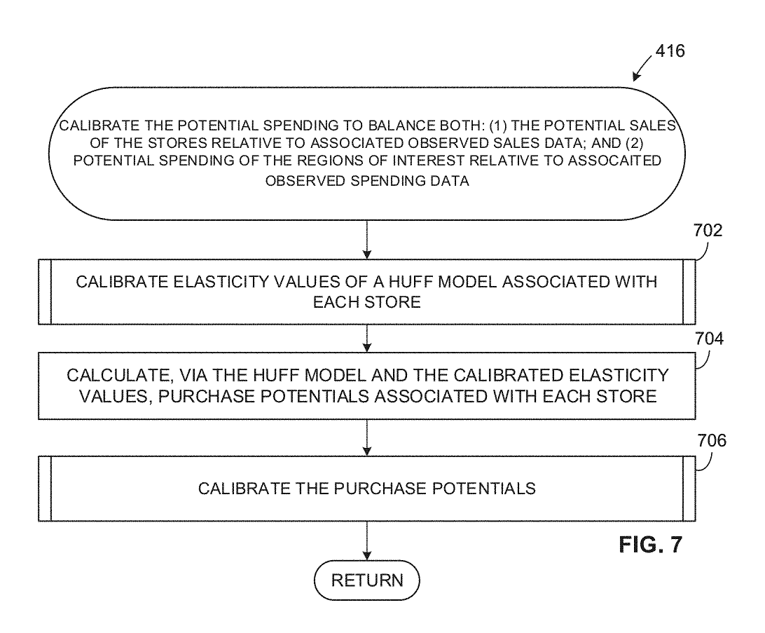

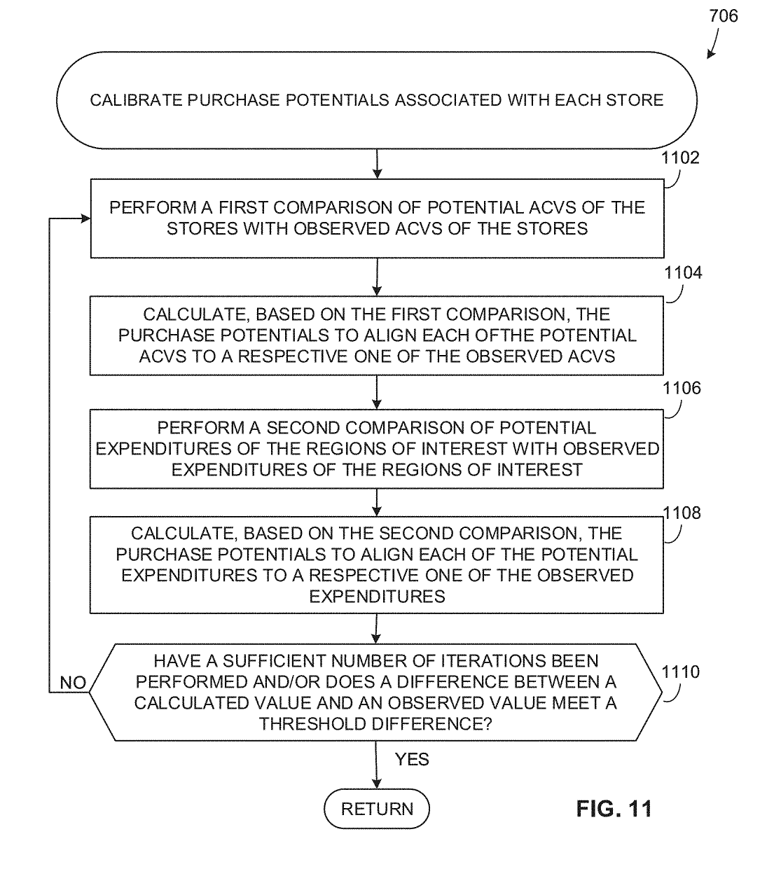

In some examples, as previously disclosed, Equations (1), (2), and/or (3) may not provide potential ACVs that substantially align to and/or match respective observed ACVs. As such, prior to generating the projection weights, the projection system 100 re-calculates, changes, adjusts, and/or otherwise calibrates the potential spending of the households associated with the example stores in the geographic region. In some examples, the calibration engine 108 calibrates and/or selects one or more elasticity values of Equation (1) that may be specific to each example store to enable the modeling engine 106 to calculate improved purchase potentials As a result, the calibrated and/or selected elasticity value(s) enable the modeling engine 106 to calculate improved potential spending at the example stores as well as improved potential sales of the stores, which is disclosed in greater detail below in connection with FIGS. 7 and 10. Additionally or alternatively, in some examples, the calibration engine 108 calibrates the purchase potentials (e.g., probability values and/or proportional values) to further enable the modeling engine 106 to calculate improved potential spending at the example stores as well as an improved potential spending of the store, which is disclosed in greater detail below in connection with FIGS. 7 and 11.

After calibrating the potential spending (block 416), control of the example method 400 proceeds to identifying a target retailer or a target retail channel for calibration (block 418). In some examples, the data analyzer 102 of FIG. 1 accesses and/or analyzes the data in the memory 114 to determine the first store, the second store, and/or the third store correspond to a first target retailer (e.g., a first company) and/or a first target retail channel (e.g., a supermarket retail channel, a convenience store retail channel, a gas station/kiosk retail channel, etc.), as disclosed in greater detail below in connection with FIG. 8. In particular, the projection system 100 identifies a target (e.g., a target retailer and/or a target retail channel) such that the example target has sufficient data (e.g., observed sales data, projected potential sales data, and/or other data) associated therewith to enable the example projection system 100 to mitigate and/or eliminate panel imbalance and/or associated errors in the projection weights caused by the store(s) representing each target.

After identifying at least the first example target for calibration (block 418), control of the example method 400 proceeds to calculating initial projection weights for households of interest in the geographic region associated with the panel (block 420). In some examples, the projection engine 110 of FIG. 1 calculates first (e.g., initial) example projection weights (e.g., the example projection weights 3056, 3058, 3062, 3064, 3068 in the sixth table 3078 of FIG. 3C) for first example households of interest (e.g., the example households of interest 3002, 3004, 3006, 3008, 3010 in connection with the fourth table 3000 of FIG. 3A) associated with the example panel and the first target retailer. For example, the projection system 100 calculates the first projection weights based on a ratio of a number (e.g., a total) of the first households of interest associated with the panel and a number (e.g., a total) of households in the geographic region. In such examples, when the example panel includes 100,000 households of interest and the example geographic region includes 100,000,000 households, the projection engine 110 calculates an average projection weight (e.g., 1,000) for each household of interest, for example, where the

$$average projection weight ≅ \frac{100 , 000 , 000 housholds}{100 , 000 households of interest} .$$

Accordingly, each household of interest of the panel represents a projected quantity of households in the geographic region based on a respective one of the projection weights. For example, each of the first households of interest represents 1,000 households in the geographic region. However, these projected quantities of households may be inaccurate relative to observed quantities of households in the geographic region without calibration. As previously disclosed, to reduce and/or eliminate panel imbalance and/or errors in the projection weights (e.g., caused by a demographic bias, a store bias, and/or a shopping bias associated with the target retailer(s)), the projection system 100 calibrates and/or balances the first projection weights, for example, via an iterative proportional fitting (IPF) method and/or technique in a manner consistent with Equation (4), as disclosed further below.

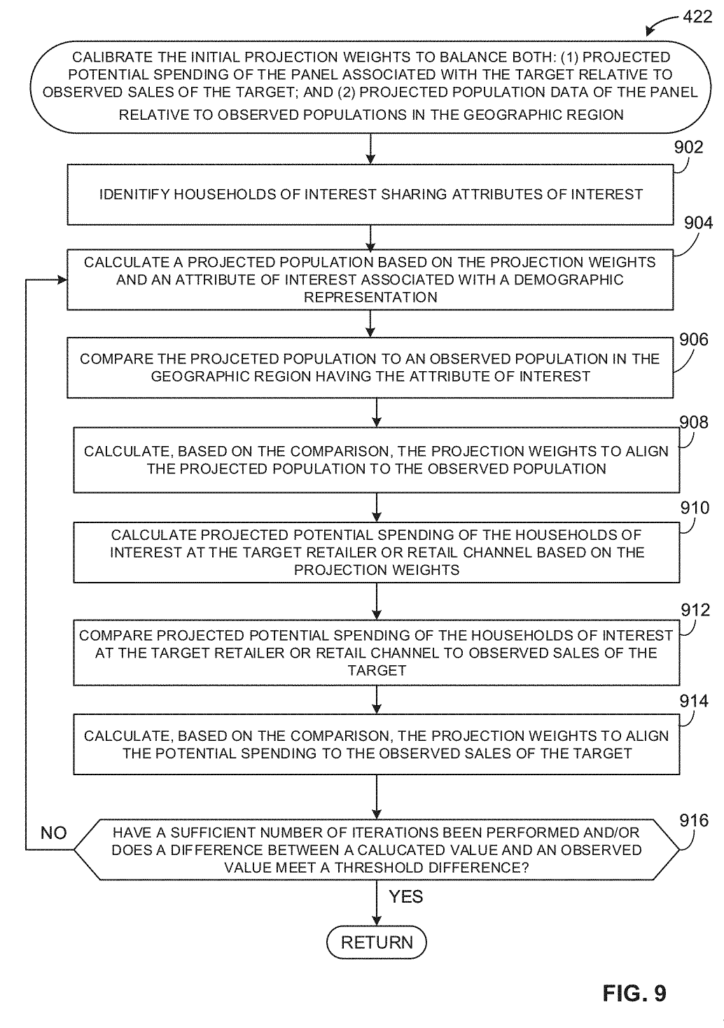

After calculating the first and/or initial projection weights for the example households of interest (block 420), control of the example method 400 proceeds to calibrating the initial projection weights to balance both: (1) the projected potential spending of the panel associated with the target relative to observed sales of the target; and (2) projected population data of the panel relative to observed populations in the geographic region (block 422). In some examples, the projection engine 110 and/or the calibration engine 108 of FIG. 1 calibrate the first projection weights for the example panel in a manner consistent with Equation (4) (e.g., see the example balanced and/or calibrated projection weights 3056, 3058, 3062, 3064, 3068 in the fifth table 3054 of FIG. 3B), thereby providing second (e.g., final) projection weights for the panel, which is disclosed in greater detail below in connection with FIG. 9. As a result, the second and/or final projection weights enable the projection engine 110 to calculate accurate and/or useful projection data. For example, based on the second projection weights, the projection engine 110 calculates one or more projected populations in the geographic region that represent observed populations in the geographic region with a greater accuracy. Accordingly, such projection data enables clients of a data measurement company to efficiently and/or effectively market to groups of consumers in the geographic region corresponding to the projected populations by leveraging the core panelist data 132 and/or the auxiliary panelist data 134 (e.g., by leveraging purchase behaviors and/or shopping behaviors of the core panelists and/or the auxiliary panelists).

In some such examples, prior to calibrating the first projection weights, the example projection engine 110 of FIG. 1 calculates projected potential spending of the first households of interest of the example panel at the first example target retailer based on the first projection weights (e.g., see the example values 3080, 3082, 3084, 3086, 3088, 3090 of projected potential spending by the example households of interest 3002, 3004, 3006, 3008, 3010 at retailer “A” of FIG. 3C). Similarly, the example projection engine 110 calculates one or more projected populations associated with the geographic region based on the first projection weights (e.g., see the example values 3102, 3104 in the sixth table 3078 of FIG. 3C representing the first example projected population 3106). This projection data (e.g., unbalanced and/or uncalibrated projection data) of the panel facilitates calibration of the first projection weights by the projection system 100. In particular, in addition to aligning projected population data of the panel relative to the observed population data of the geographic region, the projection system 100 similarly aligns projected spending data of the panel at the target retailer(s) and/or target retail channel(s) relative to respective observed sales data (e.g., observed store ACVs, retailer ACVs and/or retail channel ACVs), thereby reducing and/or eliminating any bias that may be associated with the panel as well as associated errors that may be associated with the first projection weights.

After calculating the second and/or final projection weights for the panel (block 422), the example projection system 100 may store the second and/or final projection weights in the memory 114 and the example method 400 ends.

FIG. 5 is a flow diagram representative of an example method 410 that may be performed by the example projection system 100 of FIG. 1 to calculate distances between the stores and the regions of interest. Example operations of blocks 502 and/or 504 may be used to implement block 410 of FIG. 4.

The example method 410 begins by identifying a center of mass coordinate for a region of interest (block). In some examples, the distance calculator 104 of FIG. 1 uses the geographic data 126 to identify a first center of mass coordinate for the first region of interest based on a geometry or shape of the first region of interest. For example, the distance calculator 104 calculates a first geometric center or centroid for the first region of interest based on the first coordinates of the first region of interest. The distance calculator 104 then identifies the first geometric center as the first center of mass coordinate of the first region of interest.

In some examples, the data analyzer 102 uses the population data 128 to identify the first center of mass coordinate for the first region of interest. For example, the distance calculator 104 calculates a population center of the first region of interest based on a population density and/or a population distribution of the first region of interest. In such examples, the distance calculator 104 identifies the population center as the first center of mass coordinate for the first region of interest. Further, in some examples, the distance calculator 104 identifies a center of mass coordinate for one or more other regions of interest. For example, the distance calculator 104 calculates a second center of mass coordinate for a second region of interest, a third center of mass coordinate for a third region of interest, etc. Thus, in some examples, the distance calculator 104 identifies a center of mass coordinate for each region of interest in a geographic region.

After identifying at least the first center of mass coordinate for the first region of interest (block 502), the projection system 100 stores the first center of mass coordinate in the memory 114 and control of the example method 310 proceeds to calculating a distance between a store and the region of interest based on the center of mass coordinate and a store coordinate of the store (block 504). In some examples, the distance calculator 104 of FIG. 1 calculates a first distance between the first region of interest and the first store based on the first center of mass coordinate of the first region of interest and the first store coordinate of the first store.

Further, in some examples, the distance calculator 104 calculates one or more other distances between the first region of interest and other stores. For example, the distance calculator 104 calculates a second distance between the first region of interest and a second store based on the first center of mass coordinate and the second store coordinate of the second store, etc. As such, in some examples, the distance calculator 104 calculates a distance between the first region of interest each store in the geographic region. Further, in some examples, the distance calculator 104 likewise calculates other distances between other regions of interest and other stores. As such, in some examples, the distance calculator 104 may calculate a distance between each store and each region of interest within the geographic region (e.g., the example method 410 of FIG. 5 may iterate any number of times for each store of interest).

After calculating at least the first distance between the first region of interest and the first store (block 504), the distance calculator 104 stores the calculated distance(s) in the memory 114 and control of the example method 410 returns to a calling function such as the example method 400 of FIG. 4.

FIG. 6 is a flow diagram representative of an example method 412 that may be performed by the example projection system 100 of FIG. 1 to calculate potential spending for households (e.g., households of interest) in the geographic region associated with each store. Example operations of blocks 602, and/or 604 may be used to implement block 412 of FIG. 4.

The example method 412 begins by calculating, via a Huff model, purchase potentials associated with each store and households (e.g., all households) in the geographic region (block 602). In some examples, the modeling engine 106 of FIG. 1 calculates first purchase potentials (e.g., in a manner consistent with Equations (1) and/or (2)) associated with the first example store and the regions of interest and/or households in each region, each of which indicate a probability and/or a likeliness of a household to shop and/or otherwise spend money at the first store as well as a portion of the household's yearly spending (and/or a portion of an expenditure of a region of interest in which the household is located) likely to be spent at the first store. These purchase potentials may depend on store attributes and/or characteristics, such as a size (e.g., retrieved and/or calculated via the data analyzer 102) of the first store, a relative distance (e.g., calculated via the distance calculator 104) to travel to the first store, etc. Further, the modeling engine 106 similarly calculates purchase potentials for the other example stores in a manner consistent with Equations (1) and (2) such as, for example, second purchase potentials associated with the second store, third purchase potentials associated with the third store, etc.

In some examples, to reduce a number of calculations, the projection system 100 calculates the purchase potentials for the regions of interest in which the households are located (e.g., instead of calculating a unique purchase potential for all households located in a region of interest). In such examples, a purchase potential corresponding to a region of interest may likewise correspond to each household in the region of interest. For example, the modeling engine 106 calculates a purchase potential corresponding to the first example store and the first region of interest, a different purchase potential corresponding to the first example store and the second region of interest, etc. in a manner consistent with Equations (1) and/or (2). In such examples, instead of calculating multiple purchase potentials associated with the households in the first region of interest and the first store, the projection systems 100 calculates only the first purchase potential and associates the first purchase potential with one or more of the households (e.g., all the households) in the first region of interest, thereby reducing computational resource consumption of the projection system 100 in calculating the potential spending. Further, in such examples, the modeling engine 106 calculates the potential spending for the household(s) in the first region of interest (and/or other households in other regions of interest) based on observed data (e.g., an observed expenditure) of the first region of interest instead of using observed data for each household (e.g., observed spending for each household and/or coordinates for each household representing a location in the geographic region), as disclosed further below in connection with the operation of block 604. As a result, the projection system 100 is enabled to generate the potential spending for the households by performing less calculations (e.g., by not performing unique distance calculations for each household) as well as using less data (e.g., by not using observed spending data unique to each household). Additionally, a relatively lower reliance upon such observed data results in a corresponding reduction in a cost of memory consumption and/or computational resources associated with calculating the potential spending.

After calculating the purchase potentials associated with the example stores (block 602), control of the example method 412 proceeds to calculating potential spending for each household based on the purchase potentials as well as observed expenditures of regions of interest in which the households are located (block 604). In some examples, the modeling engine 106 of FIG. 1 calculates values corresponding to money or currency spent (e.g., per year) at the first store by one or more (e.g., all) of the households in the geographic region (e.g., see the example values 270, 252, 272, 274, 276, 278 in the first table 200 of FIG. 2A associated with store “A”), which enables the projection engine 110 to calculate projection weights for households of interest of the panel in terms of their projected potential spending at a target retailer or target retail channel associated with the first store.

Further, in some examples, similar to the first store, the projection system 100 likewise calculates potential spending for the regions of interest and/or households therein associated with the other example stores in the geographic region (e.g., the second store, the third store, etc.), for example, to generate the first example table 200 of FIG. 2A (e.g., see the example values 270, 280, 282, 284, 286 of FIG. 2A associated with stores “A,” “B,” “C,” “D,” and “E”).

After calculating the potential spending (block 604), control of the example method 412 returns to a calling function such as the example method 400.

FIG. 7 is a flow diagram representative of an example method 416 that may be performed by the example projection system 100 of FIG. 1 to calibrate the potential spending to balance both: (1) potential sales of the stores relative to associated observed data; and (2) potential spending of the regions of interest relative to associated observed spending data, which facilitates the generation of improved (e.g., more accurate) projection weights for the panel. Example operations of blocks 702, 704, and/or 706 may be used to implement block 416 of FIG. 4.

The example method 416 begins by calibrating elasticity values of a Huff model associated with each store (block 702). As previously disclosed, the first elasticity value α and the second elasticity value β of Equation (1) each affect resulting purchase potentials based on store attributes (e.g., a store size and/or a distance to travel to the first target store) and, thus, each affect the calculated potential spending of the households, the calculated potential ACVs of the example stores, retailers and/or retail channels, and/or the calculated potential expenditures of the regions of interest. The first and second elasticity values (α, β) of Equation (1) may be specific or unique to each example store in the geographic region and may be pre-defined, selected, adjusted and/or otherwise calibrated to enable each potential ACV to substantially align to and/or match (e.g., within about 95%) a respective one of the observed ACVs.

In some examples, the calibration engine 108 of FIG. 1 calibrates the first elasticity value α and/or the second elasticity value β of Equation (1) for the example stores to provide a calibrated first elasticity value α′ (alpha prime) and a calibrated second elasticity value β′ (beta prime), which enables the modeling engine 106 to calculate the potential ACVs of the example stores that substantially align to and/or match respective ones of the observed ACVs of the example stores in a manner consistent with Equations (1), (2), and/or (3). In some such examples, the calibration engine 108 analyzes multiple first elasticity values α and/or second elasticity values β for the group of example stores and determines the first calibrated elasticity value α′ and/or the second calibrated elasticity value β′ based on the analysis, which is disclosed in greater detail below in connection with FIG. 10.

After calibrating the elasticity value(s) for the example stores (block 702), the projection system 100 stores the calibrated elasticity value(s) and/or associated calibrated elasticity data 142 in the memory 114 and control of the example method 416 proceeds to calculating, via the Huff model and the calibrated elasticity values, purchase potentials associated with each store (block 704). In some examples, the modeling engine 106 of FIG. 1 calculates first example purchase potentials associated with the first store and the regions of interest and/or households in the geographic region based on the calibrated first elasticity value α′ and/or the calibrated second elasticity value β′ in a manner consistent with Equations (1) and (2). The resulting purchase potentials enable the modeling engine 106 to calculate a first potential ACV of the first store to substantially align to and/or match the first observed ACV of the first store. For example, the first potential ACV of the first store is within about 95% of the first observed ACV of the first store. Similarly, in some examples, the modeling engine 106 likewise calculates purchase potentials associated with one or more of the other example stores and the households and/or regions of interest based on the calibrated elasticity data 142. For example, the modeling engine 106 calculates second purchase potentials associated with the second example store, third purchase potentials associated with the third example store, etc.

After calculating the purchase potentials associated with the example stores (block 704), the example projection system 100 stores the calculated purchase potential data in the memory 114 and control of the example method 416 proceeds to calibrating the purchase potentials (block 706). As previously disclosed, in some examples, to further align and/or match a potential ACV of an example store to a respective observed ACV of the store, the purchase potentials associated with the store need to be re-calculated, changed, adjusted, and/or otherwise calibrated. However, by changing the purchase potentials, potential expenditures provided by the purchase potentials may no longer substantially align to and/or match the respective observed expenditures (e.g., the calculated potential data associated with the example stores is unbalanced relative to the associated observed data), which may adversely affect the accuracy of resulting projection weights for the panel.

Accordingly, in such examples, the calibration engine 108 of FIG. 1 calibrates the first purchase potentials associated with the first example store to enable the modeling engine 106 to calculate both: (1) the first predicted ACV of the first store to substantially align to and/or match the first observed ACV of the first store (e.g., in connection with satisfaction of a first threshold value (e.g., +/−$100, $500, $1,000, etc.) and/or a sufficient number of calibration iterations); and (2) the predicted expenditures of the regions of interest to substantially align to and/or match the respective observed expenditures (e.g., in connection with satisfaction of a second threshold value (e.g., +/−$100, $500, $1,000, etc.) and/or a sufficient number of calibration iterations). For example, the calibration engine 108 may implement an iterative proportional fitting (IPF) method and/or technique (e.g., as shown in FIGS. 2A-C) to calibrate the potential spending in this manner, which is disclosed in greater detail below in connection with FIG. 11. Further, in some examples, the calibration engine 108 likewise calibrates the other purchase potentials (e.g., the second purchase potentials associated with the second example store, the third purchase potentials associated with the third example store, etc.) for the other example stores in this same manner.

After calibrating the purchase potentials (block 706), the example projection system 100 stores the calibrated purchase potentials and/or associated calibrated purchase potential data 144 in the memory 114 (e.g., to enable the projection engine 110 to calculate projection weights for households of interest) and control of the example method 416 then returns to a calling function such as the example method 400 of FIG. 4.

FIG. 8 is a flow diagram representative of example method 418 that may be performed by the example projection system 100 of FIG. 1 to identify a target retailer or a target retail channel for calibration, which enables the example projection system 100 to correct for associated panel imbalance (e.g., caused by a store bias and/or a shopping bias) by ensuring there is sufficient data associated with each target. Example operations of blocks 802, 804, 806, 808, 810, 812, 814, 816, and/or 818 may be used to implement block 418 of FIG. 4.

The example method 418 begins by identifying one or more stores of a retailer (block 802). As previously disclosed, an example retailer includes a company associated with one or more stores in the geographic region. In some examples, the data analyzer 102 of FIG. 1 accesses and/or analyzes the data in the memory 114 to identify the first example store, the second example store, and the third example store as part of the first example retailer.

After identifying the store(s) of the first retailer (block 802), control of the example method 418 proceeds to determining whether at least one of the stores has a loyalty program (block 804). In some examples, the data analyzer 102 of FIG. 1 accesses and/or analyzes the data in the memory 114 associated with the first store, the second store, and/or the third store (e.g., obtained by the example projection system 100 from the stores via the network(s) 116) to determine whether at least one of the stores of the first retailer has a loyalty program. In such examples, the data analyzer 102 identifies one or more core panelists and/or auxiliary panelists of the panel participating in the loyalty program. Stated differently, the data analyzer 102 identifies members of the loyalty program associated with the core panelist data 132 and/or the auxiliary panelist data 134. In response to one of the first store, the second store, and/or the third store having a loyalty program, the data analyzer 102 determines the first retailer is a target retailer for calibration (block 806).

On the other hand, in response to none of the stores of the first retailer having a loyalty program, control of the example method 418 proceeds to comparing a banner share of the retailer to a first threshold (block 808). An example banner share of a retailer includes a share or percentage of sales (e.g., observed ACVs and/or potential ACVs calculated by the modeling engine 106) of stores of the retailer relative to other sales associated with other retailers in the geographic region. In some examples, the data analyzer 102 of FIG. 1 compares a first banner share (e.g., calculated by the projection system 100) associated with the first retailer to a first example threshold (e.g., about 5%), which may indicate whether the first retailer has sufficient data associated therewith to facilitate calibration of the projection weights.

After comparing the first banner share to the first threshold (block 808), control of the example method 418 proceeds to determining whether the banner share meets the first threshold (block 810). In some examples, in response to the first banner share not meeting the first threshold, the data analyzer 102 of FIG. 1 determines the first retailer is part of a first target retail channel (e.g., a supermarket or supercenter retail channel, a convenience retail channel, a gas station/kiosk retail channel, a drug retail channel, etc.) for calibration (block 812).

On the other hand, if the first banner share meets the first threshold (block 810), control of the example method 418 proceeds to comparing a footprint of the retailer to a second threshold (block 814). An example footprint of an example retailer includes a share or percentage of a number of households exposed to store(s) of the retailer relative a total number of households in the geographic region. As previously disclosed, a region of interest and/or a household therein are considered to be exposed to a store when a value of potential spending associated therewith is greater than 0$ (e.g., per year). In some examples, the data analyzer 102 of FIG. 1 compares a first example footprint (e.g., calculated by the projection system 100) to a second example threshold (e.g., about 10%), which may indicate whether the first retailer has sufficient data associated therewith to facilitate calibration of the projection weights.

After comparing the first footprint to the second threshold (block 814), control of the example method 418 proceeds to determining whether the footprint meets the second threshold (block 816). In some examples, in response to the example data analyzer 102 determining the first footprint of the first retailer meets the second threshold, the data analyzer 102 of FIG. 1 determines the first retailer is a target retailer for calibration (block 806).

On the other hand, in response to the example data analyzer 102 determining the first footprint of the first retailer does not meet the second threshold, the example data analyzer 102 of FIG. 1 determines the first example retailer is part of the first retail channel (block 812).

After determining the first retailer is a target retailer (block 806) or part of a target retail channel (block 812), control of the example method 418 proceeds to determining whether each retailer associated with the geographic region has been analyzed for calibration (block 818). In some examples, in response to determining at least one retailer associated with the geographic has not been analyzed for calibration, the data analyzer 102 of FIG. 1 identifies one or more stores of a different retailer (e.g., a second retailer, a third retailer, a fourth retailer, etc.) at block 802. As such, in some examples, control of the example method 418 repeats the operations of blocks 802, 804, 806, 808, 810, 812, 816, and/or 818 until each retailer associated with the geographic region has been analyzed for calibration. Control of the example method 418 then returns to a calling function such as the example method 400 of FIG. 4.

FIG. 9 is a flow diagram representative of an example method 422 that may be performed by the example projection system 100 of FIG. 1 to calibrate the initial projection weights to balance both: (1) projected potential spending of the panel associated with the target relative to observed sales of the target; and (2) projected population data of the panel relative to observed populations in the geographic region, which reduces and/or eliminates imbalance associated with the panel (e.g., caused by a store bias and/or a shopping bias) and/or associated errors in the projection weights. Example operations of blocks 902, 904, 906, 908, 910, 912, 914, and/or 916 may be used to implement block 422 of FIG. 4.

The example method 422 begins by identifying households of interest sharing attributes of interest (block 902). In some examples, the data analyzer 102 of FIG. 1 identifies which of the first households of interest (e.g., see the example households of interest 3002, 3004, 3006, 3008, 3010 in connection with the fourth table 3000 of FIG. 3A) share one or more example attributes of interest (e.g., see the example attributes of interest 3012, 3014, 3016 in connection with the fourth table 3000 of FIG. 3A) with each other, such as a particular household size, a household income, etc., which enables the projection engine 110 to calculated one or more projected populations (e.g., a total number of households) in the geographic region associated with the attribute(s) of interest.

The example method 422 also includes calculating a projected population based on the projection weights and an attribute of interest associated with a demographic representation (block 904). In some examples, based on the first projection weights of the panel, the projection engine 110 of FIG. 1 calculates a first example projected population representing a number of households in the geographic region (e.g., see the example values 3102, 3104, 3106 in the sixth table 3078 of FIG. 3C) associated with a first attribute of interest (e.g., see the example first attribute of interest 3012 in the fourth table 3000 of FIG. 3A) associated with a demographic representation (e.g., a household having only 1 resident). Further, in some examples, the projection engine 110 similarly calculates one or more other projected populations based on the first projection weights (e.g., see the example values 3108, 3110, 3112 and/or the example values 3114, 3116 in the sixth table 3078 of FIG. 3C). In such examples, each of the projected populations together represent a total projected population in the geographic region (e.g., see the example value 3071 in the fifth table 3054 of FIG. 3B).

After calculating the projected population(s) (block 904), control of the example method 422 proceeds to comparing the projected population to an observed population in the geographic region having the attribute of interest (block 906). In some examples, the projection system 100 of FIG. 1 compares the first projected population to a first observed population (e.g., a number of households having only one resident) in the geographic region sharing the first attribute of interest (e.g., see the example first iteration of calibration in connection with the sixth table 3078 of FIG. 3C).

After comparing the projected population(s) (block 906), control of the example method 422 proceeds to calculating, based on the comparison, the projection weights to align the projected population to the observed population (block 908). In some examples, the calibration engine 108 of FIG. 1 re-calculates the first projection weights of the panel to align the first projected population to the first observed population (e.g., see the example first iteration of calibration in connection with the sixth table 3078 of FIG. 3C as well as the resulting example projection weights 3056, 3058, 3062, 3064, 3068 in the seventh table 3130 of FIG. 3D).

After re-calculating the first projection weights with respect to projected populations and observed populations (block 908), control of the example method 422 proceeds to calculating projected potential spending of the households of interest at the target retailer or the retail channel based on the projection weights (block 910). In some examples, the projection engine 110 of FIG. 1 calculates projected potential spending of the first households of interest of the panel at the example stores of the first target retailer based on the first projection weights (e.g., see the example values 3080, 3082, 3084, 3086, 3088, 3090 in the seventh table 3130 of FIG. 3D).

After calculating the projected potential spending (block 910), control of the example method 422 proceeds to comparing the projected potential spending of the households of interest at the target retailer or retail channel to observed sales of the target (block 912). In some examples, the projection system 100 of FIG. 1 compares the calculated potential spending of the first households of interest at the first target retailer to observed sales of the target retailer (e.g., see the example second iteration of calibration in connection with the seventh table 3130 of FIG. 3D).

After comparing the projected spending to the observed sales (block 912), control of the example method 422 proceeds to calculating, based on the comparison, the projection weights to align the potential spending to the observed sales of the target (block 914). In some examples, the calibration engine 108 of FIG. 1 re-calculates the first projection weights to align the potential spending of the first households of interest to observed sales of the first target retailer (e.g., see the example second iteration of calibration in connection with the seventh table 3130 of FIG. 3D as well as the resulting example projection weights 3056, 3058, 3062, 3064, 3068 in the eighth table 3134 of FIG. 3E). Further, in some examples, the calibration engine 108 similarly re-calculates the first projection weights to align the potential spending to observed sales of one or more other target retailers and/or target retail channels (e.g., see the example third iteration and fourth iteration of calibration in connection with the eighth table 3134 of FIG. 3E and the ninth table 3150 of FIG. 3F).

After calculating the projection weights with respect to potential spending and observed sales (block 914), control of the example method 422 proceeds to determining whether a sufficient number of iterations have been performed and/or a difference between a calculated value and an observed value meets a threshold difference (block 916). In some examples, if the example projection system 100 of FIG. 1 determines an insufficient number of iterations have been performed (e.g., less than about 50 iterations), control of the example method 422 repeats the operations of blocks 904, 906, 908, 910, 912, and/or 914 until the projection system 100 determines a sufficient number of iterations (e.g., about 50 or more iterations) have been performed associated with convergence of the first projection weights, thereby generating the second and/or final projection weights for the panel (e.g., see the example projection weights 3056, 3058, 3062, 3064, 3068 in the fifth table 3054 of FIG. 3B). In this manner, the projection system 100 balances both: (1) the projected potential spending of the first households of interest associated with the first target retailer relative to the observed sales of the first target retailer; and (2) projection population data of the panel relative to the observed populations in the geographic region.

Additionally or alternatively, in some examples, the projection system 100 continues performing iterations until at least a difference (e.g., an absolute difference and/or a relative difference) (e.g., see the example difference values 3096, 3098, 3100, 3118, 3120, 3122 in the sixth table 3078 of FIG. 3C) between a calculated value (e.g., a projected population and/or a projected potential ACV) and an observed value (e.g., an observed population and/or an observed ACV) meets a threshold difference. For example, the projection system 100 continues performing iterations until a projected number of households (e.g., see the example values 3102, 3104, 3106, 3108, 3110, 3112, 3114, 3116 in the sixth table 3078 of FIG. 3C) differs from an observed number of households (e.g., see the example values 3060, 3066, 3070 in the sixth table 3078 of FIG. 3C; see also the example value 3071 in the fifth table 3054 of FIG. 3B) by less than a threshold number of households (e.g., about 1 household) and/or a threshold proportion (e.g., about 0.1%). Further, in some examples, the projection system 100 similarly continues performing iterations until a projected potential ACV (e.g., see the example values 3080, 3082, 3084, 3086, 3088, 3090 in the seventh table 3130 of FIG. 3D; see also the example values 3140, 3142, 3144, 3146, 3148, 3092 in the eighth table 3134 of FIG. 3E; see also the example values 3152, 3154, 3156, 3158, 3160, 3094 in the ninth table 3150 of FIG. 3F) differs from an observed ACV (e.g., see the example value 3072 in the seventh table 3130 of FIG. 3D; see also the example value 3074 in the eighth table 3134 of FIG. 3E; see also the example value 3076 in the ninth table 3150 of FIG. 3F) by less than a threshold ACV (e.g., $100 per year, $500 per year, $1,000 per year, etc.) and/or a threshold proportion (e.g., about 0.1%). Then, control of the example method 422 returns to a calling function such as the example method 400 of FIG. 4.

FIG. 10 is a flow diagram representative of an example method 702 that may be performed by the example projection system 100 of FIG. 1 to calibrate elasticity values of the Huff model associated with each store, which provides for the potential ACVs of the example stores that substantially align to and/or match the respective observed ACVs of the example stores. Example operations of blocks 1002, 1004, 1006, and/or 1008 may be used to implement block 702 of FIG. 7.

The example method 702 begins by generating and/or pre-defining first elasticity values and second elasticity values (at block 1002). In some examples, the calibration engine 108 of FIG. 1 generates a first table or matrix having one or more first elasticity values (e.g., α₁, α₂, α₃, etc.) and one or more second elasticity values (e.g., β₁, β₂, β₃, etc.) for the example stores. In such examples, the first elasticity values and the second elasticity values may have a range with an incremental spacing between each value. For example, the first elasticity values range between 0.5 and 1.5 in increments of 0.1 (e.g., α₁=0.5, α₂=0.6, α₃=0.7, etc.) and the second elasticity values range between 0.5 and 1.5 in increments of 0.1 (e.g., β₁=0.5, β₂=0.6, β₃=0.7, etc.). In other examples, the range of the first elasticity values and/or the second elasticity values is less than or greater than 1.5 and/or 0.5. Further, in other examples, the increment between each of the first elasticity values and/or the second elasticity values is less than or greater than 0.1. While the first range is the same as the second range in this example, the first range may be different than the second range in other examples. Similarly, while the first increment is the same as the second increment in this example, the first increment may be different from the second increment in other examples. Further still, the example value(s) used in the disclosed examples are for illustrative purposes and other values may be used in other examples.

After generating the first matrix of the first elasticity values and the second elasticity values for at least the first target store (at block 1002), control of the example method 702 proceeds to calculating, via the Huff model, sets of purchase potentials based on the first elasticity values and the second elasticity values (at block 1004). In some examples, the modeling engine 106 of FIG. 1 calculates the sets of purchase potentials based on each of the first elasticity values and each of the second elasticity values, for example, in a manner consistent with Equations (1) and/or (2). In particular, the modeling engine 106 may use different combinations and/or permutations of the first elasticity values and the second elasticity values in calculating the sets of purchase potentials. For example, the modeling engine 106 calculates a first set of purchase potentials based on a first pair of elasticity values (α₁,β₁), a second set of purchase potentials based on a second pair of elasticity values (α₁,β₂), a third set of purchase potentials based on a third pair of elasticity values (α₂,β₁), a fourth set of purchase potentials based on a fourth pair of elasticity values (α₂, β₂), etc. Thus, the projection system 100 may input into Equation (1) every combination and/or permutation of the first elasticity values and the second elasticity values in the first matrix, which enables the projection system 100 to determine a pair of the elasticity values that provide predicted ACVs substantially aligning to and/or matching respective ones of the observed ACVs, as discussed further below.

After calculating the sets of purchase potentials (block 1004), the example projection system 100 stores the calculated sets of purchase potentials in the memory 114 and control of the example method 802 proceeds to comparing resulting potential ACVs of the example stores to respective ones of the observed ACVs (at block 1006). As previously disclosed, a potential ACV (e.g., calculated via the modeling engine 106) of an example store is based on purchase potentials associated with that store as well as observed expenditures of the regions of interest and/or the households (e.g., potential spending of the households). As such, the potential ACVs of the example stores are unique based on each of the sets of the purchase potentials. In some examples, based on each of the sets of purchase potentials, the calibration engine 108 compares resulting potential ACVs (e.g., calculated via the modeling engine 106) of the example stores to respective ones of the observed ACVs (e.g., retrieved via the data analyzer 102) of the example stores.

After comparing the resulting potential ACVs (at block 1006), control of the example method 702 proceeds to selecting one of the first elasticity values and/or one of the second elasticity values as the calibrated elasticity value(s) based on the comparison (block 1008). In some examples, the calibration engine 108 of FIG. 1 selects one of the generated and/or pre-defined first elasticity values and/or one of the generated and/or pre-defined second elasticity values, for example, such that the elasticity value(s) provide a potential ACV (e.g., calculated via the modeling engine 106) for each example store that substantially aligns to and/or matches a respective one of the observed ACVs in connection with satisfaction of a criterion. For example, the calibration engine 108 may analyze a gap or difference (e.g., calculated via the data analyzer 102) between each example store's potential ACV and observed ACV (e.g., provided at block 1006) and, in response, selects one or more (e.g., a pair) of the elasticity values in the first matrix that satisfy a root mean square error (RMSE), a chi-square distribution, correlations, regression parameters, etc. In such examples, if the calibration engine 108 determines at least one of the elasticity values satisfies the criterion, the calibration engine 108 selects a corresponding one of the first elasticity values and/or a corresponding one of the second elasticity values as the calibrated elasticity value(s).

After selecting the elasticity value(s) as the calibrated elasticity value(s) (block 1008), the projection system 100 stores the calibrated elasticity values and/or associated calibrated elasticity data 142 in the memory 114 (e.g., to enable the modeling engine 106 to calculate improved purchase potentials). In some examples, based on the calibrated elasticity data 142, the modeling engine 106 calculates potential sales (e.g., one or more potential or rebuilt ACVs) for one or more stores and/or retailers in the geographic region that more accurately represent and/or better align to observed sales (e.g., one or more observed ACVs) of the store(s) and/or the retailer(s). Further, in some examples, based on the calibrated elasticity data 142, the modeling engine 106 calculates potential spending (e.g., one or more potential or rebuilt expenditures) for households (e.g., households of interest) (and/or regions of interest in which the households are located) in the geographic region that more accurately represent and/or better align to observed spending (e.g., one or more observed expenditures) of the households (and/or the regions of interest in which the households are located). In such examples, by enabling the projection system 100 to calculate improved purchase potentials via the calibrated elasticity data 142, the calibration engine 108 performs less iterations (e.g., iterations in connection with the example method 706 of FIG. 11) in calibrating the purchase potentials, which saves computational resources of the projection system 100 associated with generating the second and/or final projection weights of the panel. Then, control of the example method 702 returns to a calling function such as the example method 416 of FIG. 7.

FIG. 11 is a flow diagram representative of an example method 706 that may be executed by the example projection system 100 of FIG. 1 to calibrate purchase potentials associated with the example stores, which provides for the potential ACVs (e.g., calculated via the modeling engine 106) of the example stores that further align to and/or match the respective observed ACVs of the example stores. Example operations of blocks 1102, 1104, 1106, 1108, and/or 1110 may be used to implement block 706 of FIG. 7. Calibration of the purchase potentials may be implemented, for example, using an IPF technique or method, as disclosed above in connection with FIGS. 2A-C.

The example method 706 begins by performing a first comparison of the potential ACVs of the stores with observed ACVs of the stores (block 1102). In some examples, the projection system 100 compares each potential ACV of the example stores to a respective one of the observed ACVs of the example stores, for example, as shown in the example first table 200 of FIG. 2A. In such examples, the projection system 100 may determine a numerical difference between each potential ACV and its respective observed ACV (e.g., see row 216, 218, and 234 of FIG. 2A).

After performing the first comparison (block 1102), control of the example method 706 proceeds to calculating, based on the first comparison, the purchase potentials to align to and/or match each of the potential ACVs to a respective one of the observed ACVs (block 1004). In some examples, the calibration engine 108 calculates a potential ACV for each example store (e.g., see row 216 of FIG. 2A) based on a corresponding ratio or multiplier (e.g., see row 236 of FIG. 2A), for example, to calculate the example second table 202 of FIG. 2B.

As previously disclosed, by changing, adjusting, and/or otherwise calibrating the purchase potentials facilitating the potential data to better align the potential ACVs of the example stores, resulting potential expenditures of the regions of interest may no longer substantially align to and/or match a respective one of the observed expenditures, which may adversely affect projection data (e.g., reduce accuracy of the projection data) generated by the projection system 100. In addition to reducing accuracy of projection weights generated by the projection engine 110, such erred and/or imbalanced purchase potential data results in the projection engine 110 performing more iterations of calibration (e.g., see FIGS. 3C-F) to calculate the second and/or final projection weights for the panel, which increases processing resource consumption of the projection system 100. As such, after calculating the purchase potentials in connection with block 1104, control of the example method 706 proceeds to performing a second comparison of potential expenditures with observed expenditures of the regions of interest (block 1106). In some examples, the calibration engine 108 compares a potential expenditure (e.g., calculated via the modeling engine 106) (e.g., see column 230 of FIG. 2B) of each region of interest with a respective one of the observed expenditures (e.g., see column 232 of FIG. 2B), for example, to calculate a corresponding numerical difference (e.g., see column 238 of FIG. 2B).

After performing the second comparison (block 1106), control of the example method 706 proceeds to calculating, based on the second comparison, the purchase potentials to align and/or match each of the potential expenditures to a respective one of the observed expenditures (block 1108). In some examples, the calibration engine 108 of FIG. 1 determines a ratio or multiplier between each potential expenditure and its respective observed expenditure (e.g., see column 240 of FIG. 2B) and changes the purchase potentials facilitating the associated potential portions of the expenditure and/or potential spending of the households based on the multiplier. For example, the calibration engine 108 updates potential portions of each expenditure and/or potential spending of households in each region based on their corresponding multiplier, thereby calculating the potential expenditures that align to and/or match the respective observed expenditures, for example, to calculate the third table 204 of FIG. 2C.

After calculating the purchase potentials in connection with the operation of block 1108, control of the example method 706 proceeds to determining whether a sufficient number of iterations have performed and/or a difference between a calculated value and an observed value meet a threshold difference (block 1110). In some examples, if the example projection system 100 determines an insufficient number of iterations have been performed (e.g., less than about 50 iterations), control of the example method 706 repeats the operations of block 1102, 1104, 1106, and/or 1108 until the projection system 100 determines a sufficient number of iterations (e.g., about 50 or more iterations) have been performed associated with convergence of the projection weights. In this manner, the projection system 100 balances both: (1) the potential sales of the example stores relative to associated observed sales data; and (2) potential spending of the regions of interest relative to associated observed spending.

Additionally or alternatively, in some examples, the projection system 100 continues performing iterations until at least a difference (e.g., an absolute and/or a relative difference) (e.g., see the eighth row 234 and/or the eighth column 238 of the first table 200 of FIG. 2A) between a calculated value (e.g., a potential or rebuilt ACV and/or a potential or rebuilt expenditure) and an observed value (e.g., an observed ACV and/or an observed expenditure) meets a threshold difference. For example, the projection system 100 continues performing iterations until a potential ACV (e.g., see the sixth row 216 of the first table 200 of FIG. 2A) differs from an observed ACV (e.g., see the seventh row 218 of the first table 200 of FIG. 2A) by less than a threshold ACV (e.g., +/−$100 per year, $500 per year, $1,000 per year, etc.) and/or a threshold proportion (e.g., about 0.1%). Further, in some examples, the projection system 100 similarly continues performing iterations until a potential expenditure (e.g., see the sixth column 230 of the first table 200 of FIG. 2A) differs from an observed expenditure (e.g., see the seventh column 232 of the first table 200 of FIG. 2A) by less than a threshold expenditure (e.g., +/−$100 per year, $500 per year, $1,000 per year, etc.) and/or a threshold proportion (e.g., about 0.1%). Then, control of the example method 422 returns to a calling function such as the example method 400 of FIG. 4.

As used herein, the terms “ratio,” “multiplier,” “proportion,” “proportional value,” “factor,” and/or “percentage,” may be used interchangeably.

FIG. 12 is a block diagram of an example processor platform 1200 capable of executing the instructions of FIGS. 4-11 to implement the example projection system 100 of FIG. 1. The processor platform 1200 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer. The hardware processor may be a semiconductor based (e.g., silicon based) device. In this example, the processor implements the data analyzer 102, the distance calculator 104, the modeling engine 106, the calibration engine 108, and the projection engine 110.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1120 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives.

The coded instructions 1232 of FIGS. 4-11 may be stored in the mass storage device 1228, in the volatile memory 1214, in the non-volatile memory 1216, and/or on a removable tangible computer readable storage medium such as a CD or DVD.

From the foregoing, it will be appreciated that example methods, systems, and apparatus have been disclosed that generate at least some projection weights for a panel based on calculated potential spending of panelist households at retailer stores as well as observed sales of those stores. By generating the projection weights in this manner, examples disclosed herein reduce and/or eliminate panel imbalance and/or errors in the projection weights (e.g., caused by a retail or store bias) that would have otherwise been exhibited by known projection systems. Thus, examples disclosed herein improve computational efficiency in generating the projection weights by reducing and/or eliminating a need for re-calculations caused by such imbalance(s) and/or error(s). Further, some disclosed examples generate effective and/or accurate projection weights for a combined panel (e.g., a panel having core panelist data and auxiliary panelist data) while using less core panelist data (e.g., less memory) that would have otherwise been required by the above-described known projection systems. Additionally, a relatively lower reliance upon core panelist data results in a corresponding reduction in a cost associated with market research.

Although certain example methods, systems, apparatus and articles of manufacture have been disclosed herein, the scope of coverage of this patent is not limited thereto. On the contrary, this patent covers all methods, systems, apparatus and articles of manufacture fairly falling within the scope of the claims of this patent.

An example apparatus disclosed herein to reduce panel imbalance errors includes a data analyzer to identify a retailer in a geographic region indicative of shopping bias. The data analyzer also is to identify households of interest in the geographic region having combined panel data. The combined panel data represents core panelist data and auxiliary data. The apparatus also includes a modeling engine to calculate potential spending of the households at one or more stores of the retailer. The potential spending is based on observed spending data. The apparatus also includes a projection engine to reduce panel imbalance errors by calculating projection weights for the combined panel data based on (a) the potential spending at the one or more stores and (b) demographic representation data of the combined panel data.

In some examples, the data analyzer is to identify the retailer based on the one or more stores having members associated with at least one of the core panelist data or the auxiliary data participating in a loyalty program. In some examples, the data analyzer is to identify the retailer by comparing a banner share associated with the retailer to a threshold value. The banner share is based on observed sales of the retailer and other retailers in the geographic region. In some examples, the data analyzer is to identify the retailer by comparing a footprint associated with the retailer to a threshold value. The footprint is based on a number of the households of interest exposed to the retailer and a total number of households in the geographic region.

In some examples, the apparatus also includes a calibration engine to calibrate the projection weights to balance both: (a) projected population data of the panel relative to observed population data of the geographic region; and (b) the potential spending of the households of interest at the retailer relative to observed sales data of the retailer. In some examples, the calibration engine is to calibrate the projection weights by calculating potential sales of the retailer based on the potential spending of the households of interest and the projection weights. In some examples, the calibration engine is to calibrate the projection weights by calculating a projected number of households in the geographic region sharing a same demographic attribute based on the combined panel data and the projection weights. In some examples, the calibration engine is to calibrate the projection weights by identifying an observed number of households in the geographic region sharing the same demographic attribute. In some examples, the calibration engine is to calibrate the projection weights by aligning values of the potential sales of the retailer to values of observed sales of the retailer in connection with satisfaction of a first threshold value. In some examples, the calibration engine is to calibrate the projection weights by aligning the projected number of households to the observed number of households in connection with satisfaction of a second threshold value.

In some examples, the apparatus also includes a calibration engine to calibrate the potential spending at the one or more stores to balance potential data associated with the one or more stores and the geographic region relative to observed data. In some examples, the calibration engine is to calibrate the potential spending by calculating potential sales of the one or more stores based on the potential spending of the households of interest and other potential spending of other households in the geographic region. In some examples, the calibration engine is to calibrate the potential spending by calculating potential expenditures of regions of interest in which the households of interest and the other households are located based on the potential spending. In some examples, the calibration engine is to calibrate the potential spending by aligning the potential sales to observed sales of the one or more stores in connection with satisfaction of a first threshold value. In some examples, the calibration engine is to calibrate the potential spending by aligning the potential expenditures to respective observed expenditures of the regions of interest in connection with satisfaction of a second threshold value. In some examples, the calibration engine is to select a pair of elasticity values of a Huff model to enable the modeling engine to calculate, via the Huff model, potential sales that align to the observed sales prior to calibrating the potential spending. In some examples, the calibration engine is to adjust purchase potentials associated with the one or more stores to enable the modeling engine to calculate, via the Huff model, potential sales that align to the observed sales prior to calibrating the potential spending, the purchase potentials including proportional values based on preferences of the households of interest to spend money at the one or more stores relative to other stores in the geographic region.

An example computer implemented method to reduce panel imbalance errors disclosed herein includes identifying, by executing an instruction with a processor, a retailer in a geographic region indicative of shopping bias. The computer implemented method also includes identifying, by executing an instruction with a processor, households of interest in the geographic region having combined panel data. The combined panel data represents core panelist data and auxiliary data. The computer implemented method also includes calculating, by executing an instruction with a processor, potential spending of the households at one or more stores of the retailer. The potential spending is based on observed spending data. The computer implemented method also includes calculating, by executing an instruction with a processor, projection weights for the combined panel data based on (a) the potential spending at the one or more stores and (b) demographic representation data of the combined panel data.

In some examples, the computer implemented also includes identifying the retailer includes identifying one or more stores of the retailer having members associated with at least one of the core panelist data or the auxiliary data participating in a loyalty program. In some examples, the computer implemented method also includes comparing a banner share associated with the retailer to a threshold value. The banner share is based on observed sales of the retailer and other retailers in the geographic region.

In some examples, the computer implemented method also includes calibrating the projection weights to balance both: (1) projected population data of the panel relative to observed population data of the geographic region; and (2) the potential spending of the households of interest at the retailer relative to observed sales data of the retailer. In some examples, the computer implemented also includes calculating potential sales of the retailer based on the potential spending of the households of interest and the projection weights. In some examples, the computer implemented method also includes calculating a projected number of households in the geographic region sharing a same demographic attribute based on the combined panel data and the projection weights. In some examples, the computer implemented method also includes identifying an observed number of households in the geographic region sharing the same demographic attribute. In some examples, the computer implemented method also includes aligning values of the potential sales of the retailer to values of observed sales of the retailer in connection with satisfaction of a first threshold value. In some examples, the computer implemented method also includes aligning the projected number of households to the observed number of households in connection with satisfaction of a second threshold value.

In some examples, the computer implemented method also includes calibrating the potential spending at the one or more stores to balance potential data associated with the one or more stores and the geographic region relative to observed data. In some examples, the computer implemented method also includes calculating potential sales of the one or more stores based on the potential spending of the households of interest and other potential spending of other households in the geographic region. In some examples, the computer implemented method also includes calculating potential expenditures of regions of interest in which the households of interest and the other households are located based on the potential spending. In some examples, the computer implemented method includes aligning the potential sales to observed sales of the one or more stores in connection with satisfaction of a first threshold value. In some examples, the computer implemented method includes aligning the potential expenditures to respective observed expenditures of the regions of interest in connection with satisfaction of a second threshold value. In some examples, the computer implemented method also includes selecting a first elasticity value or second elasticity value of a Huff model to enable the modeling engine to calculate, via the Huff model, potential sales that align to the observed sales prior to calibrating the potential spending.

An example tangible machine-readable storage medium disclosed herein comprises instructions which, when executed, cause a processor to identify a retailer in a geographic region indicative of shopping bias. In some examples, the instructions also cause the processor to identify households of interest in the geographic region having combined panel data. The combined panel data represents core panelist data and auxiliary data. In some examples, the instructions also cause the processor to calculate potential spending of the households at one or more stores of the retailer. The potential spending based on observed spending data. In some examples, the example instructions also cause the processor to calculate projection weights for the combined panel data based on (a) the potential spending at the one or more stores and (b) demographic representation data of the combined panel data.

In some examples, the example instructions also cause the processor to calibrate the projection weights to balance both: (a) projected population data of the panel relative to observed population data of the geographic region; and (b) the potential spending of the households of interest at the retailer relative to observed sales data of the retailer.

What is claimed is:

1. An apparatus to reduce panel imbalance errors, the apparatus comprising:
a data analyzer to:
identify a retailer in a geographic region indicative of shopping bias; and
identify households of interest in the geographic region having combined panel data, the combined panel data representing core panelist data and auxiliary data;
a modeling engine to calculate potential spending of the households at one or more stores of the retailer, the potential spending based on observed spending data; and
a projection engine to reduce panel imbalance errors by calculating projection weights for the combined panel data based on (a) the potential spending at the one or more stores and (b) demographic representation data of the combined panel data.

2. The apparatus as defined in claim 1, wherein the data analyzer is to identify the retailer based on the one or more stores having members associated with at least one of the core panelist data or the auxiliary data participating in a loyalty program.

3. The apparatus as defined in claim 2, wherein the data analyzer is to identify the retailer by comparing a banner share associated with the retailer to a threshold value, the banner share based on observed sales of the retailer and other retailers in the geographic region.

4. The apparatus as defined in claim 2, wherein the data analyzer is to identify the retailer by comparing a footprint associated with the retailer to a threshold value, the footprint based on a number of the households of interest exposed to the retailer and a total number of households in the geographic region.

5. The apparatus as defined in claim 1, further including a calibration engine to calibrate the projection weights to balance both: (a) projected population data of the panel relative to observed population data of the geographic region; and (b) the potential spending of the households of interest at the retailer relative to observed sales data of the retailer.

6. The apparatus as defined in claim 5, wherein the calibration engine is to calibrate the projection weights by:
calculating potential sales of the retailer based on the potential spending of the households of interest and the projection weights;
calculating a projected number of households in the geographic region sharing a same demographic attribute based on the combined panel data and the projection weights;
identifying an observed number of households in the geographic region sharing the same demographic attribute;
aligning values of the potential sales of the retailer to values of observed sales of the retailer in connection with satisfaction of a first threshold value; and
aligning the projected number of households to the observed number of households in connection with satisfaction of a second threshold value.

7. The apparatus as defined in claim 1, further including a calibration engine to calibrate the potential spending at the one or more stores to balance potential data associated with the one or more stores and the geographic region relative to observed data.

8. The apparatus as defined in claim 7, wherein the calibration engine is to calibrate the potential spending by:
calculating potential sales of the one or more stores based on the potential spending of the households of interest and other potential spending of other households in the geographic region;
calculating potential expenditures of regions of interest in which the households of interest and the other households are located based on the potential spending;
aligning the potential sales to observed sales of the one or more stores in connection with satisfaction of a first threshold value; and
aligning the potential expenditures to respective observed expenditures of the regions of interest in connection with satisfaction of a second threshold value.

9. The apparatus as defined in claim 8, wherein the calibration engine is to select a first elasticity value or second elasticity value of a Huff model to enable the modeling engine to calculate, via the Huff model, potential sales that align to the observed sales prior to calibrating the potential spending.

10. The apparatus as defined in claim 8, wherein the calibration engine is to adjust purchase potentials associated with the one or more stores to enable the modeling engine to calculate, via the Huff model, potential sales that align to the observed sales prior to calibrating the potential spending, the purchase potentials including proportional values based on preferences of the households of interest to spend money at the one or more stores relative to other stores in the geographic region.

11. A computer implemented method to reduce panel imbalance errors, the method comprising:
identifying, by executing an instruction with a processor, a retailer in a geographic region indicative of shopping bias;
identifying, by executing an instruction with a processor, households of interest in the geographic region having combined panel data, the combined panel data representing core panelist data and auxiliary data;
calculating, by executing an instruction with a processor, potential spending of the households at one or more stores of the retailer, the potential spending based on observed spending data; and
calculating, by executing an instruction with a processor, projection weights for the combined panel data based on (a) the potential spending at the one or more stores and (b) demographic representation data of the combined panel data.

12. The computer implemented method as defined in claim 11, wherein identifying the retailer includes identifying one or more stores of the retailer having members associated with at least one of the core panelist data or the auxiliary data participating in a loyalty program.

13. The computer implemented method as defined in claim 12, wherein identifying the retailer includes comparing a banner share associated with the retailer to a threshold value, the banner share based on observed sales of the retailer and other retailers in the geographic region.

14. The computer implemented method as defined in claim 11, further including calibrating the projection weights to balance both: (a) projected population data of the panel relative to observed population data of the geographic region; and (b) the potential spending of the households of interest at the retailer relative to observed sales data of the retailer.

15. The computer implemented method as defined in claim 14, wherein calibrating the projection weights includes:
calculating potential sales of the retailer based on the potential spending of the households of interest and the projection weights;
calculating a projected number of households in the geographic region sharing a same demographic attribute based on the combined panel data and the projection weights;
identifying an observed number of households in the geographic region sharing the same demographic attribute;
aligning values of the potential sales of the retailer to values of observed sales of the retailer in connection with satisfaction of a first threshold value; and
aligning the projected number of households to the observed number of households in connection with satisfaction of a second threshold value.

16. The computer implemented method as defined in claim 11, further including calibrating the potential spending at the one or more stores to balance potential data associated with the one or more stores and the geographic region relative to observed data.

17. The computer implemented method as defined in 16, wherein calibrating the potential spending includes:
calculating potential sales of the one or more stores based on the potential spending of the households of interest and other potential spending of other households in the geographic region;
calculating potential expenditures of regions of interest in which the households of interest and the other households are located based on the potential spending;
aligning the potential sales to observed sales of the one or more stores in connection with satisfaction of a first threshold value; and
aligning the potential expenditures to respective observed expenditures of the regions of interest in connection with satisfaction of a second threshold value.

18. The computer implemented method as defined in claim 16, wherein calibrating the potential spending includes selecting a first elasticity value or second elasticity value of a Huff model to enable the modeling engine to calculate, via the Huff model, potential sales that align to the observed sales prior to calibrating the potential spending.

19. A tangible machine-readable storage medium comprising instructions which, when executed, cause a processor to at least:
identify a retailer in a geographic region indicative of shopping bias;
identify households of interest in the geographic region having combined panel data, the combined panel data representing core panelist data and auxiliary data;
calculate potential spending of the households at one or more stores of the retailer, the potential spending based on observed spending data; and
calculate projection weights for the combined panel data based on (a) the potential spending at the one or more stores and (b) demographic representation data of the combined panel data.

20. The tangible machine-readable storage medium of claim 19, further including instructions which, when executed, cause the processor to calibrate the projection weights to balance both: (a) projected population data of the panel relative to observed population data of the geographic region; and (b) the potential spending of the households of interest at the retailer relative to observed sales data of the retailer.
